(19) United States
(12) Patent Application Publication
(10) Pub. No.: US 2008/0077530 A1
(43) Pub. Date: Mar. 27, 2008

(54) SYSTEM AND METHOD FOR PROJECT PROCESS AND WORKFLOW OPTIMIZATION

(76) Inventors: John Banas, Scottsdale, AZ (US); Glenn Spreen, Los Angeles, CA (US); Kenneth Russell, McKinney, TX (US); Christina Crawford, San Francisco, CA (US); Doug Lui, Los Angeles, CA (US); Rick Saenz, Plano, TX (US)

Correspondence Address: NOBLITT & GILMORE, LLC., 4800 NORTH SCOTTSDALE ROAD, SUITE 6000, SCOTTSDALE, AZ, 85251, US

(21) Appl. No.: 11/860,670

(22) Filed: Sep. 25, 2007

Related U.S. Application Data
(60) Provisional application No. 60/848,063, filed on Sep. 28, 2006.
(60) Provisional application No. 60/826,877, filed on Sep. 25, 2006.

(51) Int. Cl. G06Q 10/00; H04L 9/32

(52) U.S. Cl. 705/50; 705/7; 705/9

(57) ABSTRACT

A system and method for process control and management is disclosed. Various features and applications of the present invention may be suitably adapted to manage, control or otherwise improve compliance and/or project workflow processing. In representative applications, the present invention provides a system and method for control, management, verification, certification and communication of compliance standards.

### RELATED APPLICATIONS

This application claims the benefit of U.S. Provisional Patent Application Ser. No. 60/848,063 filed in the United States Patent and Trademark Office on Sep. 28, 2006, and U.S. Provisional Patent Application Ser. No. 60/826,877 filed in the United States Patent and Trademark Office on Sep. 25, 2006.

### FIELD OF INVENTION

The present invention generally relates to project process optimization, project management, process, quality, standards and/or compliance control, and project workflow technology. More particularly, the present invention involves a system and method for control, management, verification, certification and/or communication of compliance standards.

### BACKGROUND OF INVENTION

All organizations (such as businesses, enterprises, agencies, associations, governmental agencies, private and public entities, for-profit and not-for-profit entities) conduct activities or transactions for the purpose of achieving organizational objectives. For example, an organization might institute a requirement that employees must sign an ethics agreement stating that they have read, understand and promise to comply with all of the organization's ethical standards. In another example, an organization might need to certify to the government that its financial statements are accurate. In such settings, these activities may be defined by a process; such as, for example, filing signed ethics forms and monitoring that each employee has signed the form. Each process may vary by feature, function, characteristic, performance and management, depending on various factors such as the type of organization, subject matter, transaction type, activity purpose, or the actuators.

Organizations typically engage in projects to create, implement and/or document processes. Once the process exists, organizations may engage in additional projects to manage and/or re-engineer the process to improve, enhance or maintain the efficiency and/or effectiveness of the process.

These projects may be implemented with a workflow—or a project process—having project objectives, activities, tasks, procedures, parameters, standards, content, data, documents and/or other project features, functions, or other deliverables. Such projects, with their many potential stages or events (e.g., planning, scoping, evaluation, assessment, analysis, bench-marking, design, engineering, development, documentation, implementation, testing, re-engineering, remediation, control, management, auditing, verification, certification, reporting, monitoring, change management, education, communication, and the like), may involve a multitude of human or system resources and may be complicated, time consuming, costly and/or manually intensive to implement and/or manage and prone to errors. Moreover, in today's marketplace, such projects are frequently engaged and placed under greater scrutiny as organizations are faced with ever-increasing regulatory requirements with respect to their internal processes. New mandates from a growing list of government agencies, ongoing changes in accounting standards, and escalating demands for information transparency have lead to increased regulatory compliance requirements and complexity with respect to an organization's internal processes. For example, a representative (but non-exclusive) list of compliance challenges facing companies and other organizations include regulations under the:

Insurance Information and Privacy Protection Model Act—providing standards for consumer personal information, such as health and financial circumstances.

Government Information Security Reform Act—requiring governmental agencies to assess the security of their IT infrastructure.

Child Internet Protection Act—addressing concerns involving access in schools and libraries to the internet and other information portals.

Homeland Security Act—anti-terrorism act, created by the Department of Homeland Security, providing new operational requirements in both the public and private sectors.

Graham-Leach-Bliley Act—requiring the U.S. Securities and Exchange Commission to establish appropriate standards for financial institutions to protect consumer information.

Health Insurance Portability and Accountability Act of 1996—amending the Internal Revenue Code promoting the use of Medical Savings Accounts, as well as medical record privacy, continuity of health insurance, etc.

Privacy Act of 1974—regulating the collection, use and dissemination of personal information by federal executive branch agencies.

Federal Energy Regulatory commission—overseeing the energy industry in the economic and environmental interest of the public.

SEC Regulation SP—embodying privacy rules dictated by section 504 of the Graham-Leach-Bliley Act.

Network Advising Initiative—requesting advertisers to give consumers prior notice concerning the use of web beacons, as well as information about what data is being collected and for what purpose.

European Data Protection Derivative of 1995—protecting individuals (in the European Union and beyond) with respect to personal data and its movement.

Family Educational Rights and Privacy Act—giving parents certain rights with respect to their children's education records.

Cyber Security Research and Development Act of 2002—awarding grants for basic research on innovative approaches to the structure of computer and network hardware and software that are aimed at enhancing computer security.

Basel II of June 2004—an international committee of major economies on Banking Supervision revising the standards governing the capital adequacy of internationally active banks. An important element is the incorporation of Operational Risk in the calculation of minimum capital requirement, which is defined as the risk of loss resulting from inadequate or failed internal processes, people and systems or from external events.

Payment Card Industry Data Security—a set of security standards that were created by the major credit card companies (American Express, Discover Financial Services, JCB, MasterCard Worldwide, and Visa International) to protect their customers from increasing identity theft and security breaches.

Sarbanes-Oxley Act of 2002 (SOx)—a wide ranging body of legislation establishing new and enhanced standards for all U.S. public companies and accounting firms.

As compliance complexity for companies and their internal processes increase, so do associated project costs. An AMR Research Study of over 225 business and IT leaders estimated that the total cost of compliance for 2005 equaled 15.5 billion dollars. Based on this same study, the SOx compliance portion of the budget was estimated at 6.2 billion dollars, $1.8 billion was devoted to SOx-related software, $2.6 billion to internal effort and service and $1.8 billion to IT investment.

Accordingly, SOx provides a representative example of the complexity and costs associate with project process issues facing companies today. Some of SOx's major provisions include a requirement that public companies engage in ongoing compliance efforts to evaluate and disclose the effectiveness of the their internal controls as they relate to financial reporting and requires independent auditors for these companies to conduct related projects attesting to such disclosure. Some exemplary SOx compliance issues for companies include:

Section 302—a company must certify that all reported financial data and information is accurate, thereby resulting in regular monitoring by organizations of changes to their processes and internal control environment;

Section 404—requires a certification that internal controls are in place to support management's certification;

Section 409—requires real time reporting (48 hours or less) of material events that could impact the bottom line;

Section 906—requires certification that Securities Exchange Commission (SEC) filings fairly represent the organization's financial condition; and

Section 103—requires the storage of documents and records for seven years, as well as the synchronization of these files with the auditor's own files.

Establishing and managing a project to achieve the organizational objective of complying with these (and other) SOx requirements is an incredibly resource-intensive task. Currently, most SOx compliance projects have been performed using conventional desktop tools, such as Microsoft Office applications. Management of comprehensive SOx and other compliance requirements projects with thousands of documents and numerous tasks is a difficult, if not near-impossible, manual task. For instance, project process administration using conventional approaches accounts for approximately 50-75% of available productivity of an organization's staff. Accordingly, almost all organizations would substantially benefit from the use of more effective tools and a consistent, reproducible project and workflow framework to certify their internal controls and processes.

Since the enactment and enforcement of SOx, other countries have introduced similar regulations on corporate governance e.g. Revised Guidance for Directors on the Combined Code published in October 2005 by the Financial Reporting Council in the United Kingdom, the Financial Instruments and Exchange Laws published in June 2006 by the Financial Services Agency in Japan, and the Bill 198 Bulletin published in February 2005 by the Canadian Securities Administrator and the like.

### SUMMARY OF THE INVENTION

In a representative aspect, the present invention includes a system and method for project process optimization. The system comprises data that may be entered manually via a user or administrator or uploaded directly onto the system. The data may be separated into different organizational levels which may be accessible through at least part of the system. In accordance with various aspects of the present invention, the system stores, tracks, searches, analyzes, sorts, organizes, configures, manipulates and/or provides data to users in order to track compliance and/or increase total compliance with at least one standard and/or requirement.

### BRIEF DESCRIPTION OF THE DRAWINGS

A more complete understanding of the present invention may be derived by referring to the detailed description and claims when considered in connection with the following representative figures. In the following figures, like reference numbers refer to similar elements and steps throughout the figures.

FIG. 1 illustrates a project process optimization system in accordance with a representative embodiment of the present invention;

FIG. 2 illustrates a schematic diagram of a data hierarchy in accordance with a representative embodiment of the present invention;

FIG. 3 illustrates a schematic diagram of a data hierarchy in accordance with a representative embodiment of the present invention;

FIG. 4 illustrates a schematic diagram of a data hierarchy in accordance with a representative embodiment of the present invention;

FIG. 5 illustrates a schematic diagram of a data hierarchy in accordance with a representative embodiment of the present invention;

FIG. 6 illustrates a schematic diagram of a data hierarchy in accordance with a representative embodiment of the present invention;

FIG. 7 illustrates a schematic diagram of a data hierarchy in accordance with a representative embodiment of the present invention;

FIG. 8 illustrates a Project Maintenance page in accordance with a representative embodiment of the present invention;

FIG. 9 illustrates a Project Creation page of a project process optimization system in accordance with a representative embodiment of the present invention;

FIG. 10 illustrates a schematic diagram of user roles and access to a project process optimization system in accordance with a representative embodiment of the present invention;

FIG. 11 illustrates a User Profile page of a project process optimization system in accordance with a representative embodiment of the present invention;

FIG. 12 illustrates a Project Plan page of a project process optimization system in accordance with a representative embodiment of the present invention;

FIG. 13 illustrates a Project Plan page of a project process optimization system in accordance with a representative embodiment of the present invention;

FIG. 14 illustrates a Task Screen of a project process optimization system in accordance with a representative embodiment of the present invention;

FIG. 15 illustrates a task workflow of a project process optimization system in accordance with a representative embodiment of the present invention;

FIG. 16 illustrates a User Preferences page of a project process optimization system in accordance with a representative embodiment of the present invention;

FIG. 17 illustrates a User Login page of a project process optimization system in accordance with a representative embodiment of the present invention;

FIG. 18 illustrates a schematic diagram of user access to a project process optimization system in accordance with a representative embodiment of the present invention;

FIG. 19 illustrates a schematic diagram of a task workflow of a project process optimization system in accordance with a representative embodiment of the present invention;

FIG. 20 illustrates a schematic diagram of a stage workflow of a project process optimization system in accordance with a representative embodiment of the present invention;

FIG. 21 illustrates a stage display page of a project process optimization system in accordance with a representative embodiment of the present invention;

FIG. 22 illustrates a schematic diagram of a stage workflow of a project process optimization system in accordance with a representative embodiment of the present invention;

FIG. 23 illustrates a schematic diagram of a data hierarchy in accordance with a representative embodiment of the present invention;

FIG. 24 illustrates a Key Control Setup page of a project process optimization system in accordance with a representative embodiment of the present invention;

FIG. 25 illustrates a Key Control Details page of a project process optimization system in accordance with a representative embodiment of the present invention;

FIG. 26 illustrates cycle, process and/or control hierarchy of a project process optimization system in accordance with a representative embodiment of the present invention;

FIG. 27 illustrates a Control Activity Setup page of a project process optimization system in accordance with a representative embodiment of the present invention;

FIG. 28 illustrates a Custom Attribute page of a project process optimization system in accordance with a representative embodiment of the present invention;

FIG. 29 illustrates a Financial Statement Setup page of a project process optimization system in accordance with a representative embodiment of the present invention;

FIG. 30 illustrates an Assessment stage page of a project process optimization system in accordance with a representative embodiment of the present invention;

FIG. 31 illustrates an Assessment stage page of a project process optimization system in accordance with a representative embodiment of the present invention;

FIG. 32 illustrates an Assessment stage page of a project process optimization system in accordance with a representative embodiment of the present invention;

FIG. 33 illustrates a Test Information page of a project process optimization system in accordance with a representative embodiment of the present invention;

FIG. 34 illustrates a Test Information page of a project process optimization system in accordance with a representative embodiment of the present invention;

FIG. 35 illustrates a Test Information page of a project process optimization system in accordance with a representative embodiment of the present invention;

FIG. 36 illustrates a schematic diagram of a Save function for a Test Information page of a project process optimization system in accordance with a representative embodiment of the present invention;

FIG. 37 illustrates a schematic diagram of a Save function for a Test Information page of a project process optimization system in accordance with a representative embodiment of the present invention;

FIG. 38 illustrates a schematic diagram of a Finish function for a Test Information page of a project process optimization system in accordance with a representative embodiment of the present invention;

FIG. 39 illustrates a schematic diagram of a Finish function for a Test Information page of a project process optimization system in accordance with a representative embodiment of the present invention;

FIG. 40 illustrates a Risk Rating Setup page of a project process optimization system in accordance with a representative embodiment of the present invention;

FIG. 41 illustrates a Cycle/Process Popup page of a project process optimization system in accordance with a representative embodiment of the present invention;

FIG. 42 illustrates a Trial Balance Setup page of a project process optimization system in accordance with a representative embodiment of the present invention;

FIG. 43 illustrates a schematic diagram of a task flow process of a project process optimization system in accordance with a representative embodiment of the present invention;

FIG. 44 illustrates a Report Parameters popup page of a project process optimization system in accordance with a representative embodiment of the present invention;

FIG. 45 illustrates a Report List page of a project process optimization system in accordance with a representative embodiment of the present invention;

FIG. 46 illustrates a report of a project process optimization system in accordance with a representative embodiment of the present invention;

FIG. 47 illustrates a schematic diagram of an Import function for a project process optimization system in accordance with a representative embodiment of the present invention;

FIG. 48 illustrates a Consolidated Trial Balance page of a project process optimization system in accordance with a representative embodiment of the present invention;

FIG. 49 illustrates Sub-level Trial Balance page of a project process optimization system in accordance with a representative embodiment of the present invention;

FIG. 50 illustrates a Sample Size Setup page of a project process optimization system in accordance with a representative embodiment of the present invention;

FIG. 51 illustrates a Currency Conversion page of a project process optimization system in accordance with a representative embodiment of the present invention;

FIG. 52 illustrates a Risk Calculation page of a project process optimization system in accordance with a representative embodiment of the present invention;

FIG. 53 illustrates a Query Setup page of a project process optimization system in accordance with a representative embodiment of the present invention;

FIG. 54 illustrates a Query page of a process optimization system in accordance with a representative embodiment of the present invention; and

FIG. 55 illustrates a Reconciliation table of a process optimization system in accordance with a representative embodiment of the present invention.

Elements and steps in the figures are illustrated for simplicity and clarity and have not necessarily been rendered according to any particular sequence. For example, steps that may be performed concurrently or in different order are illustrated in the figures to help improve understanding of embodiments of the present invention.

### DETAILED DESCRIPTION OF EXEMPLARY EMBODIMENTS

The following representative descriptions of the present invention generally relate to exemplary embodiments and the inventors' conception of the best mode, and are not intended to limit the applicability or configuration of the invention in any way. Rather, the following description is intended to provide convenient illustrations for implementing various embodiments of the invention. As will become apparent, changes may be made in the function and/or arrangement of any of the elements described in the disclosed exemplary embodiments without departing from the spirit and scope of the invention.

Various representative implementations of the present invention may be applied to any system for control, management, verification, certification, communication of and/or compliance with a standard. In accordance with various aspects of the present invention, representative standards may include laws, regulations, procedures, requirements, goals, compliance lists and/or the like.

A detailed description of a representative embodiment of the present invention, namely management of SOx compliance, is provided as a specific enabling disclosure that may be generalized to any application of the disclosed system and method for project process optimization, compliance management and/or project workflow processing. Moreover, it will be appreciated that the principles of the present invention may be employed to ascertain and/or realize any number of other benefits associated with project process optimization, compliance management, project workflow processing, and/or the like.

As used herein the terms “business”, “company” “corporation” and “organizations” or any contextual variant thereof, are generally intended to describe any type of entity including private, public, profit and/or non-for-profit entities, agency, association, governmental agency, and/or any grouping of individuals for a purpose of accomplishing one or more tasks.

As used herein the term “data” or any contextual variant thereof, is generally intended to describe any quanta or type of information that may be suitably adapted for entry into the system.

As used herein the term “standard” or any contextual variant thereof, is generally intended to describe any type of regulation, standard, law, requirement, cannon, criterion, principle and/or rule.

As used herein the term “control” or any contextual variant thereof, is generally intended to describe any type of testable hypothesis based on one or more standards.

As used herein the term “cycle” or any contextual variant thereof, is generally intended to describe any type of identification, characterization, testing and/or remediating of one or more controls in order to comply with a standard.

As used herein the term “process” or any contextual variant thereof is generally intended to describe any type of structure, organization and/or procedure for at least partially completing a cycle.

As used herein, the term “global data” or any contextual variant thereof is generally intended to describe any type of data that is accessible throughout substantially the entire system.

As used herein the term “node” or any contextual variant thereof, is generally intended to describe any type of link, placeholder of data and/or vertex of data

As used herein the term “project” or any contextual variant thereof, is generally intended to describe any type of structure, organization and/or procedure for completing one or more tasks in order to test a control and/or achieve compliance with a standard.

As used herein the term “stage” or any contextual variant thereof, is generally intended to describe any type of portion or subpart of a project.

As used herein, the term “task” or any contextual variant thereof, is generally intended to describe any type of any step, procedure, protocol, action and/or the like, whether automated or manual, that is at least partially implemented to assist in the workflow of a stage, project, process, and/or cycle.

In accordance with various aspects of the present invention, the system and method for project process optimization, compliance management and/or project workflow processing may require identification, characterization, testing and/or analysis of a risk based on a standard and/or a control. In a representative embodiment of the present invention, data may be entered, tested and/or analyzed through any workflow protocol that may employ any type of project, stage, task and/or the like. In another representative embodiment of the present invention, controls may comprise one or more objectives and may be categorized by stages of a workflow. In another representative embodiment, stages may indicate the progress towards achievement of compliance with a standard to a control and/or identification of associated risks.

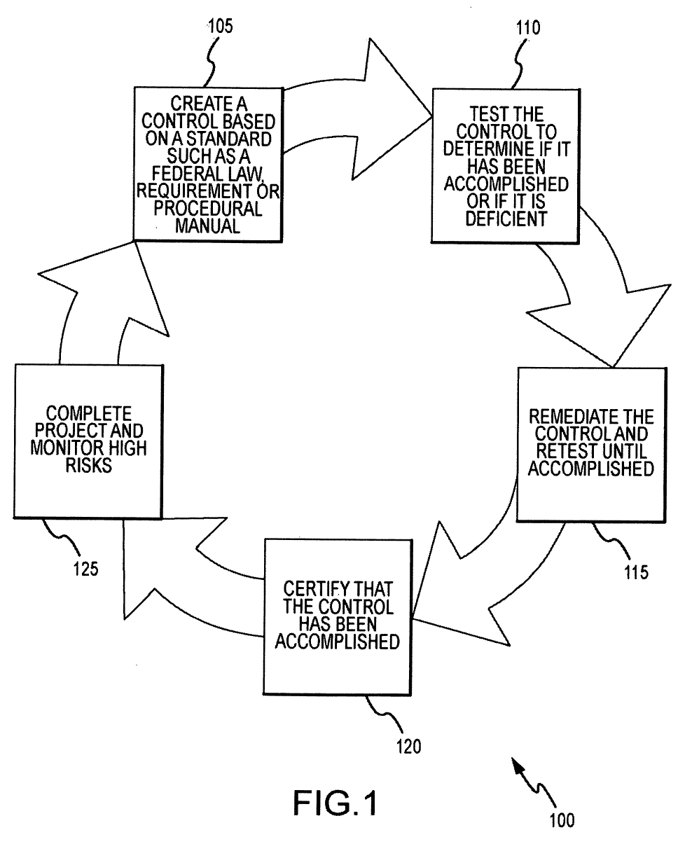

Referring now to FIG. 1, in a representative embodiment of the present invention, the system may be implemented in stepwise fashion to identify, characterize, test and/or analyze a control and/or to identify, characterize, test and/or analyze risk associated with one or more controls. First, a control may be created based on a standard, such as a federal law, regulation, requirement, procedural manual and/or the like [105]. The control may then be tested to determine if it has been accomplished or if it is deficient 1101. If the control has not been successful in achieving compliance with the standard, then remediation may occur and the control may be re-tested until utilization of the control has accomplished compliance [115]. Thereafter, a certification that compliance has been accomplished may take place [120]. Once certification has occurred, a project may be completed, risks may be identified, analyzed and/or subsequently monitored [125] through repetition of the stepwise cycle, starting again with creation of a control [115].

In accordance with various aspects of the present invention, one or more controls may be formatted as a function of a standard that the business wishes to comply with. In a representative embodiment of the present invention, controls may be implemented through the creation of one or more tasks. In another representative embodiment of the present invention, one or more tasks may be implemented to test a control. In yet another representative embodiment of the present invention, tasks may be organized in a hierarchal scheme.

In a representative embodiment of the present invention, a hierarchal scheme may comprise a cycle, process and control. A cycle may comprise the processes required for compliance with one or more standards. One or more process may be performed to complete a cycle. Further, one or more controls may be tested in order to complete a process.

The disclosed representative system includes various functions to perform tracking and/or monitoring of a control through entry, verification and/or analysis of data. For example, the system may be suitably configured to organize data based on any suitable classification or grouping of classifications.

Data may be classified as global data and/or project data. In another representative embodiment of the present invention, global and/or project data may be implemented or utilized in any suitable manner, including through various hierarchical organizations, levels of organization, links and/or the like. In another representative embodiment of the present invention, relations between various data elements may be subsequently implemented in a hierarchical data scheme, such as a global hierarchy, project hierarchy and/or the like.

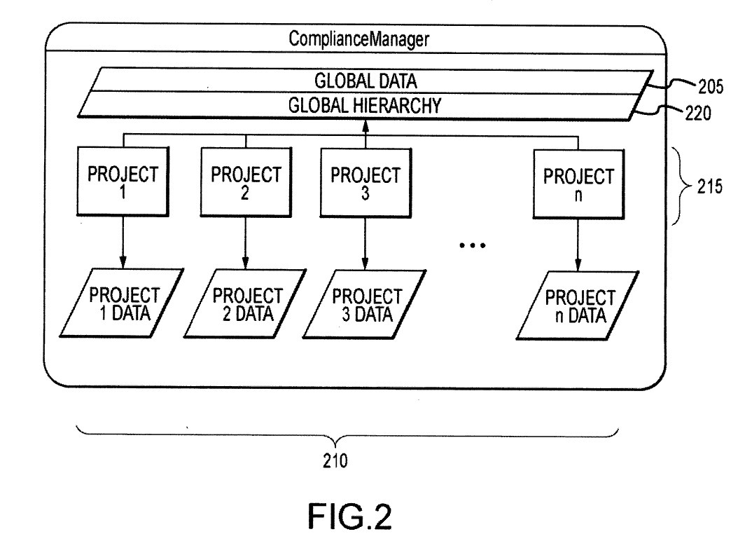

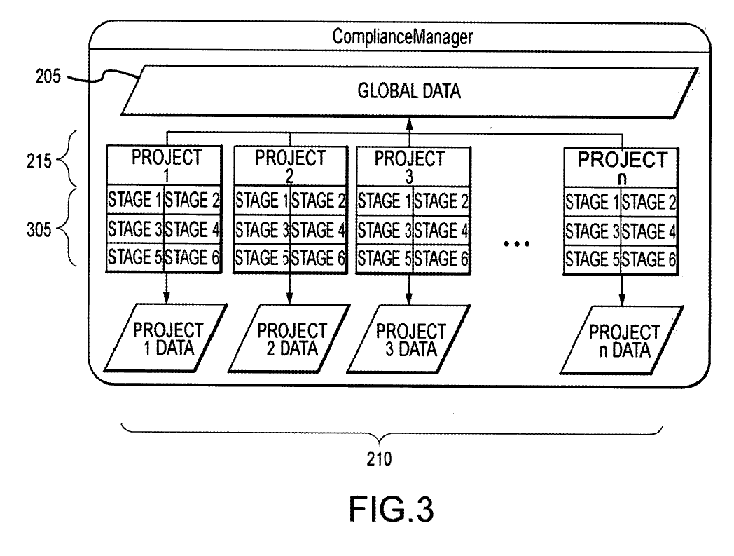

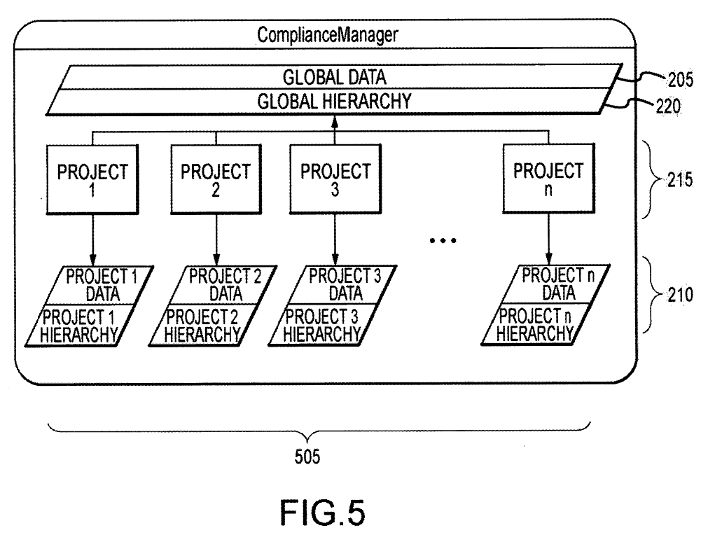

Referring now to FIGS. 2, 3 and 5, in a representative embodiment of the present invention, global data 205 may or may not be characterized as specific to any particular project 215, but rather may be configured to be accessible throughout the system by substantially every project and may be used as a framework to develop a global hierarchy 220 of data. Project data 210 generally comprises data specific to one or more projects 215, and is not typically accessible throughout the entire system, but rather only accessible to one or more projects 215 and/or one or more stages 305 within a project. Furthermore, project data may be used as a framework to develop a project hierarchy of data 505.

Various aspects of the present invention may be implemented within the system in any suitable manner, such as through an organizational scheme, hierarchy system, access levels and/or the like. In a representative embodiment of the present invention, global data may comprise any data that may be required in multiple projects; for instance in the SOx Compliance embodiment Section 302, information may be a required in multiple projects and controls and therefore would be susceptible to characterization as global data. In another representative embodiment of the present invention, global data may comprise input that may need to be accessible to substantially all users of the system.

In another representative embodiment of the present invention, global data may be organized under a single root node. In yet another representative embodiment of the present invention, a single root node may comprise an entire business. In yet a further representative embodiment, a single root node may comprise part of a business, such as a division, sub-division, department, subsidiary, sector and/or the like.

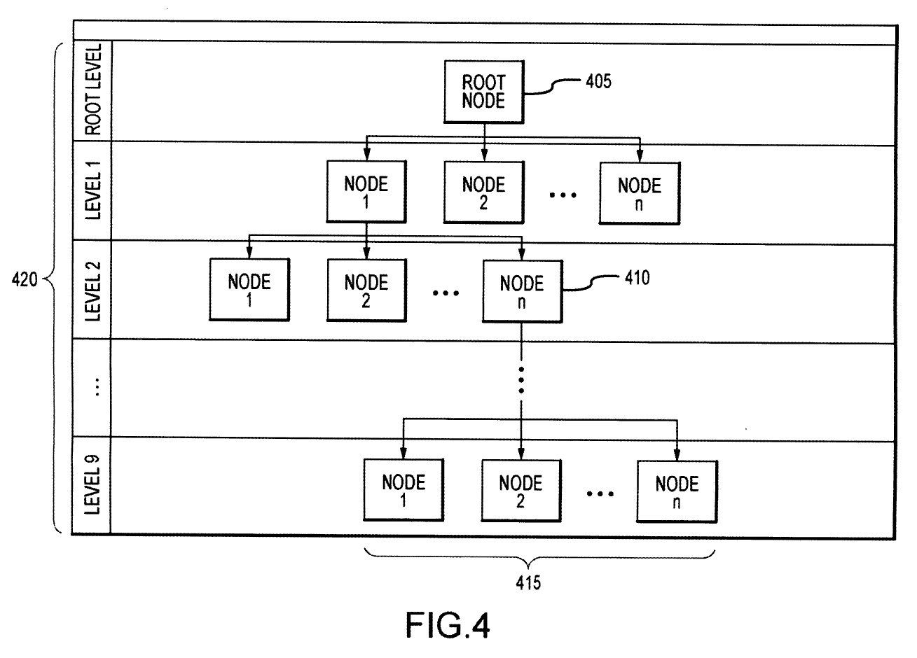

Referring now to FIG. 4, global data may be organized through the use of a single root node 405 wherein multiple nodes 410 are connected to the root node 405 in a substantially linear fashion, and may involve multiple levels of organization 420. In a representative embodiment of the present invention, each node 410 may have nodes 415 underneath, but generally no node 410 will be directly linked across to another node 410. Additionally, global data may be organized such that there may be child-to-child node relationships. Alternatively, conjunctively or sequentially, data may be linked in a variety of different structures or with other relationships, whether such structure or relationships are now known or hereafter described in the art.

Project data, in accordance with various aspects of the present invention, may be organized in multiple levels of organization, project hierarchies and/or the like. In a representative embodiment of the present invention, a project hierarchy may be implemented such that the hierarchy and data associated with it may be at least substantially accessible at the project level and not the global level. In another representative embodiment of the present invention, project data may also be attached to any global node in any level. Such an embodiment would allow project data to be accessible throughout the system. In yet another representative embodiment of the present invention, data connected to parent nodes in the project hierarchy may not be connected to more than one parent and generally will not connect across root nodes; meaning that each root node may comprise an independent tree of data from all other nodes.

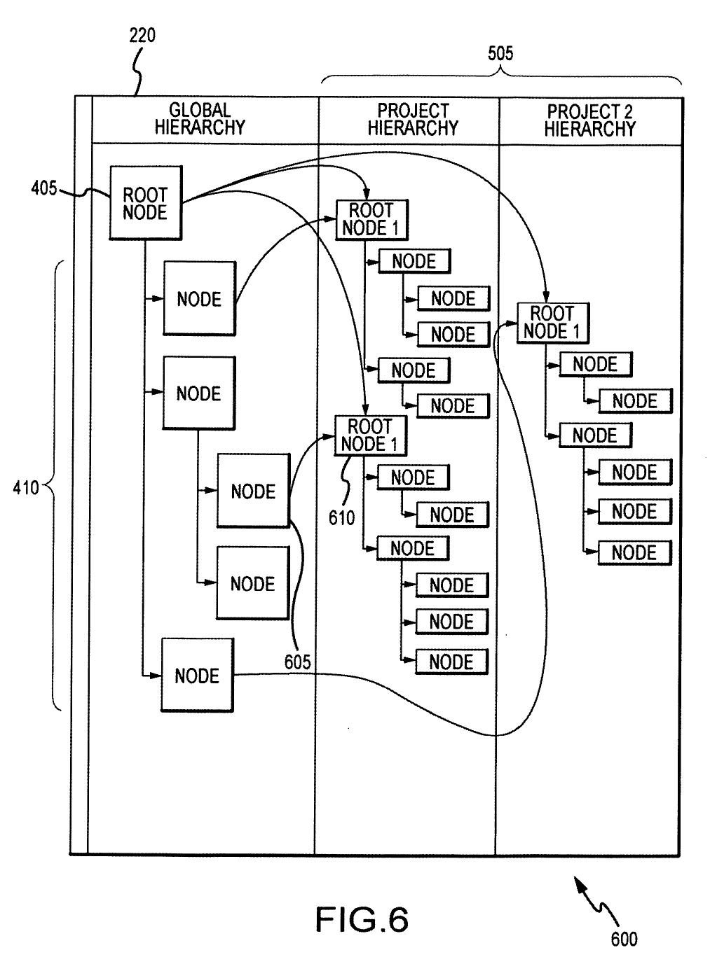

Referring now to FIG. 6, in a representative embodiment of the present invention, the system may be structured to include a summary navigation tree 600. By combining the global hierarchy 220 and the project hierarchy 505, the summary navigation tree may be used to navigate within the system. This combination may be created through elements of project data that may be associated with a node 410 in the global hierarchy. The summary navigation tree 600 may allow users to search, navigate and/or access both the global and project data. Summary navigation trees 600 may represent various relationships between root nodes, parent nodes and/or child nodes and/or the like. In a representative embodiment of the present invention, a summary navigation tree 600 may be specific to single projects and may not contain project nodes from multiple projects. In another representative embodiment of the present invention, a subsequent node 605 of a global hierarchy may also function as the root node 610 in a project hierarchy 505.

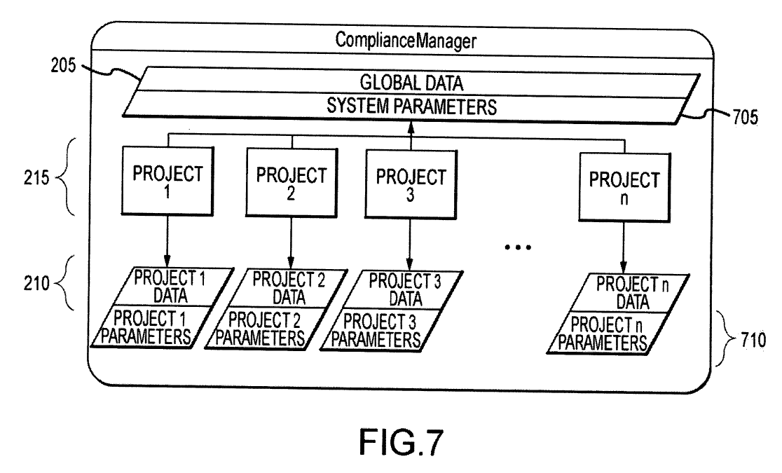

Data may be grouped in the system through the use of a variety of system parameters. System parameters may include any number of organizational levels. The system parameters generally allow the system (including projects, stages and tasks) to be easily configured and customized when necessary. Referring now to FIG. 7, in a representative embodiment of the present invention, system parameters may include global parameters 705 and project parameters 710. Global parameters, in accordance with various aspects of the present invention, may classify data that is generic across all projects while project parameters classify data which is specific to a single project.

In a representative embodiment of the present invention, global parameters may comprise code data (also known as name data) and value data. Code data may be implemented to serve as an identifier of a parameter. In another representative embodiment of the present invention, code data may be at least partially suitably configured for separate access from value data. In yet another embodiment of the present invention, value data associated with a particular parameter may be at least partially edited by a user.

System parameters, in accordance with various aspects of the present invention, may be grouped into smaller sets of data called domains. Domains may be identified in system parameters through code values, data values and/or the like. In a representative embodiment of the present invention, domains may comprise varying levels of accessibility depending on the type of user, type of data associated with a domain and/or the like. In another representative embodiment of the present invention, a domain may be available for a user to modify. In yet another representative embodiment of the present invention, one or more parameters may be hidden from users and/or only accessible to installation experts. In yet a further representative embodiment of the present invention, accessible domains may have at least two levels of access: edit or full control.

In another representative embodiment of the present invention, a domain may be editable by the user to change the value associated with a parameter. If the domain is that of “full control”, then the user may add, edit, delete and/or reorder the parameters within the domain.

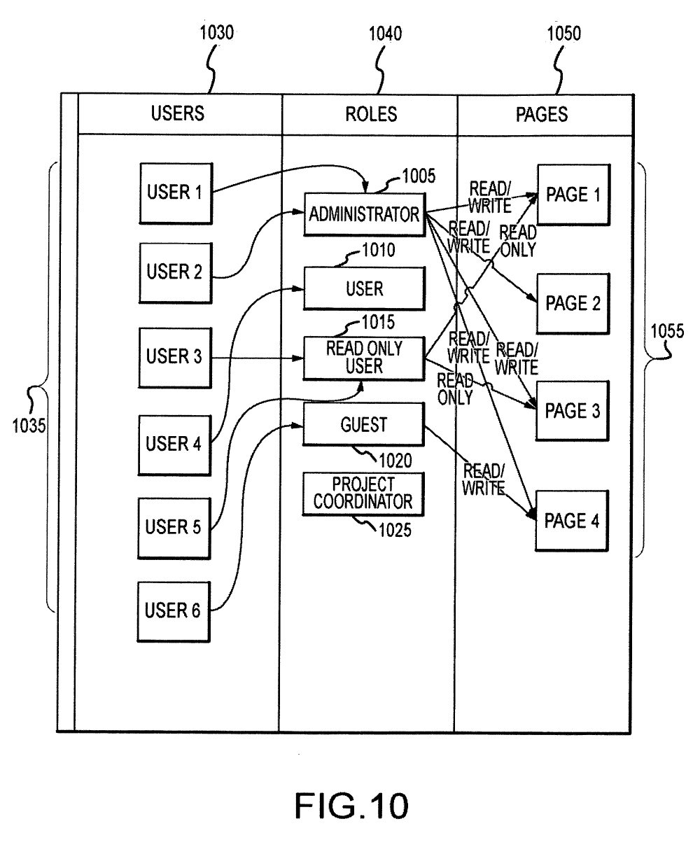

In accordance with various aspects of the present invention, the system may be designed to allow for multiple levels of access which may be referred to as roles. Referring now to FIG. 10, in a representative embodiment of the present invention, different roles 1040 may include those of administrators 1005, users 1010, read-only users 1015, guests 1020, project coordinators 1025 and/or installation experts. Various users 1030 may be assigned to roles 1040. However, individual users 1035 may generally only be assigned to one role 1040. Additionally, a role 1040 may determine whether a user has read-only access or read/write access to various pages 1050. Individual pages 1055 may generally be configured to allow one type of access assigned per role 1040.

Administrators generally have the ability to add and/or update current users, as well as inactivate and/or delete users. In a representative embodiment of the present invention, a user will generally not be deleted, but rather may be deactivated.

The system may be adapted to present a series of web-pages to display information specific to each user of the system. The first webpage may comprise a login page, where each user may enter specific information in order to access individualized web-pages. The first webpage accessed by each user will generally be the system or project homepage.

User information entered, accessed and/or stored on the system may include any information concerning the users, such as address, phone number, email address and/or the like, or may be implemented to display each user's name. In a representative embodiment of the present invention, a user's information may be entered, updated and/or accessed through a user maintenance page. In another representative embodiment of the present invention, the user maintenance page may be accessible through an administrator homepage. The user maintenance page may include a list of all_users including their name, user role (i.e., guest, full user, read-only user, etc.), their position and telephone number. The administrator may filter the results shown on this page by active and/or inactive users. In addition, the administrator may search any user based on any of the fields displayed on the user maintenance page.

In a representative embodiment of the present invention, the administrator may enter each user in a sequential fashion on the user maintenance page and/or may enter all of them at once using the import feature. In another representative embodiment of the present invention, an import feature may allow an administrator to upload a spreadsheet with all of the user information, where the system may automatically update the user information. In order to update information on a user and/or to view a user's information the administrator selects the user's name on the user maintenance page and the administrator is directed towards the user profile page.

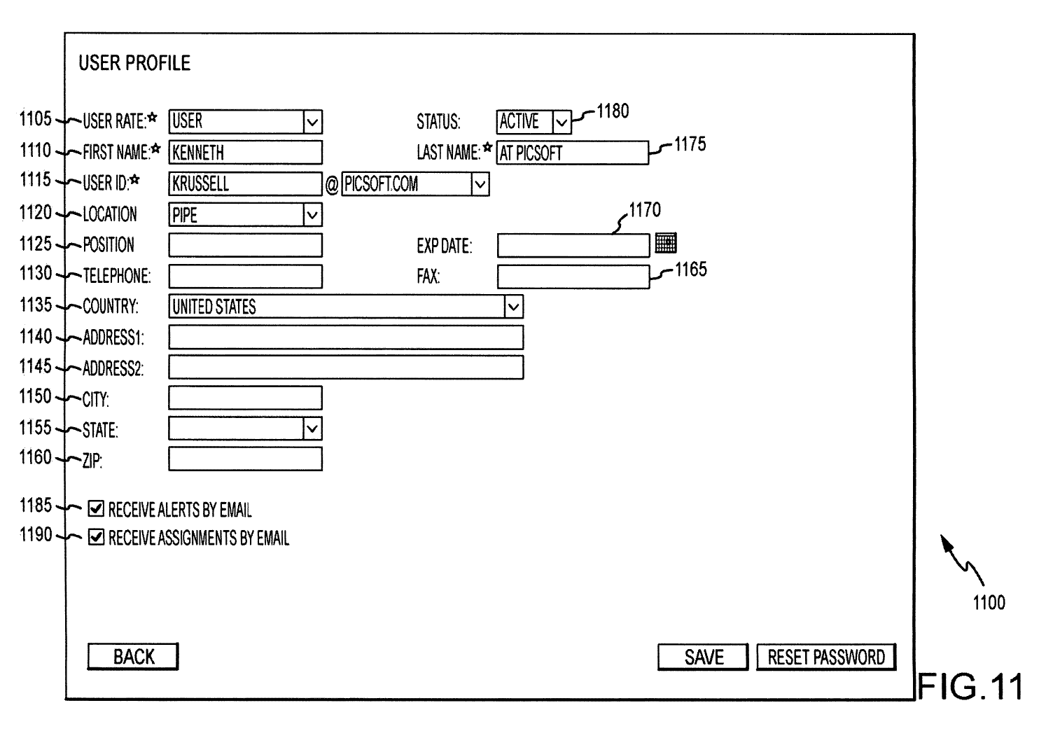

The system may also comprise a user profile page that may be implemented in any suitable manner to allow users to view and/or change their information. Referring now to FIG. 11, in a representative embodiment of the present invention, the User Profile page 1100 may be configured to allow a user and/or administrator to view and/or update a user's role 1105, name 1110 1175, status 1180 user ID 1115, position 1125, expiration date 1170, location 1120, telephone and fax number 1125 1165, address 1135, 1140, 1145, 1150, 1155, 1160 and notification settings, including whether a user would like to “Receive Alerts by Email” 1185 and “Receive Assignments by Email” 1190. In a representative embodiment of the present invention, when the user profile page is displayed to the user, various fields may be modifiable. In another representative embodiment of the present invention, a user profile page may be displayed for the user after the first login so that the user may change their password. In yet another representative embodiment of the present invention, a user profile page may be displayed when a user password has been reset.

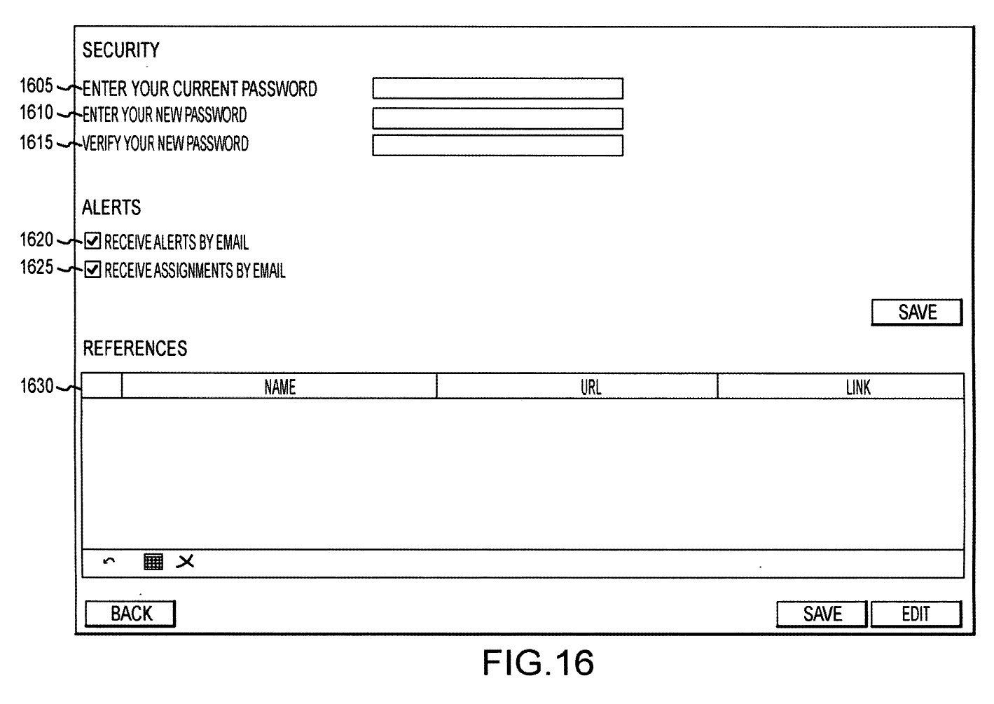

As the user profile page is only available to the user after the first login or if their password was reset, the user may access User Preferences via the homepage. Referring now to FIG. 16, the User Preferences page allows the user to change their password by entering the old password 1605 and the new password 1610 1615 as well as change the notification settings 1620 1625 and includes a references box 1630. The references box allows the user to store link information and has a column for reference name and the reference URL link. In another embodiment of the present invention, a reference box in the User Profile page 1100 may comprise an area where a user may add links such as personalized web pages links, live feeds, connections to informational pages, databases, reference databases, and/or the like.

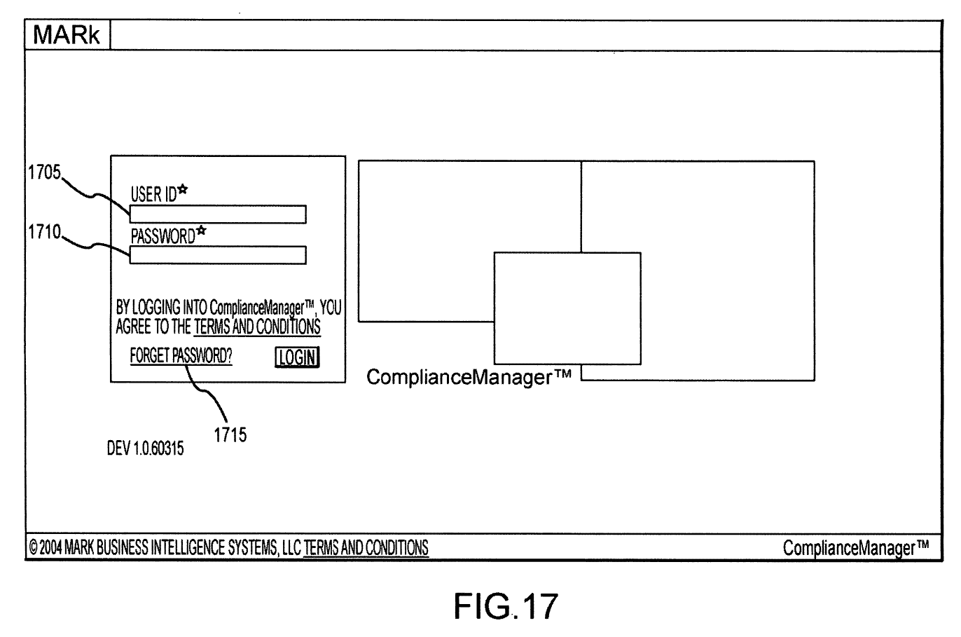

A login page may be implemented in any suitable manner, such as with the utilization of multiple screens or specifically customized towards each user. Referring now to FIG. 17, in a representative embodiment of the present invention, the User Login page 1700 provides a field for users to enter their user ID 1705 and password 1710, and additionally provides a Forgot Password 1715 button. In another representative embodiment of the present invention, the Forgot Password 1715 button directs the user to enter in their user ID. The system then emails the user a randomly generated password, they may follow the login procedure, entering their name and then the new random password. After the system accepts the information, the user may then be directed to the User Profile page 1100 where they may enter the randomly generated password again and create a new password before being allowed to access their normal homepage.

One or more security measures may be implemented in the system in order to maintain and/or secure integrity, including passwords, one-time use passwords, voice authorization and/or the like. It will be further appreciated that a randomly generated password may be created in any suitable manner, such as through a software program, a hardware device and/or manually. In a representative embodiment of the present invention, every user password will generally be encrypted in the database using one-way or hash encryption. The one-way encryption operates to prevent or impede the password from being decrypted and assures that no one other the user will know the user's password. However, passwords may be secured using any method, whether now known or otherwise hereafter described in the art, to prevent a person other than the user from accessing the system, such as two-way encryption and/or the like.

In a representative embodiment of the present invention, the system comprises at least three levels of protection. These levels may comprise user lockout, randomly generated new passwords and/or hashed passwords. The user lockout typically prevents or impedes the user from logging into the system if the user exceeds the preset number of login attempts or exceeds the preset time for the user to attempt to login. If either the login time and/or login attempts exceed the security requirements, the system locks the account preventing access and a popup is displayed alerting the user that their account has been temporarily locked and to contact the administrator to unlock the account. The login time, the login attempts and the lockout time may be modified by the administrator to better suit the needs of the business. If a user is locked out of the system, the administrator may unlock the user's account through the user maintenance page on the User Profile page 1100. The user profile page will typically include a box allowing the administrator to uncheck it and allow the user to access the system.

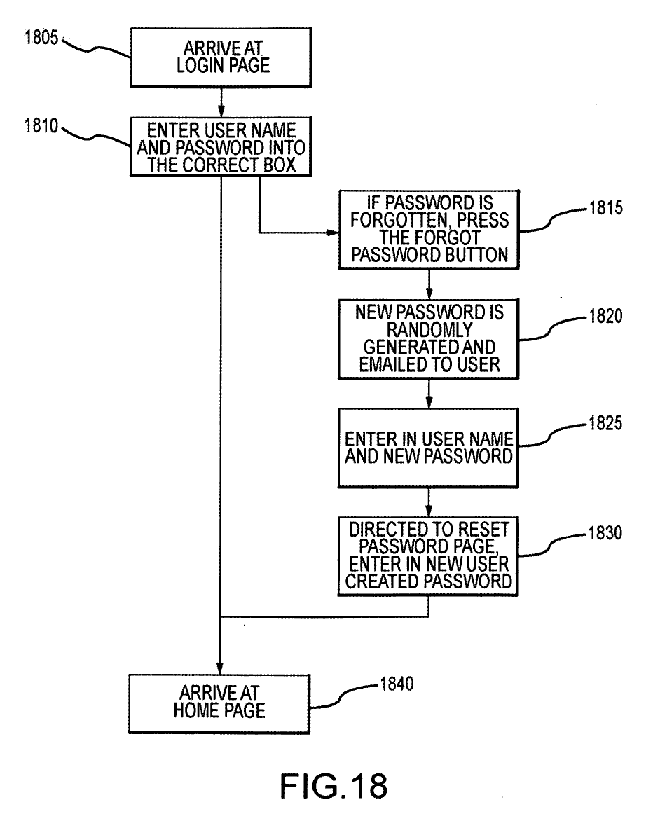

Referring now to FIG. 18, in a representative embodiment of the present invention, when attempting to access the system, a user will first encounter a login page 1805. Thereafter, a user will be required to enter a name and password into the designated boxes 1810. If a password is forgotten, reset and/or if it is the first time that a user is logging onto the system 1815, an email is sent to the user using the email address provided by the administrator with a randomly generated password 1820. This password allows the user to enter the name and password to login 1825, but the user is then directed to the user profile page and instructed to change their password 1830. Thereafter, a user may be directed to the Home (or other designated) page 1840.

A homepage, in accordance with various aspects of the present invention, may be implemented in any suitable manner and may comprise links to one or more stage pages and/or may not be included as a default page after login. It should be further appreciated that in accordance with various aspects of the present invention, the system may be implemented to comprise an overall project gauge. At the bottom of each user's homepage, an Overall Project Gauge chart may be displayed to denote project status for all users. The gauge generally represents the current status of the project selected by the user. The system may employ user-defined parameters to calculate the percentage of a project or task that has been completed as well as predicting completion of a particular stage. The Overall Project Gauge displays a range of percentages from 0 to 100% and then uses a marker or arrow to highlight or select the most accurate percentage to describe the overall project status. The overall project gauge may be implemented in any suitable manner, such as on a popup screen or may be shown as a table graph, pie chart and/or the like.

The system framework may group large portions of data into one or more projects. In a representative embodiment of the present invention, a project may represent a procedure for testing one or more controls, compliance with a standard and/or the like. In another representative embodiment of the present invention, each project may comprise distinct data that may be separated from other projects in the system. In yet another representative embodiment of the present invention, a project may access the global data and/or the project data specific only to that project. Additionally, the system may handle multiple projects and may be configured such that no project may access and/or use data from another project. In yet a further representative embodiment of the present invention, the system may be configured such that data from projects may be accessed by substantially all other projects.

In accordance with various aspects of the present invention, the system may be implemented to include a blank installation project that may be loaded with user template data. The installation project generally provides a framework which users may tailor to fit their specific needs. Users may also create new projects. In order to create a new project, the user copies either the installation project and/or a previously used project; however, the system may allow users to create a project in any suitable manner, such as programming a new project or uploading projects from other programs and/or systems. If a previous project is copied to create a new project, the data from the old project may be copied as well, reducing the need for re-entering redundant data. Furthermore, all projects may have the ability be viewed, edited, archived, and/or copied through a project maintenance page.

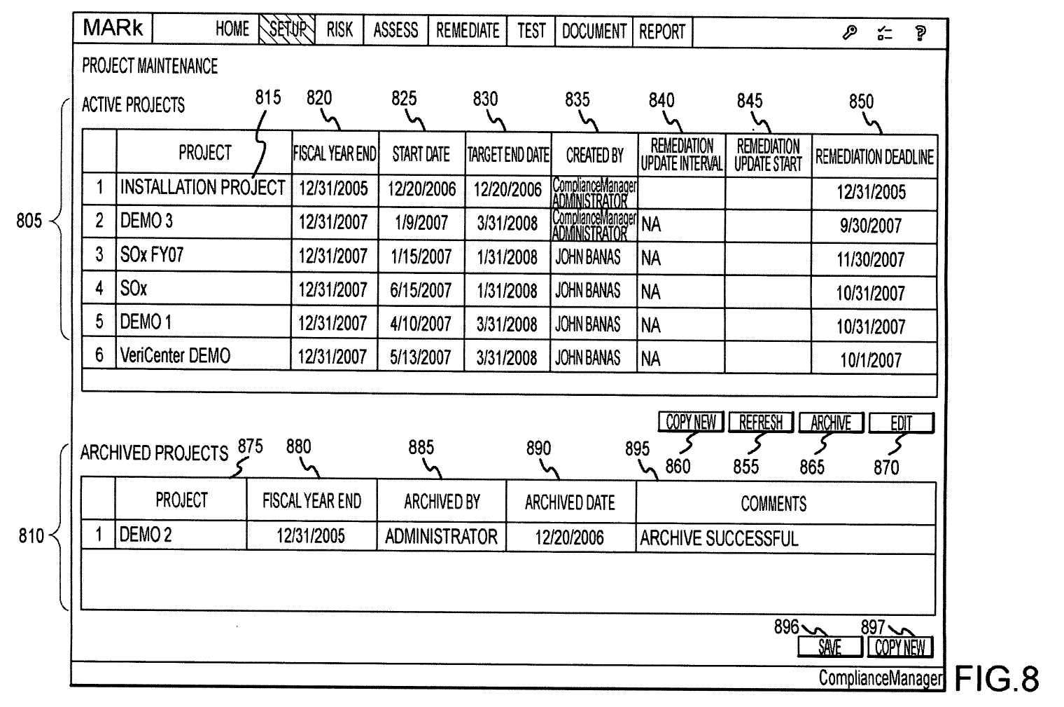

The project maintenance page, in accordance with various aspects of the present invention, displays a list of at least part of the projects. In a representative embodiment of the present invention, this page may only be accessible by the administrator and/or a project coordinator. Referring now to FIG. 8, in a representative embodiment of the present invention, a Project Maintenance page 800 may comprise Active Projects 805 and Archived Projects 810. Active Projects 805 may comprise an Installation Project 815 and any number of other projects currently open. The Project Maintenance page 800 may further detail the Fiscal Year End 820, a Start Date 825, Target End Date 830, Created By 835, Remediation Update Interval 840, Remediation Start 845, and Remediation Deadline 850. In another representative embodiment of the present invention, at least one of these columns may be automatically populated and/or automatically updated based on global and/or project data and/or changes to global and/or project data. Additionally, a “Refresh” button 855 may allow a user to update the information displayed in the Active Projects 805. Other buttons, such as “Copy New” 860, may provide the current display of Active Projects 805 to become a template for a new list of Active Projects 805. Furthermore, buttons such as “Archive” 865 and “Edit” 870 may be provided on the Project Maintenance page 800.

The Project Maintenance page 800 may be implemented in any suitable manner to provide access to the archived projects 810. In a representative embodiment of the present invention, Archived Projects 810 on the project maintenance page 800 may be itemized by the following columns: Project 875, Fiscal Year End 880, Archived By 885, Archived Date 890, and Comments 895. In another representative embodiment of the present invention, least one of these columns may be automatically populated and/or automatically updated based on global and/or project data and/or changes to global and/or project data. Additionally, in a further representative embodiment of the present invention, users may be given the availability to save the Archived Projects 810 by operation of a “Save” button 896. Furthermore, other buttons such as “Copy New” 897 may be displayed to allow users to use the Archived Projects 810 as a template.

In a representative embodiment of the present invention, projects may be archived at any time desired by the user, such as when a project is finished and/or no longer in use. The system may be designed in any suitable manner such as that data of an archived project may continue to include read/write status or the user may select whether the data of an archived project should be demoted to read-only status. In a representative embodiment of the present invention, after archiving, the data and functionality of the project may move to a read-only status. This read-only status generally permits users to view data, however no modifications may be made to the data.

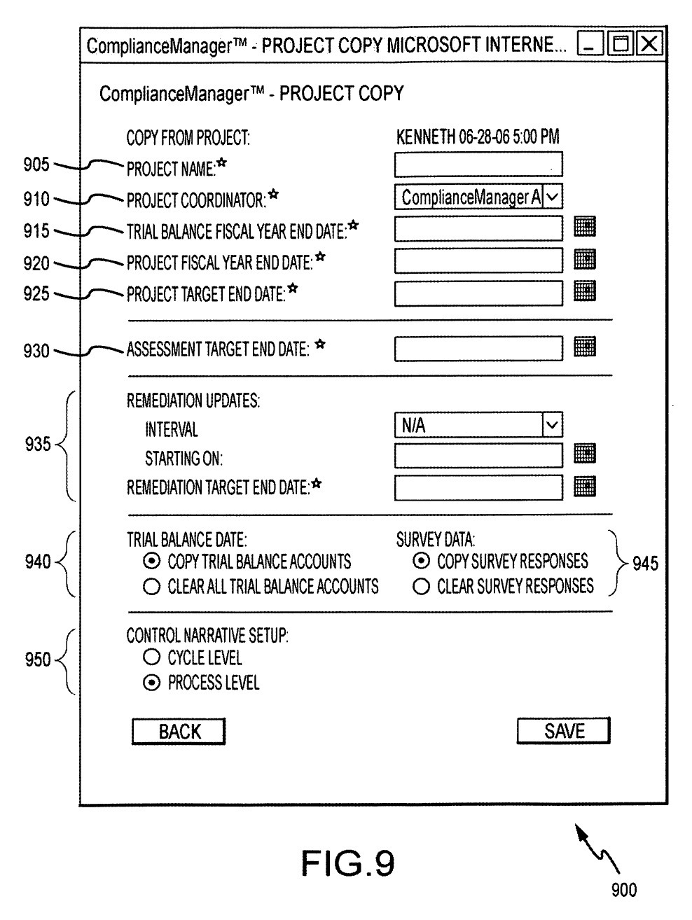

In another representative embodiment of the present invention, the system may be designed such that an archived project may be removed from archive status, returning read/write status to the data. Referring now to FIG. 9, in a representative embodiment of the present invention, an administrator may create a new project by entering data into a Project Creation Page 900 wherein the following may be entered: Project Name 905, Project Coordinator 910, Trial Balance Fiscal Year End Date 915, Project Fiscal Year End Date 920, Project Year End Date 925, Assessment Target End Date 930, Remediation Updates, including Interval, Start Date and Target End Date 935, Trial Balance Data 940, Survey Data 945 and Control Narrative Setup 950. The project coordinator 910 administers the project and controls the assignment of initial tasks in the first stage of the project. The first task assignments may be originally assigned to the project coordinator and the project coordinator may reassign tasks to any other users.

In a representative embodiment of the present invention, once a project is created, a user may have the option of setting milestone dates for that project, such as the Trial Balance Fiscal Year End Date 915, Project Fiscal Year End Date 920, Project Year End Date 925, Assessment Target End Date 930, Remediation Updates, including Interval, Start Date and Target End Date 935. These dates may be used to set due dates within project stages so that the system may set initial due dates for tasks as they progress through different stages. For example, in a representative embodiment of the present invention, milestone dates may used by the system to predict when a control and/or task should be completed in order for the entire project to be completed by a date certain. In another representative embodiment of the present invention, a user may be informed of the dates on their homepage and when a task or control has not yet been completed by the predicted date then it is shown as being past due. The milestone dates generally reflect the dates in which the business wants to have certain tasks and/or projects accomplished. It will be appreciated that the system may be designed to function without milestone dates and may allow each user to predict when each task or control should be completed.

Once a project is setup, in accordance with various aspects of the present invention, a project plan may be created. It should be appreciated that a project plan in accordance with the present invention may comprise at least one task and at least one project. In a representative embodiment of the present invention, custom tasks and/or stages may be defined within a project and custom tasks may be tracked throughout the system.

In a representative embodiment of the present invention, in order to set up a project workflow, an administrator may select the Plan Project button at the top of the homepage, which then directs the user to the Project Plan screen. A Project Plan screen allows the user to define custom tasks as well as providing links to view the status of existing tasks. Custom tasks may be created and tracked within the Project Plan function, while pre-populated tasks may be subject to the system workflow process.

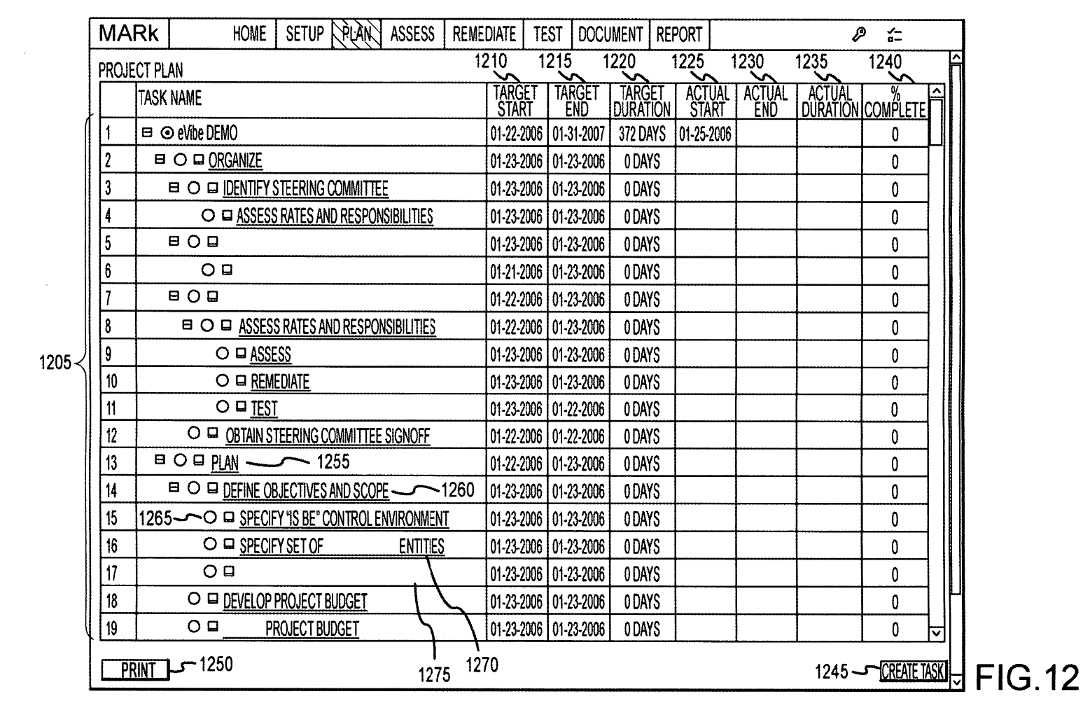

Referring now to FIG. 12, in a representative embodiment of the present invention, a Project Plan screen 1200 comprises custom tasks 1205, where these tasks may comprise subtasks. For example, the “Plan” task 1255 may comprise a subtask of “Define Objectives and Scope” 1260 that includes the subtasks: “Specify ‘to be’ control environment” 1265; “Specify list of participating entities” 1270; and “Review program scope and approach with external auditors” 1275. Additionally, information such as Target Start 1210, Target End 1215, Target Duration 1220, Actual Start 1225, Actual End 1230, Actual Duration 1235, and % Complete 1240 may be included as columns coordinated with the associated tasks.

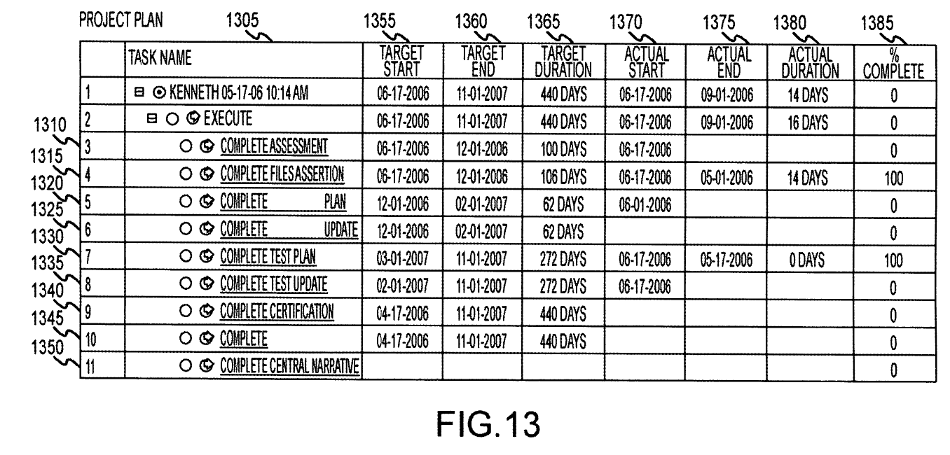

Pre-populated tasks may comprise tasks that may be included within the system after installation. Additionally, pre-populated tasks may comprise any number of tasks created prior to access by an administrator and may be altered in any manner. For example, in a representative embodiment of the present invention, a Project Plan screen 1300 may be formatted to conform and provide functionality in association with a SOx compliance management system. Referring now to FIG. 13, the pre-populated tasks 1305 may include: Complete Assessment 1310; Complete Risk Assertion 1315; Complete Remediation Plan 1320; Complete Update 1325; Complete Test Plan 1330; Complete Test Update 1335; Complete Certification 1340; Complete Workflow 1345; and Control Narrative 1350.

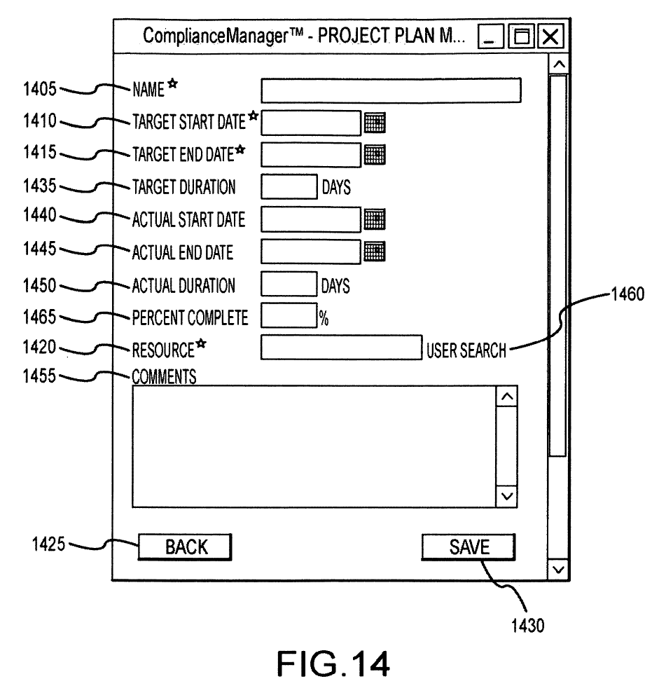

Referring now to FIG. 14, in a representative embodiment of the present invention, a task screen 1400 may provide a mechanism for creating new tasks and/or providing relevant status information. If an administrator wishes to create a new custom task, they may enter the name of the task, the target start and end dates, and the name of the user responsible for the task in the appropriate fields (for example, those labeled: “Name” 1405; “Target Start Date” 1410; “Target End Date” 1415; and “Resource” 1420) to identify which users may be assigned the task. This identification may be performed through a user search 1460 function. Additionally, “Back” 1425 and “Save” 1430 buttons may be included. Once a task has been created, additional information may be inserted, viewed, and/or edited in fields in the Task Screen 1400. These fields may include: “Target Duration” 1435; “Actual Start Date” 1440; “Actual End Date” 1445; “Actual Duration” 1450; “Percent Complete” 1465; and “Comments” 1455.

The task summary generally provides a table of all tasks, including pre-populated and custom tasks with relevant status information that may include: the name of the task; the target start date; the target end date; the target duration; the actual start; the actual end; the actual duration; and the percentage completed.

Tasks may be implemented in any suitable manner, such as allowing split tasks, including only separate tasks for separate work or allowing users to work on the same task without the split task requirement. In a representative embodiment of the present invention, a task may be assigned to only one user. In another representative embodiment of the present invention, a task may be split and/or assigned to more than one user. Additionally, tasks may be split into multiple tasks to allow different users to work on various tasks concurrently.

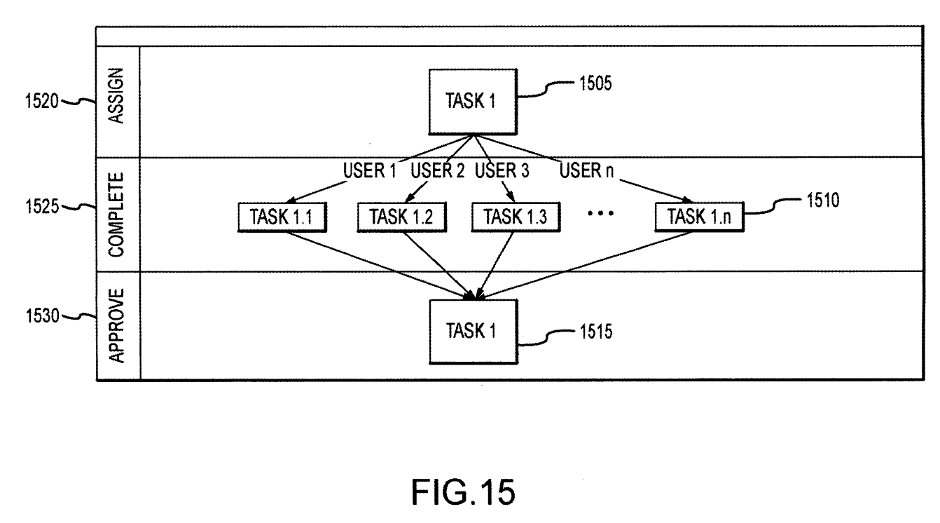

Referring now to FIG. 15, in a representative embodiment of the present invention, a task 1505 may be divided and/or assigned to one or more users in the assign stage 1520 of the task. During the complete stage 1525, parts of the task 1510 may be completed by the user to which that particular part is assigned. Thereafter, the completed task 1515 may be moved to the approval stage 1530. In another representative embodiment of the present invention, if the task does not pass the approval stage 1530, it may be returned (i.e., remediated) back to the assign stage 1520.

In a representative embodiment of the present invention, a task name for a pre-populated task may comprise a hyperlink to a summary to allow the user to see the status of the task as well as the individual task assignments at various levels in the organizational and navigational hierarchy. For example, a user may track the progress of the individual assignments that are needed for completion of any task within the system. Custom tasks may provide a link to a popup screen which may comprise the task screen (see, for example, FIG. 14.). The summary popup may not be needed for pre-populated tasks, since those tasks usually automatically determine the status and start dates by following individual assignments and tracking when they have been marked completed. In addition, the task list may be printed or exported to a Microsoft Excel spreadsheet, Apple Mesa spreadsheet, Adobe Acrobat PDF document or any table or spreadsheet format. Various tasks names and updating schemes may be implemented in any suitable manner in order to allow the tasks to be viewed and updated either automatically or manually.

A project may comprise one or more stages with each stage having one or more tasks. There may be any number of stages within a project with any number of tasks assigned, completed and/or approved in any particular stage. For example, in a representative embodiment of the present invention, there may be six stages in a SOx compliance project comprising: Risk, Assess, Remediate, Test, Document and Report.

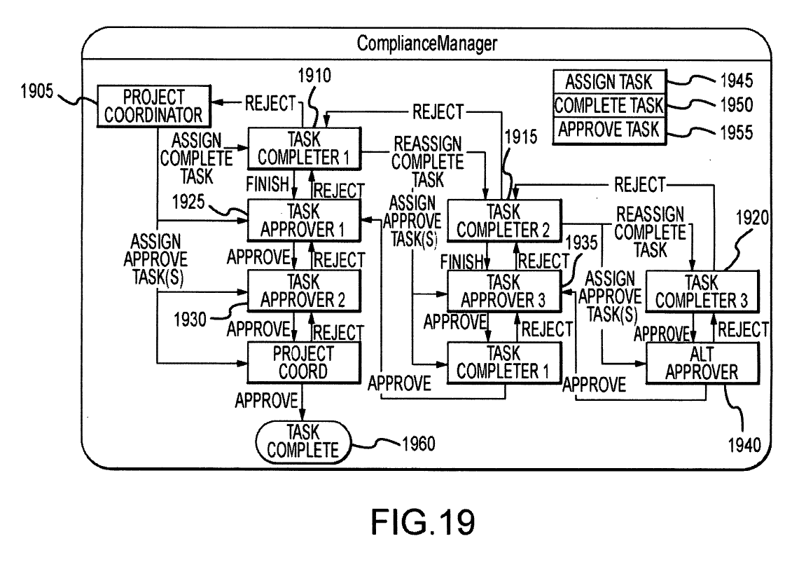

In another representative embodiment of the present invention, the assignment, completion and/or approval of tasks generally allows a project to move through one or more stages toward completion. A task workflow may comprise the following: assign, complete, approve, reject, and reassign. Referring now to FIG. 19, in a representative embodiment of the present invention, a task workflow may comprise a project coordinator 1905, one or more task completers 1910, 1915, 1920, and one or more task approvers 1925, 1930, 1935, 1940. The project coordinator 1905 assigns one or more task completers 1910, 1915, 1920 to complete, and one or more task approvers 1925, 1930, 1935, 1940 to approve and/or reject. There are various series of approvals, reassignments and/or rejections that may take place prior to final approval by the project coordinator—where subsequently the task may be labeled “complete” or finished 1960.

Each stage may be in communication with other stages, allowing for tasks to be transferred from stage to stage, for example, using a standard workflow. The standard workflow may be arranged in any suitable manner with more or fewer stages being included. Additionally, task may be designed such that they do not need to process an entire workflow stage.

In a representative embodiment of the present invention, a standard workflow may include stages corresponding to: assign, complete, approve, not started, complete, past due, in progress, reject, re-assign, and reopen. Assign, complete and approve may be classified under assignment types and may be used to define the work that a user may be required to do for a certain task. Each stage may require that the task progress through the assignment cycle, and therefore a task may not be transferred to a new stage until it has been assigned, completed and approved. Not started, complete, past due, in progress, rejected, re-assign and reopen may be classified under task status to alert users and administrators to the current status of a task. During each portion of the assignment cycle, the task status may progress through all or merely a portion of the status cycle. For example, in another representative embodiment of the present invention, a task may never reach the past due or rejected status or may always reach the past due and rejected status, but may remain individually dependent on the task and the work completed by the user.

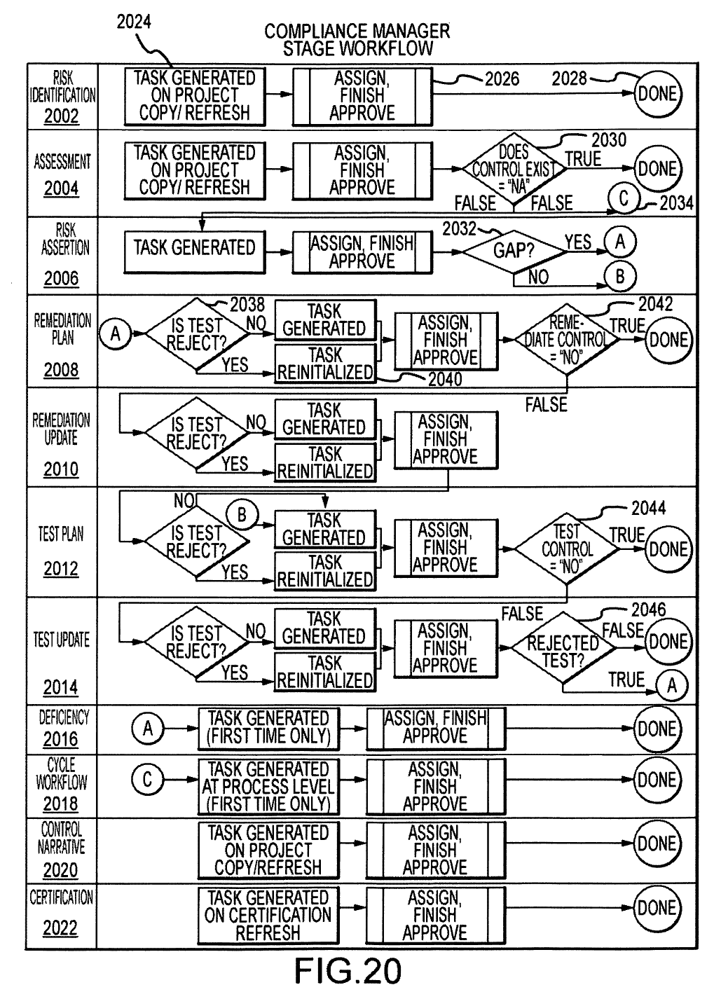

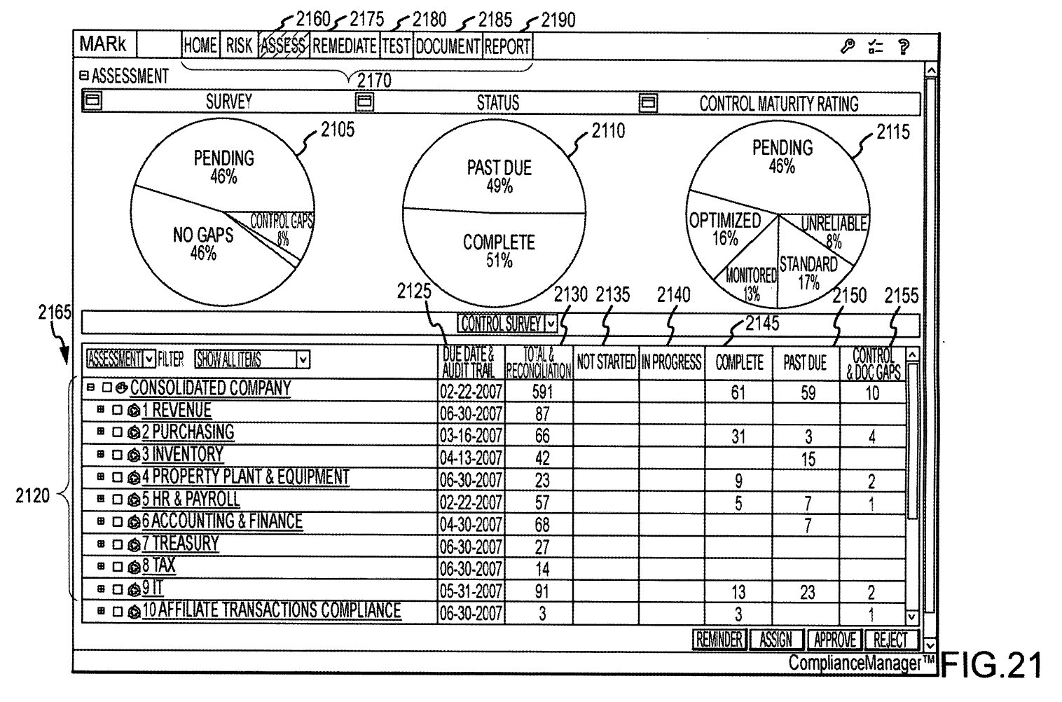

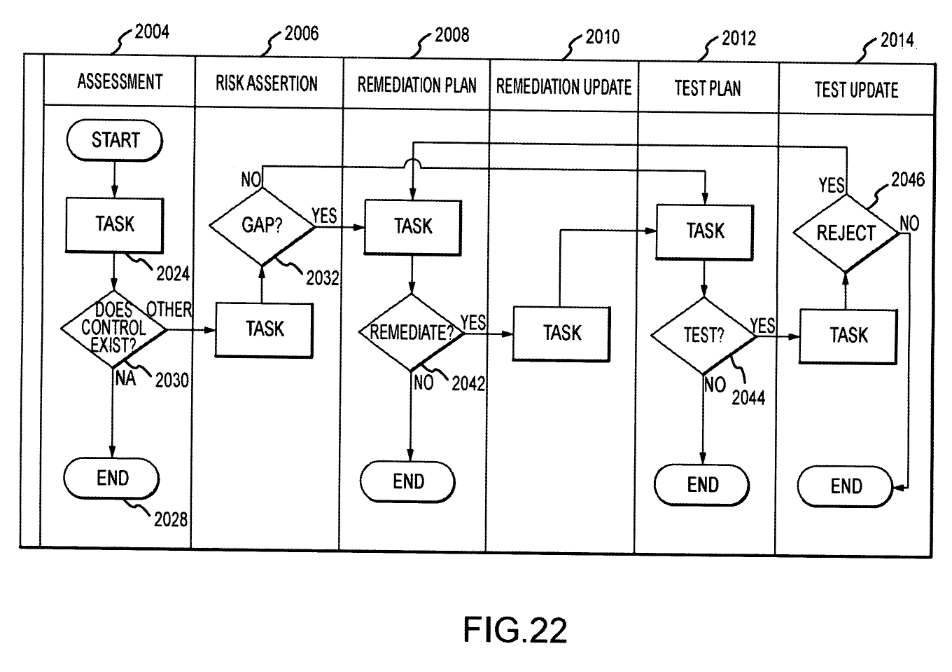

Referring now to FIGS. 20 and 22, in an exemplary embodiment of the present invention, representative stages may include: risk identification 2002; assessment 2004; risk assertion 2004; remediation plan 2008; remediation update 2010; test plan 2012; test update 2014; deficiency 2016; cycle workflow 2018; control narrative 2020; and certification 2022. During the stages of risk identification 2002, control narrative 2020 and certification 2022, a task may be generated 2024, subsequently assigned, finished and approved 2026 and thereafter completed 2028. During the assessment stage 2004, a task may be generated 2024, subsequently assigned, finished and approved 2026, and if no control exists 2030, then the assessment may be considered completed 2028. If a control does exists 2034, then the system moves to the cycle workflow stage 2018, where a task may be generated 2024, subsequently assigned, finished and approved 2026 and thereafter completed 2028. Alternatively, if a control exists the system may move to the risk assertion stage 2006, wherein a task is generated 2024, it may be subsequently assigned, finished and approved 2026 and thereafter subjected to a determination as to whether a gap 2032 exists.

A gap may comprise any deficiency, inconsistency and/or the like between a result of a task and a control. For example, in a representative embodiment of the present invention, a gap may exist when the control is configured to determine whether employees are affirmatively aware of ethics policies of a business, and the task comprises surveying employees to verify whether they have read and understand the ethics policies, and the result is, for example, that the employees have never read the ethics policies. In this instance, a gap exists between the result of the task and the control. Therefore, a remediation plan may be put in place before the control is tested; where absent a remediation plan, the control would otherwise necessarily fail.

If a gap exists 2036, the system moves into a remediation plan stage 2008, where if a test was not rejected, a task may be generated 2024, subsequently assigned, finished and approved 2026. If it is determined that the control does not need to be remediated 2042, then it is generally regarded as completed 2028. If the test was rejected, a task may be reinitialized 2040, subsequently assigned, finished and approved 2026. If it is determined that the control does not need to be remediated 2042, then it may be regarded as completed 2028. If the control does need to be remediated, the system moves to the remediation update stage 2010, where if a test was not rejected, a task may be generated 2024, subsequently assigned, finished and approved 2026 and subsequently moved to the test plan stage 2012. If the test is rejected 2028, a task may be reinitialized 2040, subsequently assigned, finished and approved 2026 and thereafter moved to the test plan stage 2012. Once in the test plan stage, if a test was not rejected, a task may be generated 2024, subsequently assigned, finished and approved 2026. If it is determined that the control does not need to be tested 2046, then it may be regarded as completed 2028. If the test was rejected, a task may be reinitialized 2040, subsequently assigned, finished and approved 2026. If it is determined that the control does need to be tested 2046, then it moves to the test update stage 2014. If a test was not rejected, a task is generated 2024, subsequently assigned, finished and approved 2026 and if it is not rejected 2046, then it may be regarded as completed. If the test is rejected 2028, a task may be reinitialized 2040, subsequently assigned, finished and approved 2026, and if the test is again rejected, then it moves to the deficiency stage 2016. In the deficiency stage, a task may be generated (generally only the first time), subsequently assigned, finished and approved 2026, and then it may be regarded as completed 2028.

In another representative embodiment of the present invention, each stage and its status may be included on the homepage of a user. The stage and status may be included in the To Do List. The To Do List may comprise columns for Pending Assign Task, Pending Task, Pending Approval, Rejections, Due Date, Past Due and Review Tests. Each stage may be configured to use specific portions of the project data, however each stage may still be able to access substantially all of the project data. Multiple projects are generally not able to access the project data stored for only single projects, but if the project was created with copied data, then the multiple projects may typically access the data.

It should be appreciated that in accordance with various aspects of the present invention, the system may be further configured to provide one or more icons to notify users about task assignments and/or alerts. The icons may include, for example: Assign, Complete, Approve, Reject, Comment, Run, Edit and/or the like. The Assign Icon may be configured to notify the user that an Assign task assignment has been assigned. The Complete Icon may notify the user that a Complete task assignment has been assigned. The Approve Icon may notify the user that an Approve task assigned has been assigned. The Reject Icon may alert the user that task assignments have been rejected. The Comment Icon may notify the user that a comment has been attached to the task assignment or a Reject state has been activated on the task assignment. The Run icon may allow a user to run a report or query after setting up the initial parameters or selecting a saved set of parameters. The Edit icon may indicate to the user that the data displayed is available to be modified. The delete icon may indicate to the user that the displayed data is available to be deleted from the project, task, stage or even from the system. That notwithstanding, various other icons or buttons may be displayed for any selected action and may be implemented in any suitable manner, whether now known or hereafter described in the art.

Due dates may be created for task assignments when they are generated. The initial due dates for Assign task assignments may be generated from milestone dates that are defined when the project is setup. These milestone dates may be selected by an administrator in order to satisfy the project requirements and the objectives of the business. When a Complete task is generated, the user assigning the task will typically set the due date on the assignment popup. The due date created generally cannot be past the task assignment for the Assign or Complete task assignment due date, and additionally will not be before the current date when the assignment is made. When the Approved tasks are generated, the due dates may be calculated using a project parameter that sets the number of days that additional approvers will have before the final due date. The Approve task assignment may be created for the assignee or the alternate approver and will typically be the same as the Assign or Complete task assignment, depending on whether it is an assignment or a reassignment. Each additional Approve task assignment will have a date previous to the date by the number of business days set in the project parameter. The due date for each additional approver typically cannot be before the due date for the Complete task assignment it is associated with. It will be appreciated that the due dates function is not necessary for the system to function correctly, and due dates may be implemented in any suitable manner. Users may select the required due dates for tasks, and tasks may be designed such that due dates are not needed and users simply complete the tasks on their own schedule, and/or the like.

Stage display pages, in accordance with various aspects of the present invention, may be implemented in any suitable manner. For example, organization and page placement may be altered and items included on the page may be omitted and/or new items added. In a representative embodiment of the present invention, a stage may be displayed on the To Do List of each user, with each stage having its own link in the navigation bar. The stage link takes the user to a separate page for each stage. In a representative embodiment of the present invention, a page may be set up in a substantially similar fashion for each stage, and may further be configured to conform to design elements embodied in the homepage. In another representative embodiment of the present invention, a page may comprise one or more status indicators, such as pie charts and/or table graphs, that display information about each stage, such as the reliability of the information, the status of the stage, the gaps and/or lack of gaps in survey data, and/or the like.

In a further representative embodiment of the present invention, status of all tasks within a particular stage (typically represented by percentages) may be provided for designations corresponding to Pending, Complete, Not Started, and/or the like. For example, the summary table may comprise an at least substantially complete status summary of all tasks within a stage, broken down by business unit, process and/or control. Additionally, there may a separate summary table for each stage listed on the phase pages.

Referring now to FIG. 21, in a representative embodiment of the present invention, a stage display page may comprise a survey pie chart 2105, a status pie chart 2110, and a control maturity rating pie chart 2115, as well as a summary table 2165 including columns displaying the process, cycle and/or control 2120 (expand and minimize functions), a link to the due date and audit trail 2125, totals and reconciliation 2130, not started 2135, in progress 2140, complete 2145, past due 2150, as well as control and document gaps 2155. The summary table 2165 may include data illustrating the summary for all of tasks and controls in a particular process, stage or even in a cycle. In another representative embodiment of the present invention, a user may filter the results by task, choosing to either show all tasks or show just pending tasks, pending approvals, rejected items, assignment items only, as well as past due and key controls. In yet another representative embodiment of the present invention, table column widths and row heights may be customizable by a user and may be adjusted to display information in any manner desired.

In another representative embodiment of the present invention, the summary table 2165 may include a hyperlink for each process, cycle and/or control, wherein the process and cycles may include maximize and minimize options which may be used to show or hide child controls and/or cycles. When a user selects the hyperlink, the user may be directed to a survey summary. The survey summary may include a header or may be modified to illustrate the hierarchy level, such as business unit, cycle, process and/or control. In yet another representative embodiment of the present invention, the header at a business unit level may include a tab bar displaying at least part of the cycles that are under the business unit. The bar may display the current units that a user is viewing. In yet a further representative embodiment of the present invention, the header bar at the cycle level may also include a tab bar comprising processes under a cycle and displays the current business unit and/or cycle being viewed. The header bar at the control level may not have a tab bar, and the hierarchy bar may display the current business unit, cycle and/or control being viewed. The header may also include bookmarks that direct a user to representative survey information that the user wishes to view.

Bookmarks may vary based on the stage a user is viewing in the survey summary. In a representative embodiment of the present invention, a survey summary may comprise a list of responses to the surveys in addition to hyperlinks directing the user to the attached documents and details of the control.

In accordance with representative aspects of the present invention, data may be gathered by the system in various ways, such as via data entered into the system through directly uploading data, entering data manually, or through data linking. In a representative embodiment of the present invention, a method of entering data into the system may comprise the use of one or more surveys. Surveys may be tailored to any control, process and/or cycle and may be designed to input template data in the system, thereby reducing the risk and increasing the compliance of the control, process and/or cycle. Surveys may be displayed to a user and have fields requesting certain information from the user.

In another representative embodiment of the present invention, a survey may request information from the user through a list of questions which have built-in validations and/or business rules. The survey may include survey information, control survey assessment, and/or control survey risk attributes. The survey information may also include information such as details about the control, the preparer's name, whether the control is an interview and, if so, the name of the employee interviewed.

In yet a further representative embodiment of the present invention, one or more validations may be used to confirm that data has been entered correctly and/or that business rules have been used to ensure correct data entry by predicting the next element of data. In yet a further representative embodiment of the present invention, a survey may be built from a template of data elements, with each data element having metadata associated with it to characterize the grouping, data type, display type, length, name of the field, and/or the like. The surveys may also be used to enter information about the controls to calculate risk information.

Data may be pre-populated into a survey field inasmuch as data elements may be re-used in multiple surveys in the system, allowing the data entered in one survey to be displayed as either read-only and/or editable data in a subsequent survey. In a representative embodiment of the present invention, data may be pre-populated through business rules and/or system calculations. For example, there may be a field value that might correspond to the result of multiple single fields processed through an algorithm (such as the total annual sales number may be the sum of each month's sales total) and then the resulting value may be populated into a field.

Data validations may be used to attempt to at least partially verify and/or confirm data and/or data accuracy. The system may include validations for various types of data such as alpha, numeric, alphanumeric, date, time and/or the like. For example, in a representative embodiment of the present invention, a data validation may be used such that if the survey requires a numeric answer, only a numeric entry will be permitted. In another representative embodiment of the present invention, the system may perform more complex data validations, such as using previous data inputs to determine the type of validation so that if all monthly sales totals were greater than zero, then the system will not allow the yearly sales total to be zero.

In yet another representative embodiment of the present invention, surveys may comprise implementation of one or more business rules. Business rules may be designed to allow the survey to direct the user to fill-in the correct fields and input correct data. The business rules may direct a user to or away from one or more fields based on one or more previous fields and/or quanta of data.

Data entered into the system in response to a survey may comprise information stored separately from the actual values associated with a particular data element. In a representative embodiment of the present invention, information such as when the data was modified, which user modified it and/or any other desired information, may be stored along with the actual modified data.

A data element in the system may comprise at least one of a base value and a task value. Representative base values, in accordance with the present invention, may be associated to a specific project node and are distinct to that project node, so that although a project node may be duplicated across global nodes, the data values will typically remain the same for each hierarchy. Representative task values, in accordance with the present invention, may be associated to a project node and a global node and may be distinct to that project and/or global node. In the navigational hierarchy, when a project node is duplicated across more than one of the global nodes, the task values may be unique for each hierarchy.

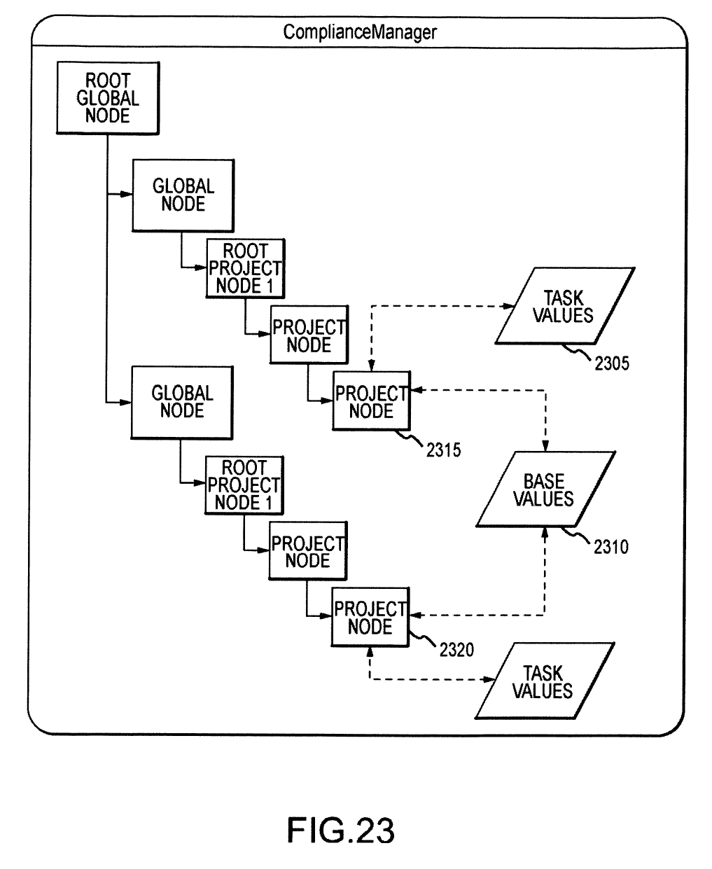

Referring now to FIG. 23, in a representative embodiment of the present invention, a task value 2305 and a base value 2310 may be associated with a project node 2315. The base value 2310 may be associated with more than one project node 2315, 2320. In such an embodiment, if a data element comprises a task value 2305, and this data element is changed in a project, it may not be changed in the global data. In another representative embodiment of the present invention, if a data element has a base value and this data element is changed in a project, it will be changed in the global data 2310.

Metadata may be implemented to provide a tracked change function. In a representative embodiment of the present invention, whenever a new data element may be defined within the system, the user or administrator may select to have a flag set such that the values for that data element will be audited. Any change to the specific data element values, either task or base values, may be recorded along with the user who made the change in addition to the date and time that the value was changed. In such a representative embodiment, substantially all data changes may be archived, creating an inclusive history of substantially every data element in the system. In another representative embodiment of the present invention, if the value altered by the user comprises a task value, project node and global node identifiers may be saved with the audit information. If the value is a base value, then only the project node identifier may be saved with the audit.

The system may generate one or more identifiers that may be used to identify a cycle, process, control activity, and/or the like. Identifiers, in accordance with various aspects of the present invention, may be visible to a user in the system, such as with survey information. In a representative embodiment of the present invention, a cycle identifier may comprise one number, such as a positive integer. In another representative embodiment of the present invention, a process identifier may comprise two numbers, such as two integers with a period in between the first and second number, wherein the first number comprises the corresponding cycle identifier and the second number comprises a project identifier. In yet another representative embodiment of the present invention, a control activity identifier may comprise three numbers, wherein the first corresponds to a cycle, the second corresponds to a process and the third corresponds to a control activity attached to that particular process, and these numbers may be positive integers separated by periods. For example, if a cycle comprises the identifier “1”, a process may comprise the identifier “1.2” (indicating it is associated with the cycle comprising the identifier “1”), and a control activity may comprise the identifier “1.2.3” (indicating it is associated with the cycle corresponding to the identifier “1” and the process corresponding to the identifier “2”).

A user may have the option of designating any control within the system as a key control. If a control is designated as a key control, users may filter and/or separate a key control from other controls in the system. In a representative embodiment of the present invention, a control may be designated as a key control if the control is more important or impacts the process or control to a greater extent than other controls. In another representative embodiment of the present invention, a user may designate which controls are key controls by viewing a key control summary which may be accessible via a navigation bar. A key control summary in accordance with various aspects of the present invention may be implemented in any suitable manner to display a key control list to provide a user with information relating to one or more key controls and/or the like.

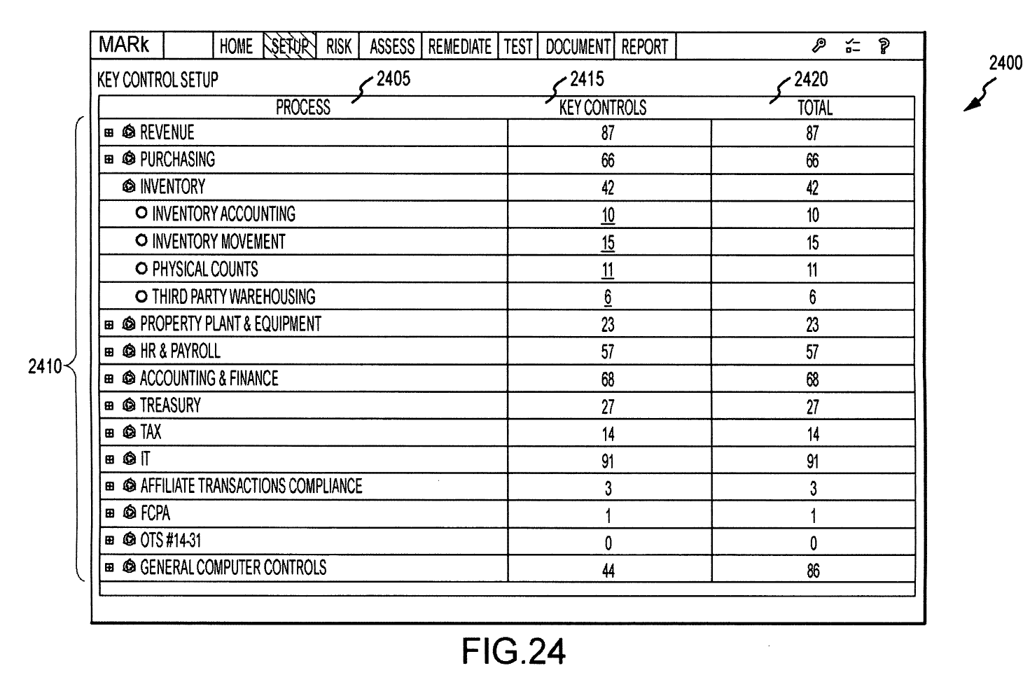

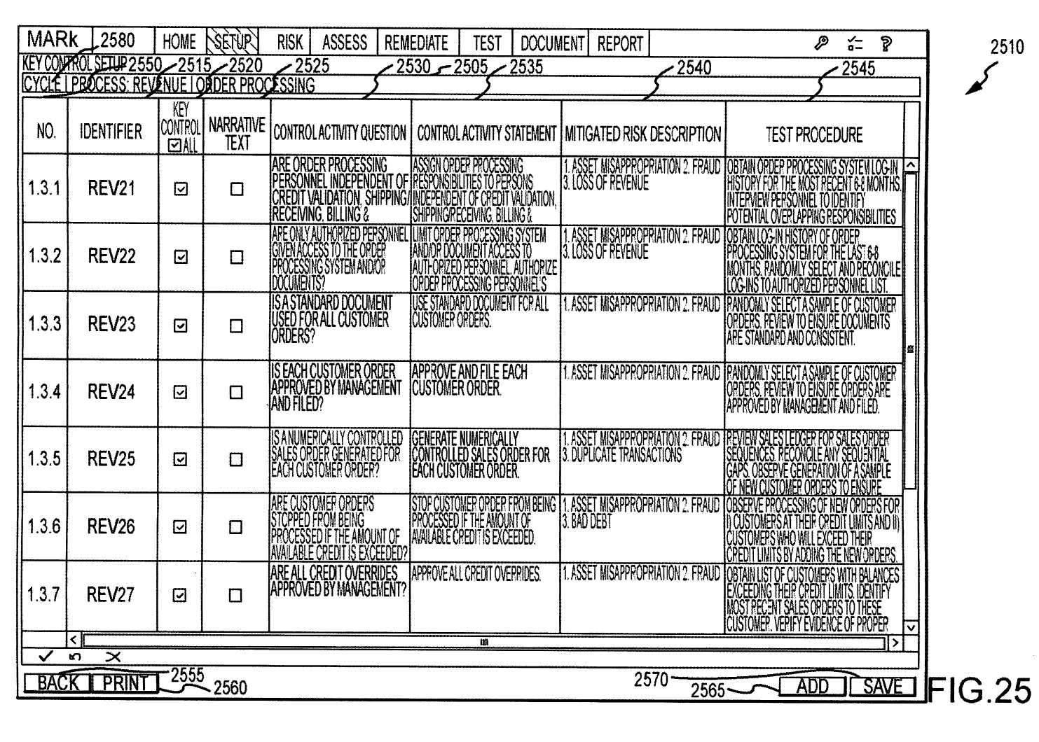

Referring now to FIG. 24, in a representative embodiment of the present invention, a key control summary may utilize a cycle/process hierarchy in the key control summary table 2400 to display basic information about the key controls within each cycle and process. The key control summary table 2400 may comprise a process column 2405 wherein the cycle and/or process hierarchy may be listed 2410. A key controls column 2415 will typically list the number of key controls linked at the process and cycle level. A total column 2420 may be included that lists the total number of controls at the process and/or cycle level. The process level in the process column 2405 may also comprise a link to key control setup details for that process.

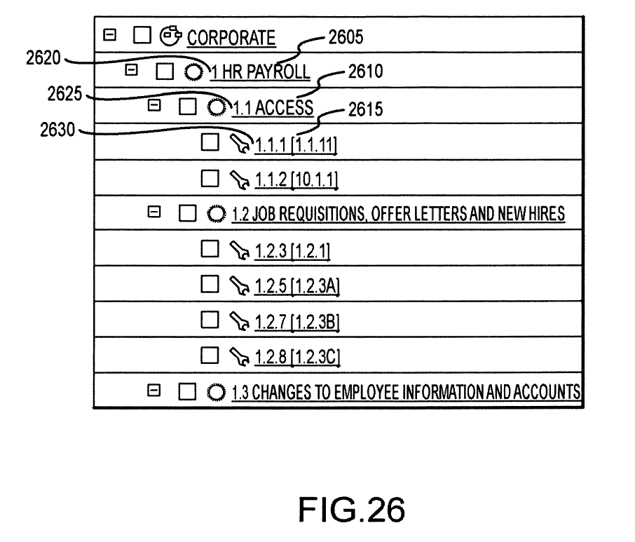

In another representative embodiment of the present invention, a process column 2405 (where the cycle and/or process hierarchy may be listed 2410) may optionally comprise maximize and minimize options, allowing the user to choose how many lower levels to display. Referring now to FIG. 26, in a representative embodiment of the present invention, these levels may be maximized to show a cycle 2605 (such as HR Payroll) a process 2610 (such as Access) and a control activity 2615. Additionally, various identifiers of cycles 2620, processes 2625 and/or control activities 2630 may be listed.

A key control setup details page, in accordance with various aspects of the present invention, may allow a user to set one or more key controls within a process. Referring now to FIG. 25, in a representative embodiment of the present invention, the key control details page may include a table 2510 and a hierarchy bar 2505. The hierarchy bar 2505 may be disposed above the table to display the selected cycle and process name 2580. The table 2510 may comprise key control information and may have various columns. The columns may include a key control column 2520 comprising a check box that, when selected, indicates that a control has been designated as a key control. Optionally, the key control column 2520 may also comprise a ‘check all’ box 2575 that when checked indicates that all controls have been designated as key controls, and a narrative text column 2525. Additionally, the table 2510 may comprise a control activity column 2530 having a control activity question. Additionally, a control activity statement 2535 may comprise a statement which answers the control activity question and/or provides a directive in response to a control activity question. Furthermore, a mitigated risk description 2540 may be present that describes one or more risks associated with a control activity. A test procedure column 2545 may also be present. The test procedure column 2545 may comprise one or more steps and/or instructions in a procedure to test the control. Additionally, a number column 2550 may be present to list the control activity identifier associated with a particular control activity. In addition, at the bottom of the table, a series of buttons (including a Back button 2555) may be provided to direct the user to a previous page, a print button 2560 to print the key controls detail table, an add button 2565 to permit the user to add a key control, and a save button 2570 to save any changes made to the key controls and reflects those changes throughout the system.

In a representative embodiment of the present invention, the system may include custom attributes setup and/or financial statement line item setup pages. The custom attributes setup typically allows data comprising customer specific information to be modified. This customer information may generally comprise global parameters of the system. The custom attribute name and/or description may comprise a set in the system parameters, where this name may be displayed at the top of the custom attribute setup page and/or other places in the system where the attribute may be referenced.

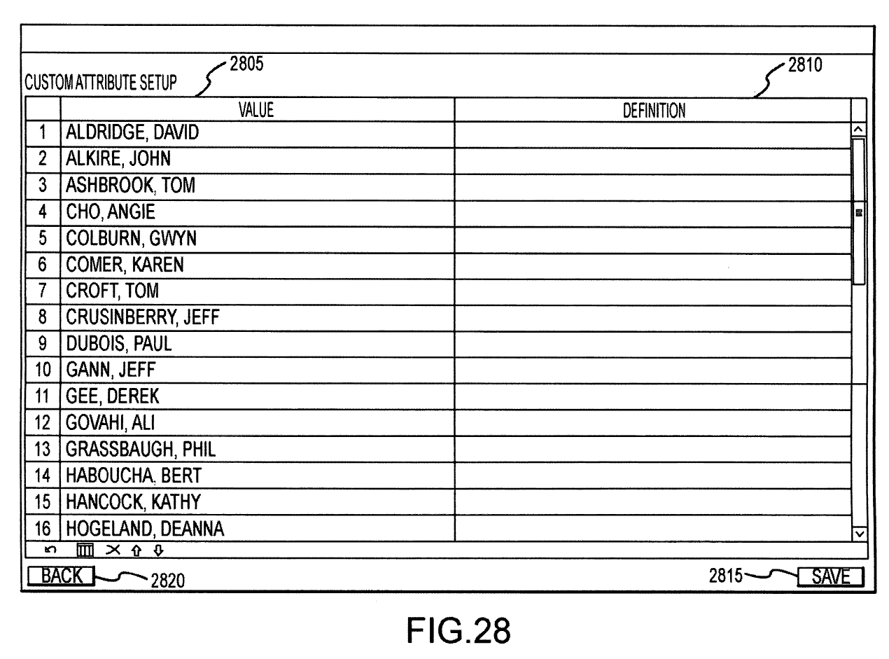

Referring now to FIG. 28, in a representative embodiment of the present invention, a custom attribute setup page may allow the user to add, update, delete and reorder custom attributes, and may comprise a value column 2805 and a definition column 2810. Additionally, a back 2820 and save button 2815 may appear as well. In another representative embodiment of the present invention, a custom attribute may be added as a query field in the query tool. The field will typically have the custom attribute name set in the system parameters as a prefix followed by the custom attribute value.

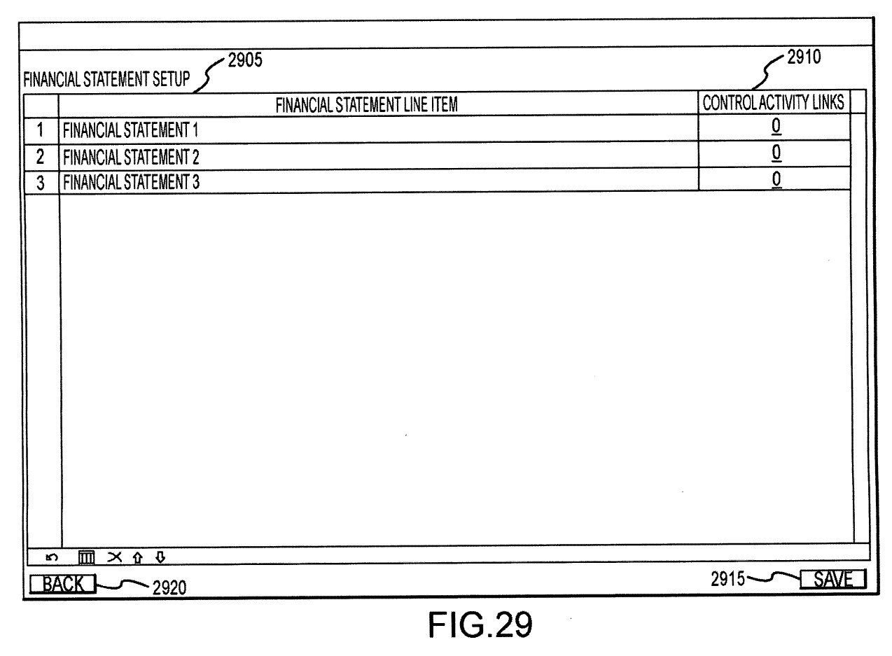

Referring now to FIG. 29, in a representative embodiment of the present invention, a financial statement setup may comprise a financial statement line item column 2905 having the name of a financial statement line item that will be displayed throughout the system and control activities links 2910 that comprise a count of control activities that are linked to the specific financial statement link item. The financial statement line item setup page may be configured to also allow the user to add, update, delete and/or reorder the financial statement line items. Additionally, a back 2920 and save button 2915 may appear to aid navigation within the system interface as well.

Representative systems may also include a control activity setup details page, which may be implemented in any suitable manner to allow a user to add and/or update a control activity within the system. The details page may include a number of user-editable fields. In a representative embodiment of the present invention, editable fields and/or textboxes associated with the details page typically allow a user to select, edit and/or remove the section to be applied to the control. Additionally, in another representative embodiment of the present invention, editable textboxes generally allow a user to enter information specific to the control activity.

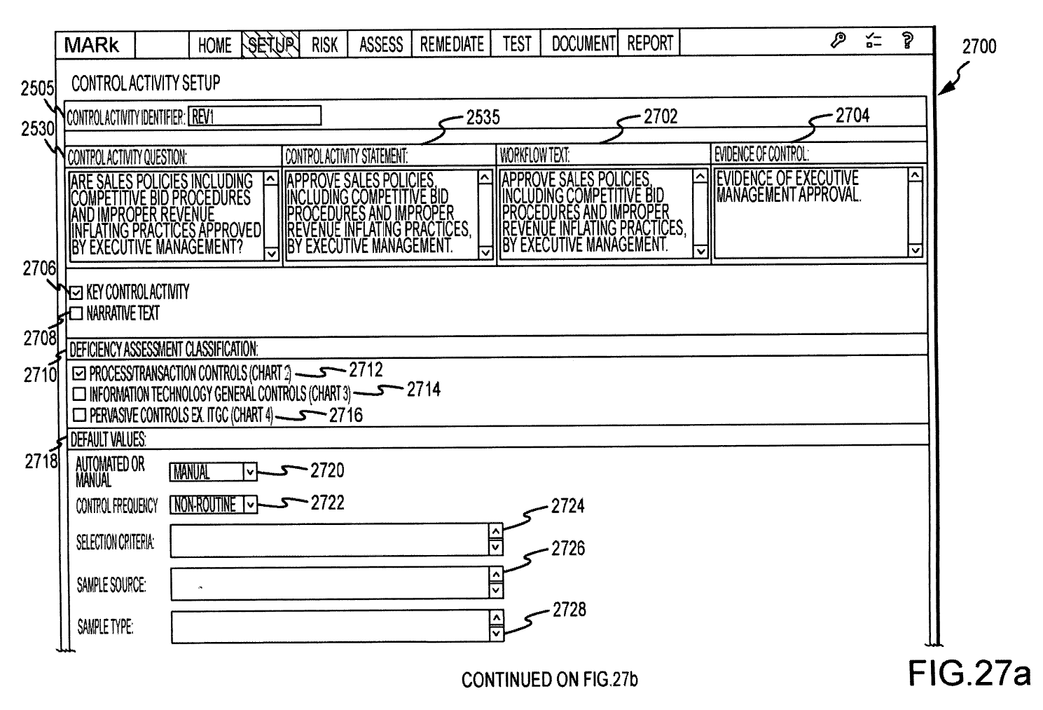

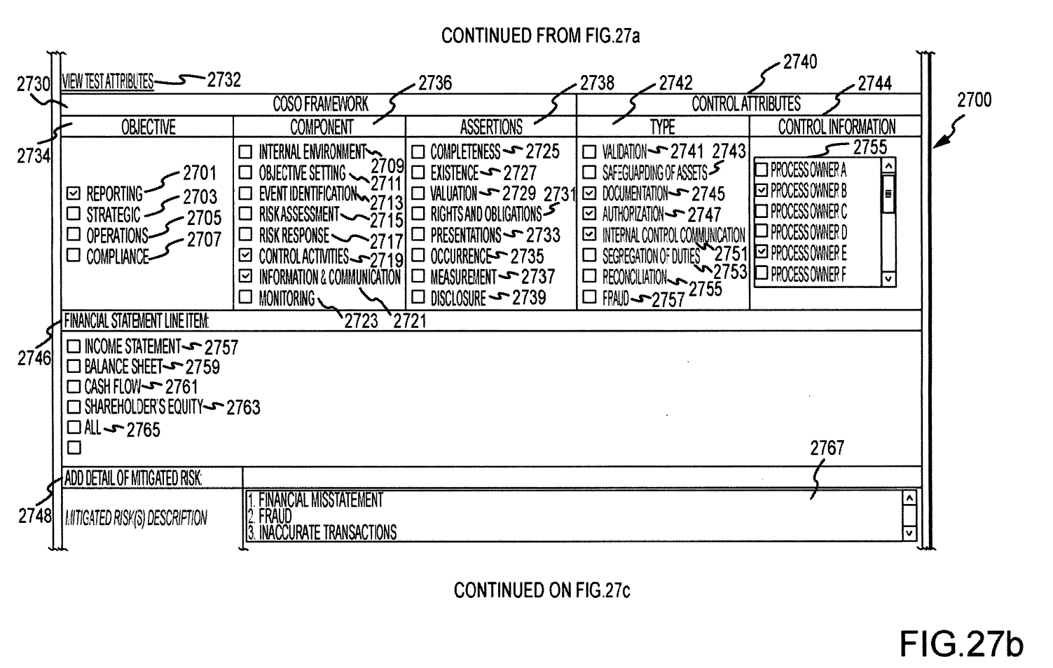

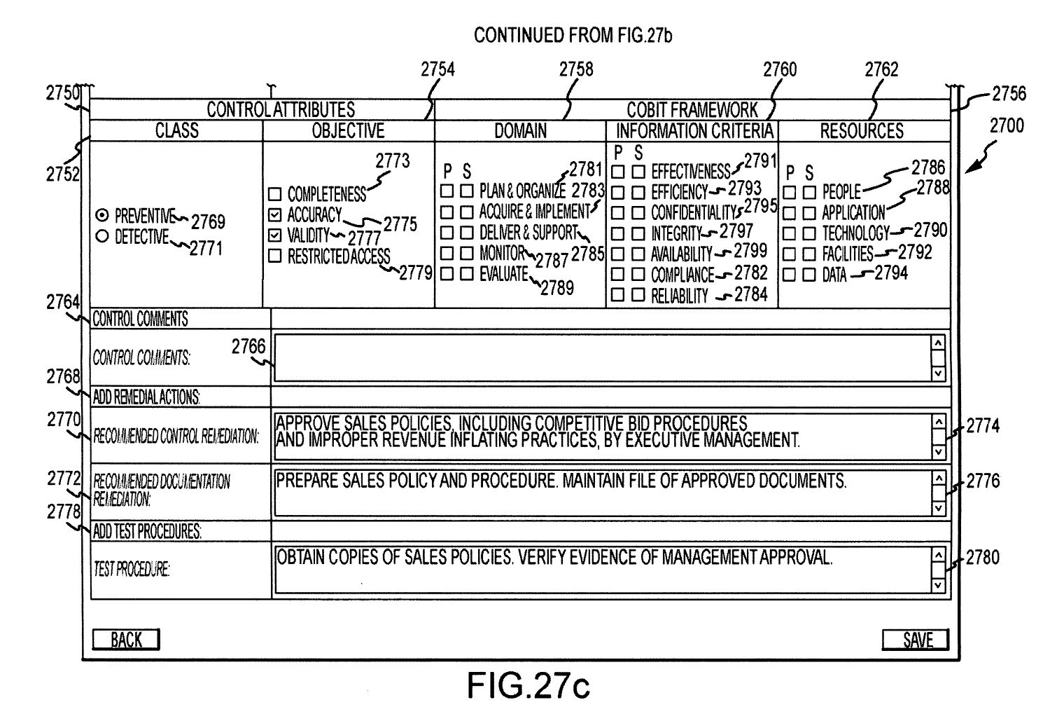

Referring now to FIG. 27, a control activity details page 2700 may comprise the following editable fields: a Control Activity Identifier 2515; a Control Activity Question 2530; a Control Activity Statement 2535 comprising the statement regarding the control activity; a Workflow Text 2702 comprising a description of what is required to satisfy the related control; Evidence of the Control 2704 comprising required evidence for the control; a Key Control Activity check box 2706 indicating whether the control is designated as a key control; and a Narrative Text check box 2708 indicating whether the control is a narrative control. The next set of fields generally comprises a Deficiency Assessment Classification 2710 having pre-populated values 2712, 2714, 2716 based on answers selected in previous fields. For example, Deficiency Assessment Classification 2710 values may comprise: process/transaction controls 2712, information technology general controls 2714, and pervasive controls ex. ITGC 2716.

Another field that may be available on the control activity setup may include Default Values 2718 comprising the following fields: automated or manual 2720, control frequency 2722, selection criteria 2724, sample source 2726, and sample type 2728. Additionally, a hyperlink to test attributes 2732 may be provided.

Further, COSO Framework field 2730 may comprise checkboxes for Objective 2734, Component 2736, and Assertions 2738. The COSO Framework, in accordance with various aspects of the present invention, may comprise a standard framework set out by the Committee of Sponsoring Organization of the Treadway Commission to obtain financial statement integrity through the identification and management of factors that may cause fraudulent financial reporting. Representative COSO Framework Objectives may include: Reporting 2701, Strategic 2703, Operations 2705, and/or Compliance 2707. COSO Framework Components may further comprise: Internal Environment 2709, Objective Setting 2711, Event Identification 2713, Risk Assessment 2715, Risk Response 2717, Control Activities 2719, Information & Communication 2721, and/or Monitoring 2723. COSO Framework Assertions may comprise: Completeness 2725, Existence 2727, Valuation 2729, Rights and Obligations 2731, Presentations 2733, Occurrence 2735, Measurement 2737, and/or Disclosure 27239.

Control Attributes field 2740 may comprise checkboxes for Type 2742 and Control Information 2744. Control Attributes may comprise one or more objects of a control, such as mechanisms for complying with a control. A user may select one or more control attributes that are to be associated with a control activity. In a representative embodiment of the present invention, control attributes may include: Validation 2741, Safeguarding of Assets 2743, Documentation 2745, Authorization 2747, Internal Control Communication 2751, Segregation of Duties 2753, Reconciliation 2755, and/or Fraud 2757.

The Financial Statement Line Item field 2746 generally displays a list of checkboxes for the types of financial statements to which the control activity may be linked. Financial statements in accordance with various aspects of the present invention may comprise: Income Statement 2757, Balance Sheet 2759, Cash Flow 2761, Shareholders Equity 2763, and/or the like. A user may select one or more and/or “All” 2765 of the available Financial Statements. Mitigated Risk Description field 2748 generally displays a fillable field 2767 for describing one or more risks that may be mitigated by the control activity.

Control Attributes 2750 may include Class 2752 and Objective 2754 fields. The Class field 2752 may describe whether a control is preventative and/or detective. For example, the Class field 2752 may comprise radio buttons to indicate Preventative 2769 or Detective 2771 control characteristics. The Control Attributes 2750 Objective field 2754 may comprise one or more objectives that a control seeks to meet. These objectives may include, for example: Completeness 2773, Accuracy 2775, Validity 2777, and/or Restricted Access 2779.

The COBIT (“Control Objectives for information and related Technology”) framework 2756 field may comprise the fields: Domain 2758, Information Criteria 2760 and Resources 2762. The COBIT framework, in accordance with various aspects of the present invention, generally comprises a set of best practices for information technology management created by the Information Systems Audit and Control Association (ISACA) and the IT Governance Institute (ITGI). The COBIT framework typically provides a set of generally accepted measures, indicators, processes and/or best practices to assist a business with maximizing one or more benefits derived through the use of information technology. The Control Comments 2764 field generally allows user to enter comments for the control activity through a fillable field 2766.

The Add Remedial Actions field 2768 generally allows a user to insert Recommended Control Remediation 2770 and/or Recommended Documentation Remediation 2772. The Recommended Control Remediation 2770 lists the recommended procedure for the control remediation, and may be displayed in an editable field 2774. Recommended Document Remediation 2772 typically comprises the recommended procedure for the document remediation, and may be displayed in an editable field 2776. The Test Procedure field 2778 generally allows a user to list a recommended test procedure for the control activity, and may do so in an editable field 2780.

It should be appreciated that in accordance with various aspects of the present invention, a homepage may be suitably configured to comprise a navigation bar. The navigation bar may be implemented in any suitable manner to provide information and/or links to various functions of the system. The navigation bar may be displayed at the top on the internet browser session, or may alternatively be located in any suitable place, such as on the bottom or sides of the browser, and may have as many or as few functions as desired. In addition, the navigation bar may be formatted to be displayed in accordance with the preferences of each user. For example, the user may chose to place the bar on the right side of the browser and include only Risk, Test and Document links to be shown.

In a representative embodiment of the present invention, the system may be suitably configured for SOx compliance and may comprise six stages representatively corresponding to: Assessment 2004, Risk Assertion 2006, Remediation Plan 2008, Remediation Update 2010, Test Plan 2012, and Test Update 2014. See FIGS. 20 and 21.

Referring now to FIG. 21, the system may comprise a navigation bar with buttons that allow a user to easily and/or quickly navigate to a particular stage. For instance, the navigation bar 2170 may include an Assess tab 2160. The user may select from the tab either the Assessment stage or the Risk Assertion stage, or make a stage selection from the drop-down menu on the summary table 2165 displayed on either the Assessment stage page or the Risk Assertion page. In a representative embodiment of the present invention, the navigation bar may also include a tab for Remediation 2175, which lists the drop-down stages Remediation Plan and Remediation update, as well as a tab for Test 2180 to list the drop-down options Test Plan and Test Update. In a representative embodiment, the SOx Assessment phase may comprise the stages Assessment and Risk Assertion, the Remediation phase may comprise the stages Remediation Plan and Remediation, and the Test phase may comprise the stages Test Plan and Test Update. In another representative embodiment of the present invention, the system may comprise a separate survey for each phase. In yet a further representative embodiment, each survey page may have a button bar. The button bar may comprise any number of buttons for a variety of system functions, such as buttons leading to other stages, the homepage and/or or the logout page.

The Assessment phase generally identifies whether a business already has one or more controls in place. In a representative embodiment of the present invention, the assessment phase may be implemented in any manner to determine the current dynamic or static state of compliance management for a business. In another representative embodiment of the present invention, the assessment phase may be implemented through the use of one or more surveys that may be configured to obtain information relating to a control from one or more users.

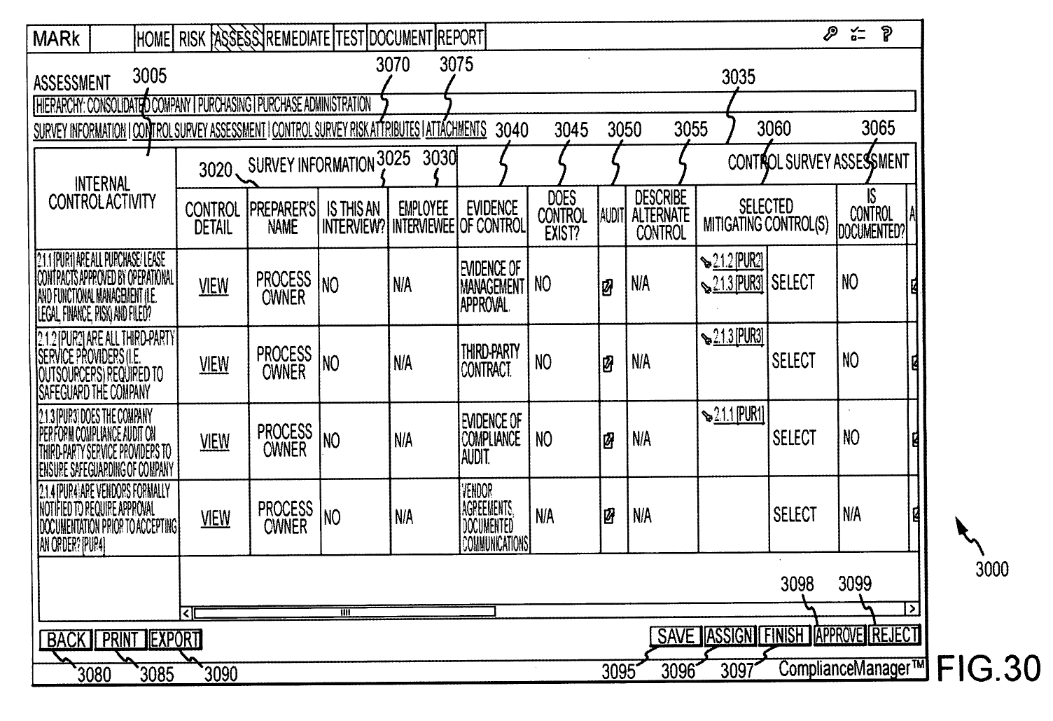

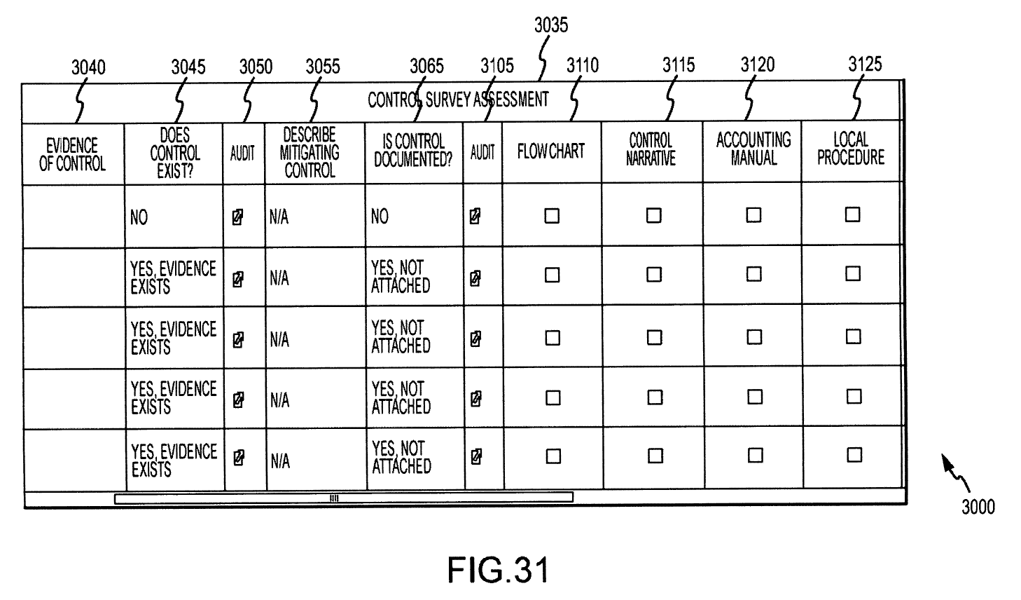

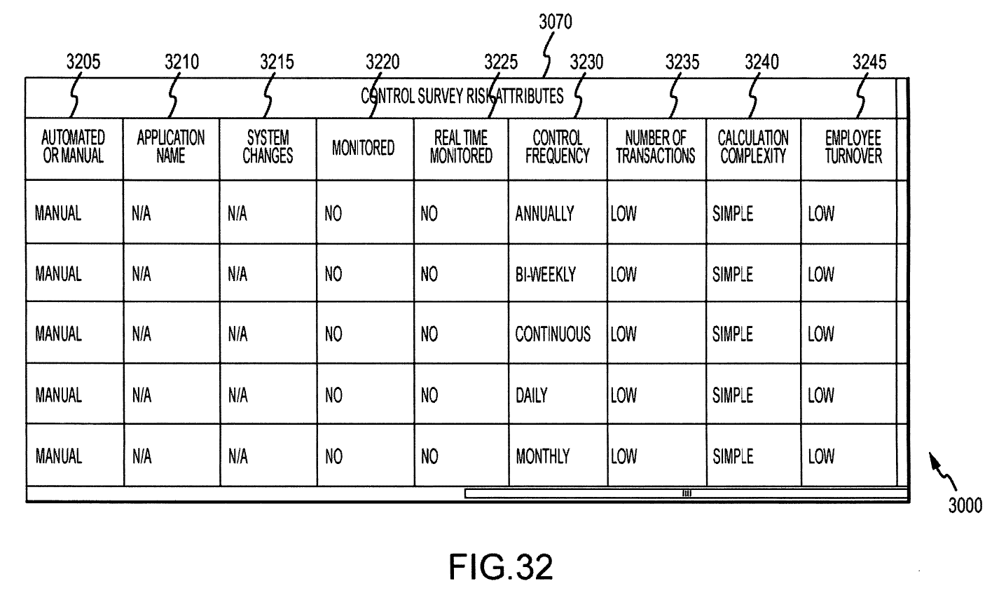

Referring now to FIGS. 30, 31 and 32, in a representative embodiment of the present invention, the Assessment stage page 3000 may include summary bookmarks comprising Internal Control Activity 3005, Survey Information 3010, Control Survey Assessment 3035, Control Survey Risk Attributes 3070 and/or Attachments 3075.

The Assessment phase summary page 3000 may include the following bookmarks:

Internal Control Activity 3005 and Survey Information 3010:

Internal Control Activity 3015—comprising a control question from control activity setup details;

Control Detail—view link to the Control Activity setup details;

Preparer's Name 3020—read-only column comprising the name of a user assigned to Complete task assignment;

Is This an Interview 3025—a field comprising a drop-down list with optional fields including Yes and No, allowing a user to fill in responses for an alternative person knowledgeable about the control activity;

Employee Interviewee 3030—comprising the name of an employee interviewee, typically only available if user selected Yes in the interview column.

Control Survey Assessment 3035:

Evidence of the Control 3040—a field that lists evidence of the control from control activity setup details;

Does the Control Exist 3045—a column comprising a drop-down list with: Yes evidence exists, Yes/No evidence, No but alternate control, No, and N/A;

Comments—providing a freeform textbox for users to enter comments regarding the control activity;

Audit Column 3050—comprising a link to audit popup for the audited values;

Describe Alternate Control—providing a freeform text field when No, but alternate control was chosen in the drop-down selection by the user in the “Does Control Exist?” column;

Select Mitigating Control 3060—comprising a link to pre-populated list of Control Activities for users to select one or more Control Activities

Is the Control Documented 3065—comprising a drop-down list including Yes attached, Yes not attached, and No;

Flow Chart 3105—permitting a user to designate if the control is documented in a flow chart;

Control Narrative 3110—permitting a user to designate if the control is documented in a control narrative;

Accounting Manual 3120—permitting a user to designate if the control is documented in an accounting manual; and

Local Procedure 3125—permitting a user to designate if the control is documented in a local procedure.

Control Survey Risk Attributes 3070:

Automated or Manual 3205—comprising a drop-down list allowing the user to specify whether a control is an automated or manual process;

Application Name 3210—where the user may enter the application name that is used to automate the process;

System Changes 3215—comprising a drop-down list allowing the user to select if there have been system changes (Yes or No);

Monitored 3220—comprising a drop-down list allowing the user to enter whether or not the process is monitored (Yes or No);

Real-Time Monitored 3235—comprising a drop-down list allowing users to enter whether the process is monitored in real time (Yes and No);

Control Frequency 3230—comprising a drop-down list for users to set the control frequency to, for example: annually, bi-weekly, continuous, daily, monthly, non-routine, quarterly, semi-annually, and weekly;

Number of Transactions 3235—comprising a drop-down list where the user sets whether the control has a high or low number of transactions;

Calculation Complexity 3240—comprising a drop-down list where the user may set whether control calculation is Complex, Simple or N/A; and

Employee Turnover 3245—comprising a drop-down list where the user may select whether the control has a high or low level of employee turnover.

Attachments:

Attach Documents—counting of the number of documents attached to the control with a link that opens a document attachment popup permitting the user to view and add documents.

In a representative embodiment of the present invention, the button bar may comprise

the following: Back 3080—taking the user to a different stage page, Print 3085—generating a printable version of the existing page, Export 3090—generating and exporting an existing page to a spreadsheet program, Save 3095—saving any changes made to the page, Assign 3096—where the user may assign or reassign the currently selected controls, Finish 3097—where the user may complete the current selected controls and send for approval, Approve 3098—where the user may approve the currently selected controls, and Reject 3099—where the user may reject the currently selected control task.

The Risk Assertion stage page may comprise the following columns: Survey Information 3010, Control Survey Assessment, Control Survey Risk Attributes, Risk Assertion and Attachments. The Risk Assertion stage page may be substantially identical to the Assessment page in FIGS. 30, 31, and 32.

The Control Survey Assessment and Risk Attributes in the Risk Assertion stage page may be read only values that are substantially similar to the values input during the Assessment stage. The Risk Assertion columns in the Risk Assertion stage may comprise the following fields:

Risk Rating—linking to the risk rating calculation popup, and including a framework for estimating the overall control risk;

Risk Assertion—providing pre-populated values with preliminary risk assessment based on the risk rating;

Audit—tracking changes to risk assertion field;

Rationale—providing a freeform textbox as a required field when risk assertion is modified.

Control Risk Category—providing a drop-down list where users can enter the likelihood of this risk occurring e.g. high, medium or low;

Once a control has been assessed and its risk asserted in the Assessment Phase and the outcome confirms a “gap” 2032 (i.e., there is evidence of a risk associated with the control in question), a remediation plan may be implemented in order to reduce and/or monitor the risk associated with the control. See, for example, FIGS. 20 and 22.

In a representative embodiment of the present invention, the Remediation Plan may comprise data corresponding to Survey Information 3010, Remediation Decision, Internal Control Remediation Plan, Documentation Remediation Plan, and Attach Documents. The columns listed in the Remediation Plan survey summary generally may include:

Survey Information and Remediation Decision:

Risk Assertion—comprising read-only values from risk assertion;

Does Control Exist?—comprising read-only values from assessment;

Alternate Control Description—comprising values from assessment that describe alternate controls that achieve similar results as compared with the control activity;

Select Mitigating Controls—pre-populated from the assessment phase with reference links to additional control activities which mitigate risk or providing the option for user to select a control activity from a pre-populated list;

Is Control Documented?—comprising read-only values from assessment;

Test Result—comprising link to read-only fields pre-populated with test result, including details on why the test failed;

Remediate Control and/or Documentation—comprising a drop-down list to determine whether a control activity will be remediated (Yes and No);

Rationale—comprising reasons for not remediating control gaps (if remediate is selected, control and/or documentation answer will typically be ‘No’, otherwise optional);

Due Date—comprising a due date for remediation effort, in response to remediate control and/or documentation; and

Remedial Action Approver—identifying a person responsible for approving completed remediation.

Internal control Remediation Plan:

Recommended Control Remediation—comprising a pre-populated value from the control activity setup, as well as recommended steps to implement a particular control when remediation work is completed;

Actual Control Remediation—comprising recommended control remediation procedures for controls in control activity setup or entering the action steps directly into the remediation plan if the actual control remediation differs from the recommended control remediation;

Automated or Manual—comprising pre-populated value with the option to modify based on control survey response, as well as specifying whether the control is an automated or manual process, which may be used to calculate a target control maturity rating;

Monitored—comprising a pre-populated value with the option to modify, based on control survey responses and specifying whether remediated control will check for failures on a regular basis, which may be used to calculate a target control maturity rating;

Real Time Monitoring—comprising a pre-populated value with option to modify based on control survey response, as well as specifying whether a control has an immediate system check for control failures which generates an automatic exception alert, which may be used to calculate target control maturity rating; and

Responsible Owner—the name of person responsible for remediation of the control activity, which may be required if response to remediate control and/or documentation is flagged as positive.

Recommended Documentation Remediation:

Documentation Remedial Action—comprising pre-populated values from control activity setup, as well as recommended steps to implement for the control to be documented when remediation work is completed;

Actual Documentation Remediation—providing recommended remedial actions for controls in the control activity setup or allowing entry of the action steps directly into the remediation plan if the actual documentation remediation differs from the recommended documentation remediation action; and

Responsible Owner—comprising the name of a person responsible for the remediation of the documentation of the control activity, if the response to the Remediate Control and/or Documentation is flagged as positive.

In another representative embodiment of the present invention, the Remediation Update summary table may include an additional column designated as “M & S gaps Remediated”, which may display the total of material and/or significant tasks selected for remediation. The Remediation Update survey summary bookmarks generally comprise internal control remediation plan, documentation remediation plan, attach documents and remediation update. The remediation update may further comprise:

Control Details and Internal Control Remediation Plan:

Control Details—view link to the control activity setup details;

Deficiency Auditor—comprising pre-populated drop-down values from setup which identifies internal or external person responsible for identifying deficiency

Recommended Control Remediation—comprising pre-populated values from the control activity setup to identify the recommended steps to implement for the control to exist when remediation work is completed;

Actual Control Remediation—comprising pre-populated values from the Remediation Plan Survey;

Responsible Owner—comprising data relating to the person responsible for the remediation of the control activity, pre-populated from Remediation Plan Survey; and

Due Date—comprising pre-populated values from the Remediation Plan Survey.

Documentation Remediation Plan:

Documentation Remedial Action—comprising pre-populated values from the control activity setup to identify the recommended steps for implementation of a control to document when remediation work has been completed;

Actual Documentation Remediation—comprising pre-populated values from the Remediation Plan survey; and

Responsible Owner—comprising data relating to the person responsible for remediation of the documentation of the control activity, pre-populated from the Remediation Plan Survey.

Remediation Update:

Control Status—comprising high-level progress data relating to control remediation work. If a control is being remediated and remediation work has begun, this variable provides a drop-down list of representative values corresponding to ‘Complete’ and ‘In Progress’;

Documentation Status—comprising high-level progress data for the documentation of remediation work with a drop-down list having values corresponding to ‘Complete’ and ‘In Progress’.

The test phase, in accordance with various aspects of the present invention, may comprise one or more stages where a control may be tested. A process may enter testing at various stages throughout a workflow. For example, in a representative embodiment of the invention, a control may be tested after the Risk Assertion stage if no gap is found to exist between the control and the result of a task in the Risk Assertion stage. In another representative embodiment of the invention, a control representative embodiment, a control may be tested after it has already been tested once, rejected, and gone through the Remediation phase.

It should be appreciated that in accordance with various aspects of the present invention, a Test Phase may comprise the stages Test Plan and Test Update. Additionally, a Test Phase may be implemented through a Test Information page. The Test Information page may be organized and implemented in any suitable manner, such as the various tables and textboxes that may be listed in any manner and may be omitted depending on the needs of the business and/or user.

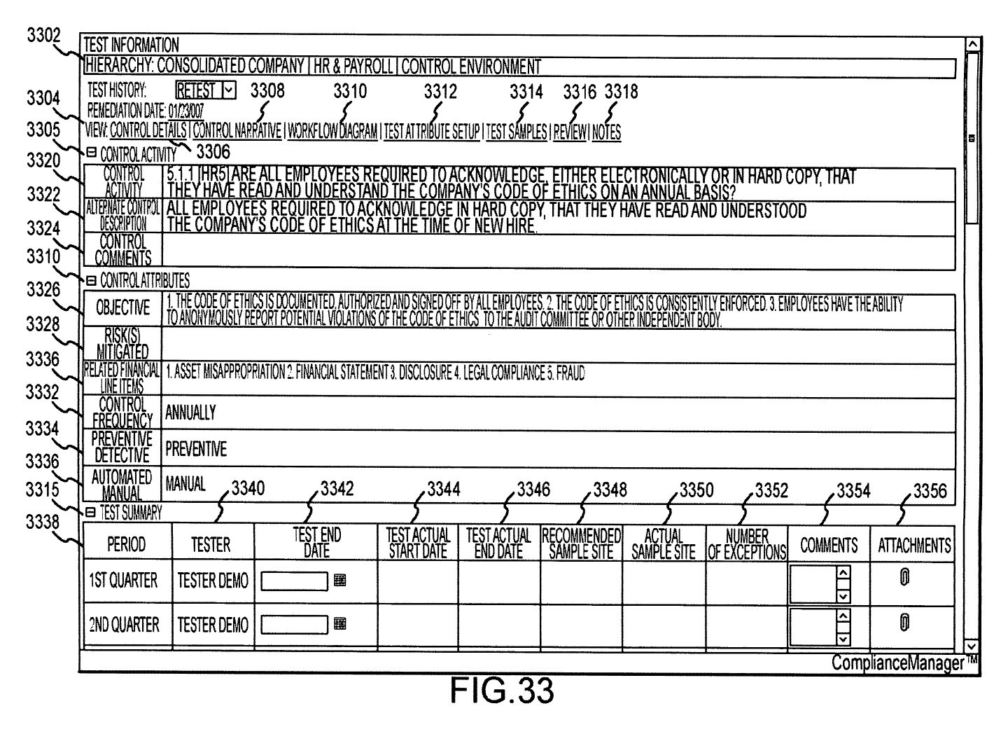

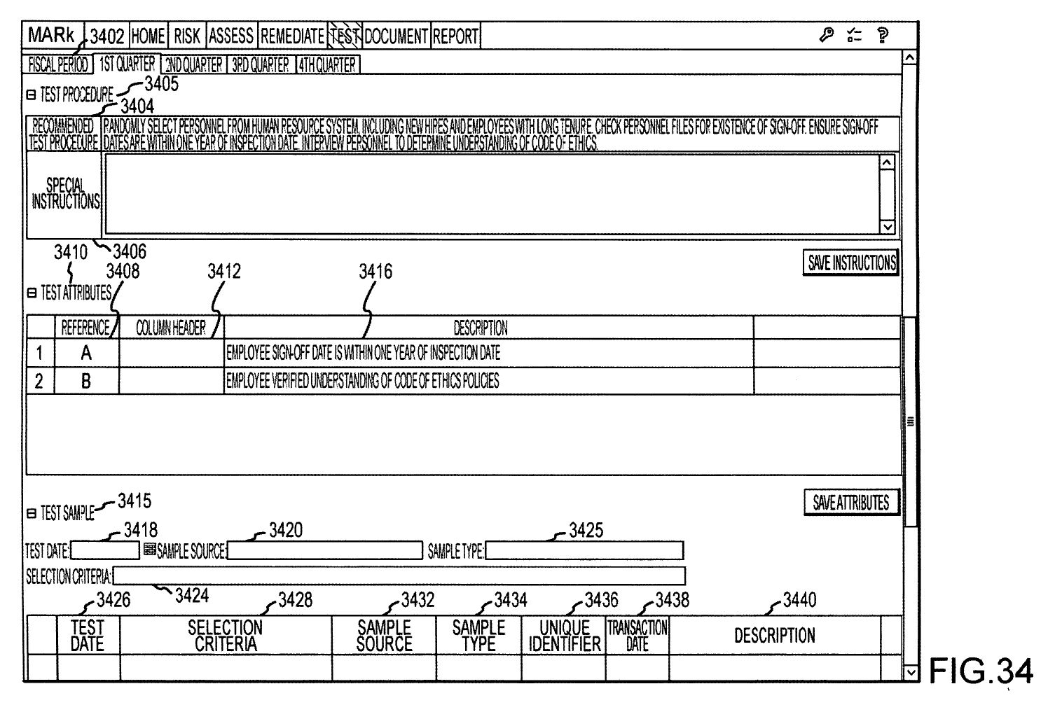

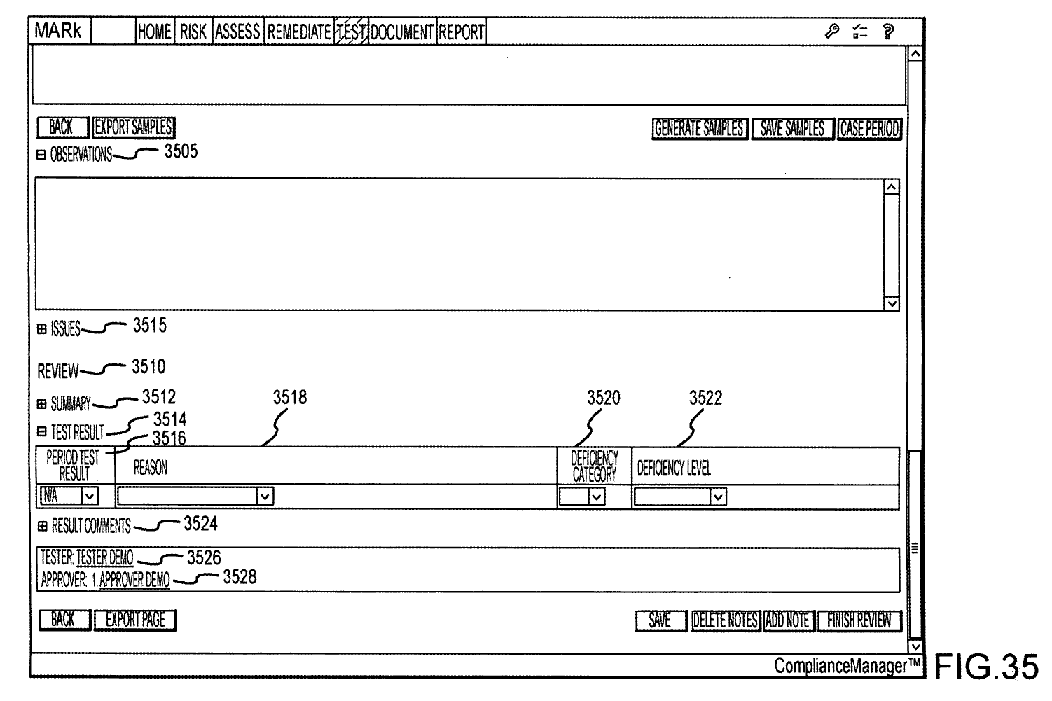

In a representative embodiment of the present invention, a test information page may be designed to provide a user with more specific details regarding the specific test of a control. Referring now to FIGS. 33, 34, and 35, the Test Information page may list information concerning the Control Activity 3305, Control Attributes 3310, Test Summary 3315, Test Procedure 3405, Test Attributes 3410, Test Sample 3415, Observations 3505, Issues 3515, and Review 3510. The Test Information page may include a hierarchy bar 3302 listing the current business name, cycle name and process name for the control being tested. Below the hierarchy bar may be a view bar 3304 that includes relevant information from the surveys to aid the user in testing. The view bar may comprise a Control Details link 3306 configured to launch a control details popup having a read-only view of the control activity details; a Control Narrative link 3308 that launches a control narrative popup having a read-only view of the current selected period's control narrative information (which can be either edited online or exported to Microsoft Word or Excel for viewing and further edits); a Workflow Diagram 3360 link that launches a workflow diagram popup generating the workflow diagram for the current process (which can be exported to Visio for viewing and further edits); a Test Attribute Setup link 3312 configured to permit scrolling of the current page down to the test attribute setup section; a Test Samples link 3314 configured to scroll the current page to the test samples section; a Review link 3316; and a Notes link 3318.

The Control Activity 3305 representatively includes details on the control activity 3320—listing the revision number and the text narrative of the control; the alternate control description 3322—listing the control if the control implemented by a business is an alternative to that of a prescribed control; and control comments 3310—lists any other additional information that any user may have included.

The Control Attributes 3310 portion generally includes the Objective 3326, Risk (s) Mitigated 3328, Related Financial Line Items 3330, Control Frequency 3332, Preventative/Detective 3334, and Automated/Manual 3336. The Objective 3326 may comprise the reason that the control is performed and/or the goal of the control. The Risk(s) Mitigated 3328 typically lists the risks that are decreased by fulfillment of the control. The Related Financial Line Items 3330 lists any relevant financial line items. The Control Frequency 3332 comprises text selected by the user in the assessment survey or remediation plan. The Preventative/Detective field 3334 lists whether the control may be characterized of having the capability of preventing a risk and/or locating a risk. The Automated/Manual field 3336 generally comprises a description on how the control may be implemented. It will be appreciated that the control attributes portion may include any other information relating to the control, process and/or business unit, whether now known or otherwise hereafter described in the art.

The Test Summary 3315 table typically lists additional test information organized by Period. The test summary columns may comprise: Period Name 3338—providing the name of the period (1^{st} Quarter, 2^{nd} Quarter, etc.); Tester 3340—providing the name of the tester assigned while the period was open for testing; Test End Date 3342—which may be generated automatically to show the required end dates for testing; Test Actual Start Date 3342—providing the date when testing activity started; Test Actual End Date 3344—providing the date when the period was closed or the test reached a reject state; Recommended Sample Size 3348—a value to aid the tester, which may be generated from the test sample size on the company hierarchy setup; Actual Sample Size 3350—computed from the number of samples entered into the Test Samples table; Number of Exceptions 3352—computed from the number of samples entered that contain at least one exception; Comments 3356—providing a textbox where the user may write comments; and optionally Attachments—a field where a user may attach documents at the period level. The test end date generally includes a calendar popup option which allows the user to select the test end date from a calendar or the user may enter the date manually. The Test Summary 3338 table may also include ‘finish’, ‘save’ and ‘export’ buttons listed below the table. The ‘finish’ button may be configured to permit the tester to finish all testing and calculate the test status and result. The ‘save’ button may be configured to update the test summary and save the new entered data. The ‘export’ button may be configured to permit the user to export the test summary table into a format other than the native system format, such as an Adobe Acrobat PDF, Microsoft Excel, and/or the like.

The Test Details may include a Test Procedure 3405 table, a Test Attributes 3410 table, a Test Sample table 3415, an Observations editable box 3505 and an Issues editable 3515 box. Additionally, the Test details table may include a Fiscal Period Tab 3402 set, allowing the tester to navigate between the periods of testing and a Test 2 tab. The Test 2 tab may be visible to the user when the Test 2 criteria has been satisfied. In a representative embodiment of the present invention, the Test Procedure Table 3405 may include a Recommended Test Procedure Box 3404—listing the recommended test procedure and a special instructions box to permit the user to fill in or read any special instructions with respect to the test procedure.

The Test Attributes Table 3410 may include a Reference column 3408, a Column Header 3412 column and a Description 3416 column. The Reference column 3408 may comprise a generated identifier. The description may comprise information specific to a particular reference. The user may select rows to be saved and/or deleted. If a row is selected to be saved and/or deleted, the tester may then be promoted to update all of the open periods or just the current period.

The Test Sample 3415 generally allows the tester to enter data about the performance of tests, and may comprise four textboxes above the table used to pre-populate redundant data in the table. Representative text boxes may include, for example: a Test Date 3418 field—including a calendar popup option; a Same Source 3420 field; and a Sample Type 3425 field and a Selection Criteria field 3424. If the user enters data into these textboxes, the data will be pre-populated into the table below. The table may include the columns: Test Date 3426—corresponding to the date of the test; Selection Criteria 3428—including details on how the sample was selected; Sample Source 3432—identifying the tester document source such that document may be retrieved at a later date; Sample Type 3434—indicating a document type; Unique Identifier 3436—providing a unique reference ID for each document such that the document may be retrieved at a later date; Transaction Date 3438—providing a date of the transaction; and Description 3440—providing descriptive details. In a representative embodiment of the present invention, the Test Sample 3415 table may include additional columns corresponding to: Additional Information—providing any additional information the tester notes on a test sample; Test Attribute Fields—where test attributes may be displayed (having a column for each test attribute where the reference may be used in the column header, and each cell contains drop-down list with three options corresponding to: With Exceptions, Without Exceptions, and N/A); Description of Exceptions—providing a description of exceptions entered in the test attributes fields; Comments—providing additional comments or notes that the tester may choose to add concerning a sample; Work Paper Cross Reference—allowing a user to reference external documentation; and Attach Document—providing for the attachment of documents at the test sample level. When a new row is added in the table, any data that has been entered may be duplicated in the Test Date, Selection Criteria, Sample Source, and Sample Type rows. The pre-populated values may remain editable so that the tester may modify the values as needed. The bottom of the table generally includes a back, export, generate, save and close period buttons. The back button may be configured to return a user back to the previously viewed page. The export button may be configured to export the test sample table into another format. The generate button may be configured to generate test sample data. The save button may be configured to save user-entered data, but generally does not generate a test sample. The close period button may be configured to allow the user to close all tests for a given period.

The Observations 3505 and Issues 3515 editable text boxes generally permit a user to enter any observations regarding the test data and/or control information, and further include any additional information regarding potential issues with the test data and/or issues experienced during the test.

The Review 3510 portion typically comprises: a Summary 3512 editable text box where the tester may include additional summary information concerning the test; a Test Result 3512 box—including drop-down fields corresponding to Period Test Result 3516, Reason 3518, Deficiency Category 3520 and Deficiency Level 3522; and Result Comments 3524—listing the Tester 3526 and the Approver 3528.

The save function in the Test phase may be implemented to upload changes that have been made in the Test Sample table to the system. In a representative embodiment of the present invention, the save function may trigger a recalculation of test results and/or test status.

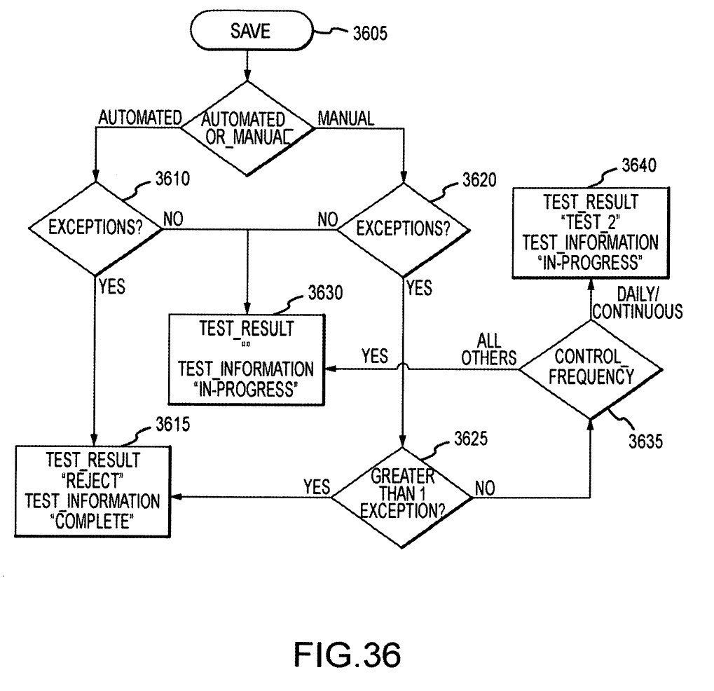

Referring now to FIG. 36, in a representative embodiment of the present invention, in a process where the confidence level is not “Other”, when a user activates (manually) and/or when the system automatically activates Save 3605, the system may be configured to determine if there are Exceptions 3610. Exceptions 3610, in accordance with various aspects of the present invention, may comprise data corresponding to an instance of noncompliance with a standard. If the system determines there are Exceptions 3610, and the system automatically saved the data, then the test result may correspond to “REJECT” 3615 and the user may see a message informing them that the test has been rejected. If the user saves manually and there are more than one Exception 3620, then the test result may correspond to “REJECT” 3615 and the user may see a message informing them that the test has been rejected. In either the automated save and/or the manual save when there are no Exceptions 3610, 3620, then the test result may correspond to “In progress” 3630. If there is not more than one Exception 3625 when data has been saved manually, and this is within the bounds of the exception threshold defined in setup, then the test result may correspond to “In progress” 3630. If there is not more than one Exception 3625 when data has been saved manually (and this is within the bounds of the exception threshold defined in setup and the control frequency is daily and/or continuous), then the test result may be configured to send the user to “Test 2” where the testing status will correspond to the designation “in progress” 3640. In this instance, the user may receive a message informing them they need to complete the Test 2 period.

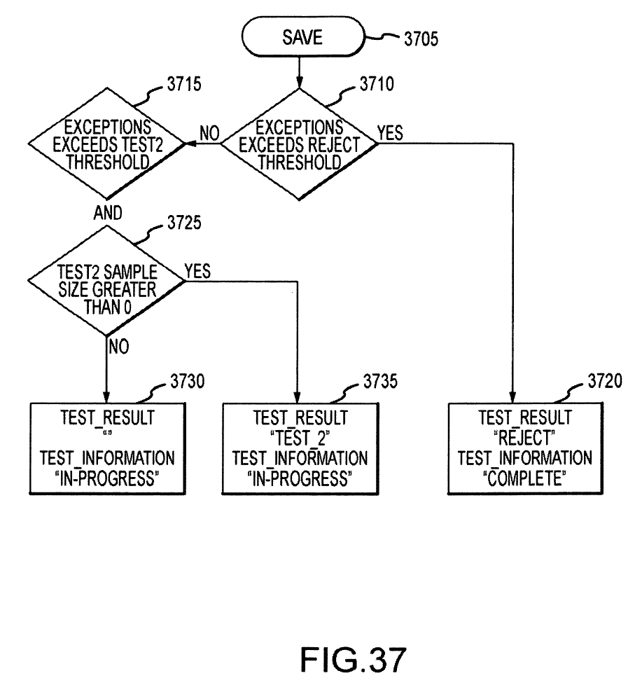

Referring now to FIG. 37, in a representative embodiment of the present invention, in a process where the confidence level is “Other” when a user manually activates and/or when the system automatically activates the Save 3705 function, the system may be configured to determine if there are Exceptions which exceed the Rejection Threshold 3710. If the Exceptions exceed the Rejection Threshold 3710, then the test result may correspond to “REJECT” 3720 status and the user may see a message informing them that the test has been rejected. If the Exceptions do not exceed the Reject Threshold 3710, but the Exceptions exceeds the Test 2 Threshold 3715 and the Test 2 Sample Size is greater than zero 3725, then the test result may correspond to “in progress” in Test 2 3735. If the Exceptions do not exceed the Reject Threshold 3710, but the Exceptions exceeds the Test 2 Threshold 3715 and the Test 2 Sample Size is not greater than zero 3725, then the test result will be “In progress” 3730.

The finish function in the Test phase may be implemented to upload changes that have been made in the Test Sample table to the system. In a representative embodiment of the present invention, the finish function may trigger a recalculation of test results and/or test status.

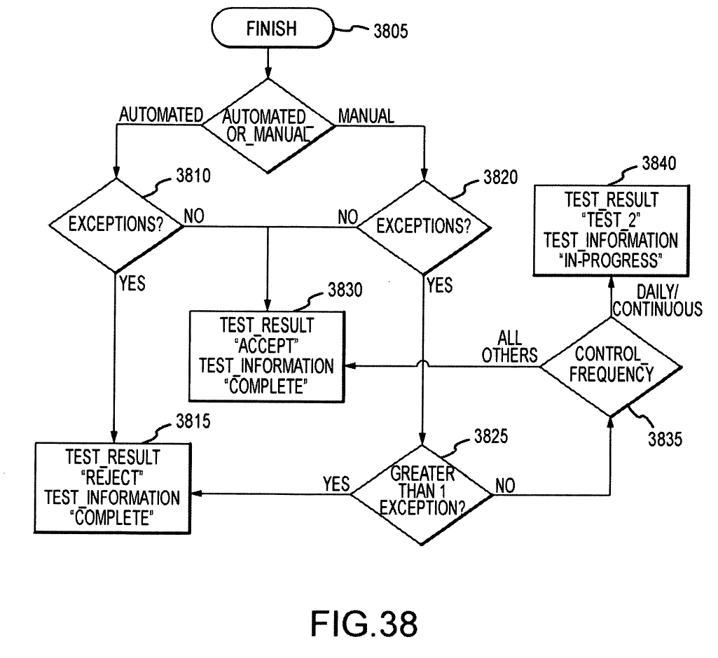

Referring now to FIG. 38, in a representative embodiment of the present invention, in a process where the confidence level is not “Other” when a user manually activates and/or when the system automatically activates Finish 3805, the system may be configured to determine if there are Exceptions 3810. Exceptions 3810, in accordance with various aspects of the present invention, may comprise data input corresponding to an instance of noncompliance with a standard. If the system determines there are Exceptions 3810 and the system automatically finishes, then the test result may correspond to “REJECT” and the test status may be designated as “Complete” 3815. The user may then see a message informing them that the test has been rejected. If the user finishes manually and there are more than one Exception 3820, 3825, then the test result may correspond to “REJECT” and the test status may be designated as “COMPLETE” 3815. The user may then see a message informing them that the test has been rejected. In either the automated finish and/or the manual finish when there are no Exceptions 3810, 3820, then the test result may correspond to “Accept” and “Complete” 3830. If there is not more than one Exception 3825 when the finish is manual and this is within the bounds of the control frequency, then the test result may correspond to “In progress” 3830. If there is not more than one Exception 3825 when the finish is manual, and this is within the bounds of the control frequency and the control frequency is daily and/or continuous, then the test result may be configured to send the user to “Test 2” and the Test will be placed in “in progress” 3840 status. In this instance, the user may receive a message informing them that they need to complete the Test 2 period.

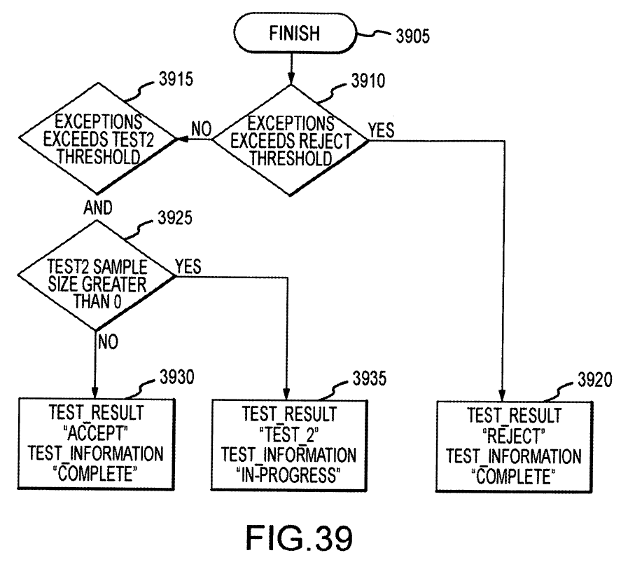

Referring now to FIG. 39, in a representative process where the confidence level is that of “Other” when a user manually activates and/or when the system automatically activates the Finish 3905 function, the system may be configured to determine if there are Exceptions which exceed the Rejection Threshold 3910. If the Exceptions exceed the Rejection Threshold 3910, then the test result may correspond to “REJECT” 3920 status. The user may then see a message informing them that the test has been rejected. If the Exceptions do not exceed the Rejection Threshold 3910, but the Exceptions exceeds the Test 2 Threshold 3915 and the Test 2 Sample Size is greater than zero 3925, then the test result may correspond to “In progress” in Test 2 3935. If the Exceptions do not exceed the Rejection Threshold 3910, but the Exceptions exceed the Test 2 Threshold 3915 and the Test 2 Sample Size is not greater than zero 3925, then the test result may correspond to “In progress” 3930.

A user may have permission to view the Test Update survey and/or the Remediation plan survey via one or more pop-ups. These pop-ups may be read-only and may be viewed from the Remediation Plan survey. In a representative embodiment of the present invention, only the currently assigned Tester and/or Approver may see a popup in an editable mode when opened from the Test Update survey.

The Test Summary table may further comprise test audit information. In a representative embodiment of the present invention, test audit information may include a drop-down box comprising date and/or time information of previous test rejections and/or information from those rejections. In another representative embodiment of the present invention, when a rejected test returns to the Test Update survey, the Test Sample data may be cleared and the Test Summary table substantially reset and readied for a new test.

It should be appreciated that in accordance with various aspects of the present invention, a deficiency assessment procedure may be used to illustrate a summary of past and/or current remediation control activities. The document tab on the navigation bar may include a drop-down selection having a deficiency assessment option. In a representative embodiment of the present invention, similar to the Assessment table 2165 on the Assessment page, the deficiency assessment deficiency summary may include a drop-down list where the user may select controls and a filter to identify which tasks to show based on task status. The deficiency assessment summary table lists the business unit, process, cycle and/or control (with maximize and minimize options) for the business unit, process, and cycle where the user may select whether to display the lower organizational levels. The table includes the columns: ‘due date and audit trail’, ‘total’, ‘not started’, ‘in progress’, ‘complete’, and ‘past due’. The ‘due date and audit trail’ generally provide a link to the audit trail popup tracking the control and task information. The ‘total’ lists a total count for all the tasks listed under that control. The ‘not started’, ‘in progress’, ‘complete’, and ‘past due’ columns list the task totals in every status for each control, cycle and process. When the user selects a control, process or cycle link, they are directed to the Deficiency Assessment page.

It should be appreciated that in accordance with various aspects of the present invention, the Deficiency Assessment page may include a hierarchy bar, a series of bookmarks and a deficiency assessment details table. The hierarchy bar may include information pertaining to the selected control, process or cycle. For instance, if a control is selected, the process and cycle where the control is incorporated are listed in the hierarchy bar. The bookmarks direct the user to certain portions of the deficiency assessment table, eliminating the need to scroll through the table to find the desired information. Representative bookmarks may include: control attributes, remediation log, test log, mitigating controls, financial statement line item, and deficiency assessment. The deficiency assessment details table may comprise the following columns:

Internal Control Activity and Control Attributes:

Internal Control Activity—listing the activity and its description;

Control Detail—comprising a view link to the Control Activity setup detail;

Preparer's Name and Owner Title—listing the name and title of the person preparing the deficiency assessment;

Control Frequency—providing pre-populated values from assessment and listing the frequency of the control;

Automated/Manual—providing pre-populated values from assessment and including whether the control is performed automatically or manually; and

Preventative/Detective—providing pre-populated values from the control activity setup.

Remediation Plan:

Auditor—providing a drop-down list including an option for ‘internal audit’;

Remediate Control and/or Documentation—providing pre-populated values from the Remediation plan stage;

Control Remediation—providing a text box with pre-populated data from the remediation plan to detail actions for remediation of the control; and

Documentation Remediation—providing a textbox with pre-populated data from the remediation plan to detail actions for remediation of the documentation.

Remediation Update:

Control Status—listing the task status from the Remediation Update stage, including the values ‘In Progress’, ‘Complete’, ‘Approved’, etc.;

Documentation Status—listing the task status from the Remediation Update stage;

Remediation History—comprising a link to a popup containing the Remediation Update summary table for the selected control.

Test Update:

Retest Date—comprising pre-populated value with latest test date if control has been remediated and has returned to the Test stage;

Test Information—a field that includes values corresponding to ‘Not Started’, ‘In Progress’, ‘Complete’, and ‘Test 2’;

Test Result—a field that includes values corresponding to ‘Accept’ or ‘Reject’;

Test History—including a link to the Test Information page;

Deficiency Category—listing the category in which the control deficiency appears;

Audit—including a link to track changes for a particular control;

Deficiency Level—listing the deficiency level of a particular control;

Audit—providing repopulated values based on answers from previous control questions and tracks changes; and

Rationale—requiring input for any change in values by the user.

Mitigating Control.

Alternate Control Description—providing text to describe the control in another manner than that listed in the control details;

Select Mitigating Controls—providing a field where a user may select other mitigating controls listed for each specific control;

Deficiency Mitigation Control—listing the mitigating controls that are deficient with respect to the selected control;

Financial Statement Line Item—listing the financial statement line item from the control activity setup;

Risk Information—including a link to a risk calculation popup which displays how the risk was calculated for the selected control; and

Comments—comprising an editable text box where the user may enter comments about the selected control.

Assessment Decision:

Prepare Deficiency Assessment—comprising a drop-down list to determine whether a deficiency will be assessed (Yes and No);

Audit—including a link to a popup for auditing tracked changes for the control;

Rationale—required if Prepare Deficiency Assessment is No.

Determine Whether a Significant Deficiency Exists—providing drop-down boxes for each column including options corresponding to the values ‘Yes’, ‘No’ and ‘N/A’:

Is the potential magnitude inconsequential to both annual and interim financial statements?

Are there mitigating controls that were tested and evaluated that achieve the same control objective?

Are there mitigating controls that were tested and evaluated that reduce the magnitude of a misstatement for both annual and interim FS to inconsequential? and

Would a prudent official conclude that the deficiency is at least a significant deficiency considering both the annual an interim FS?

Determine Whether a Material Weakness Exists—providing drop-down boxes for each column having values corresponding to ‘Yes’, ‘No’ and ‘N/A’:

Is the potential magnitude less than material for both annual and interim FS?

Are there mitigating controls that were tested and evaluated that reduce the magnitude of a misstatement for both annual and interim FS less than material?

Would a prudent official conclude that the deficiency is material weakness considering both the annual an interim FS?

Does additional evaluation result in a judgment that the likelihood of a material misstatement of both the annual and interim FS is remote? and

Do aggregate control deficiencies increase risk?—providing drop-down boxes having values corresponding to ‘Yes’, ‘No’ and ‘N/A’:

Audit—providing a link to audit popup tracking for changes to the control;

Deficiency Classification—listing the classification that the control corresponds to with respect to the deficiency;

Audit—comprising a link to audit popup tracking for changes to the control; and

Rationale—comprising an editable text box where the user may enter their rationale for altering columns within the table.

Listed below the deficiency assessment details table is a button bar. The button bar comprises the following designations: ‘Back’, ‘Export’, ‘Save’, ‘Assign’, ‘Finish’, ‘Approve’ and ‘Reject’. The back button may be configured to return the user to the previous page that they were viewing. The export button may be configured to export the table to another format such as a spreadsheet or document. The save button may be configured to save data recently entered by the user. The Assign, Finish, Approve and Reject buttons may be configured as task assignment buttons that allow the user, depending on their role, to assign, finish, approve or reject a task under each control.

It should be appreciated that in accordance with various aspects of the present invention, various risks may be identified, characterized, determined, calculated, or analyzed based on a particular control. The risk calculation may be implemented in any suitable manner, such as via selection of a risk rating for a control based on previous task results and/or observations. Additionally, a risk calculation, in accordance with various aspects of the present invention, may omit any number of the steps so that the risk may be calculated using any number of additional and/or different parameters.

In a representative embodiment of the present invention, risk may be calculated based on a control and/or how a control affects the chance of noncompliance with a standard. In another representative embodiment of the present invention, risk may be at least partially determined through a risk rating.

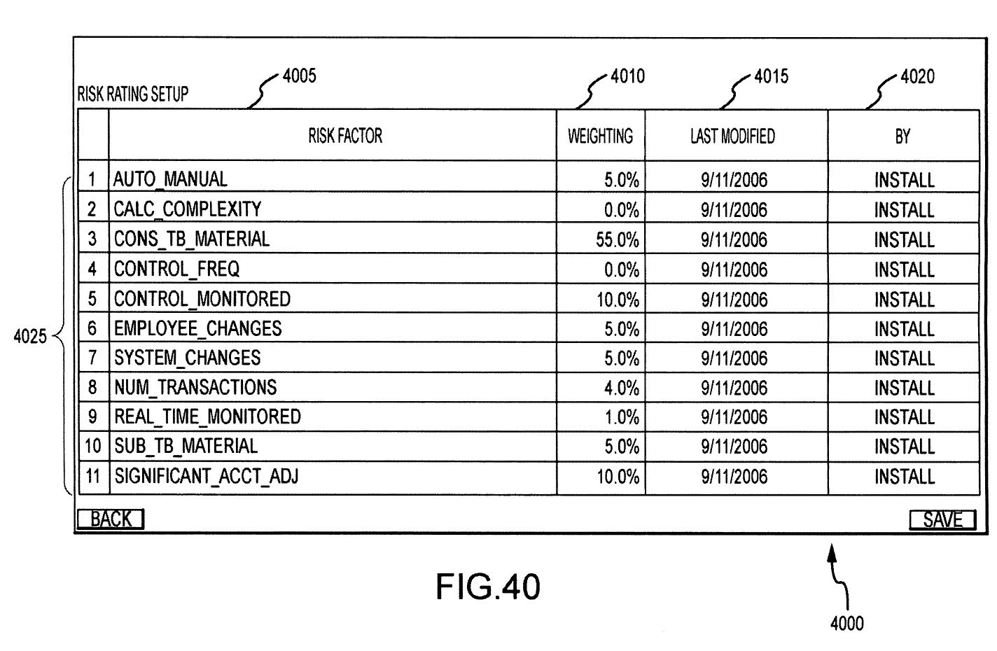

The risk rating may be setup via the Risk Rating page. Referring now to FIG. 40, in a representative embodiment of the invention, a Risk Rating Setup page 4000 may comprise the following columns: risk factor 4005, weighing 4010, last modified 4015, and by who last modified 4020. The risk rating may comprise a quantitative index taking into account up to eleven risk factors per control 4025.

In a representative embodiment of the present invention, the system may be configured to perform risk calculation in at least a three step process. First, the materiality value for each risk may be determined based on financial account materiality and responses to the Control Survey risk attributes. The materiality or suggested risk level may be assigned a numeric value from 1 to 3, wherein 1 may indicate an inconsequential status or lower risk, 2 may indicate a significant or medium risk, and 3 may indicate a material or high risk status. Second, the relative importance of each risk factor may be determined. Each risk factor may be assigned a weighting factor from 0 to 1, depending on the factor's relative importance with 0 corresponding to not very important and 1 corresponding to very important. Third, the overall risk rating index may be calculated. The risk rating for each risk factor may be equal to the materiality value multiplied by the relative weighting, the sum of the individual risk ratings totaling the overall risk rating index for the control.

In a representative embodiment of the present invention, the risk calculation parameters may be viewed for each control under either the deficiency assessment details page or in the Assess stage. Referring now to FIG. 52, the Risk Calculation page 5200 may be configured to display the hierarchy under which a particular control falls 5202, the control activity 5204, a risk calculation table 5262, a consolidated risk table 5264, and a Risk Rating Legend 5260. The risk calculation table may comprise the following columns: Risk Factors 5206, comprising a plurality of risk factors; Material (3×) 5232, Significant (2×) 5234 and Inconsequential (1×) 5236 values—identifying whether a risk is immaterial, significant or inconsequential (such as that the risk may be automated, low, simple and/or the like); Weighting of the various risks 5238; and a Risk Rating Calculation 5240 for computing a composite risk metric.

The Consolidated Risk table 5264 may comprise the following columns:

Consolidated Account Impacted 5242—listing accounts impacted, such as for example, Accounts payable 5244, 5234, Outside services 5246, Travel and entertainment 5248, and/or the like; Consolidated Balance 5250—comprising the consolidated financial balance for a particular consolidated account; Consolidated Materiality 5252; Sub-Level Balance 5254; % Consolidated Balance 5256; and Sub-Level Materiality 5258.

Additionally, the Risk Calculation page 5200 may comprise a Risk Rating Legend 5260. In a representative embodiment of the present invention, a risk rating of <1.5 may be classified as inconsequential, a risk rating of more than 1.5 and less than or equal to 2.5 may be classified as significant, and a risk rating of more than 2.5 and less than or equal to 3 may be classified as material. The Risk Calculation page 5200 may further comprise: a Back button 5266—returning the user back to the assessment deficiency details page; and a Print button 5268.

In another representative embodiment of the present invention, the calculated risk index value may be translated into a suggested risk materiality in the Risk Assertion field under the Assess stage. This suggested risk materiality and index value may be altered by the administrator to more accurately reflect the perceived risk of a certain control with respect to a particular business. In yet a further representative embodiment of the present invention, the risk function may be optional for the system to function correctly and/or it may put a control into perspective with respect to a risk associated with noncompliance.

It should be appreciated that in accordance with various aspects of the present invention, the risk rating may require one or more predefined accounts. In a representative embodiment of the present invention, a predefined account setup may be formatted as indicated in the table below:

| Screen | | | | Value | | |
|---|---|---|---|---|---|---|
| Label | Control Type | Required | Validation | (*Default) | Related Table | Comments |
| Predefined | Column 1 | Yes | | None | | |
| Accounts | Editable Text | | | | | |
| Link | Column 2 | NA | At least one | None | | If no processes |
| | Link Icon | | process | | | are linked to |
| | Unlink Icon | | should be | | | the predefined |
| | | | linked to a | | | account display |
| | | | predefined | | | the Unlink Icon. |
| | | | account | | | If one or more |
| | | | | | | processes are |
| | | | | | | linked to the |
| | | | | | | predefined |
| | | | | | | account display |
| | | | | | | the Link Icon. |
| | | | | | | Please use the |
| | | | | | | Link and Unlink |
| | | | | | | Icons used in |
| | | | | | | the |
| | | | | | | Consolidated |
| | | | | | | Trial Balance |
| | | | | | | page. |
| Undo | FarPoint | NA | NA | NA | | Discards the |
| | Control | | | | | last change. |
| Add Row | FarPoint | NA | NA | NA | | Adds a blank |
| | Control | | | | | row to the |
| | | | | | | bottom of the |
| | | | | | | table |
| Delete | FarPoint | NA | NA | NA | | Deletes the |
| | Control | | | | | selected row |
| | | | | | | and all Process |
| | | | | | | links |
| | | | | | | associated to |
| | | | | | | the row. |
| Up | FarPoint | NA | NA | NA | | Moves the |
| | Control | | | | | selected row |
| | | | | | | up one position |
| Down | FarPoint | NA | NA | NA | | Moves the |
| | Control | | | | | selected row |
| | | | | | | down one |
| | | | | | | position. |
| Print | Button | NA | NA | NA | | Prints the Predefined |
| | | | | | | Accounts |
| | | | | | | report (To Be |
| | | | | | | Defined) |
| Save | Button | NA | NA | NA | | Verify that at |
| | | | | | | least one |
| | | | | | | process is |
| | | | | | | linked to each |
| | | | | | | predefined |
| | | | | | | account. |
| | | | | | | If any accounts |
| | | | | | | are unlinked, |
| | | | | | | display the |
| | | | | | | following |
| | | | | | | warning |
| | | | | | | message: “One |
| | | | | | | or more |
| | | | | | | Predefined |
| | | | | | | Accounts are |
| | | | | | | not linked to a |
| | | | | | | process”. |

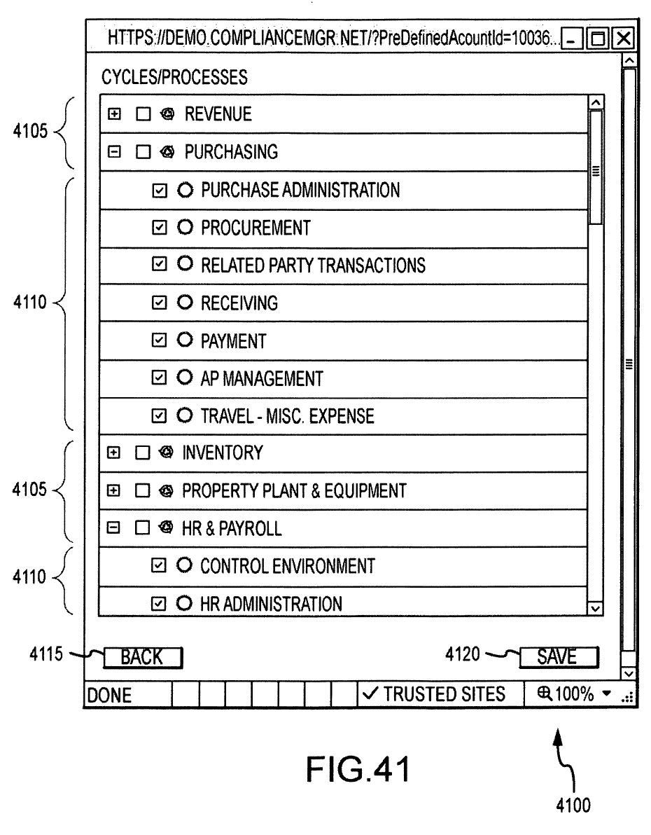

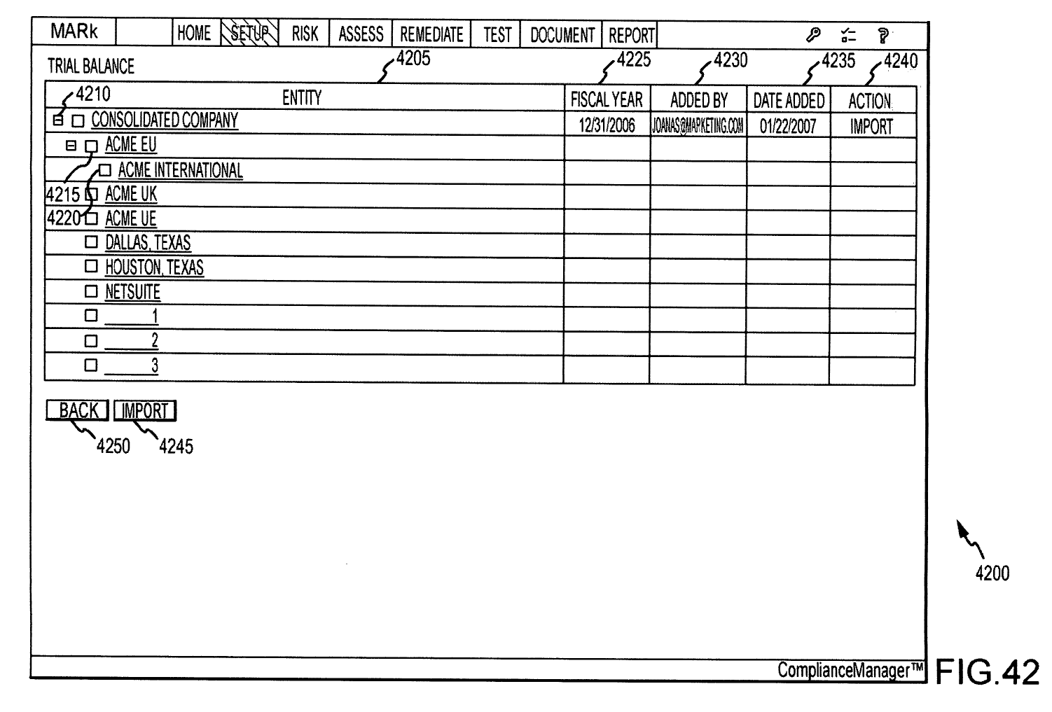

Referring now to FIG. 41, in a representative embodiment of the present invention, the system may be further configured to comprise a cycle/process popup page 4100 configured to establish one or more links between predefined accounts and processes. A cycle process popup page 4100 may comprise a hierarchy of cycles 4105 and/or processes 4110 in a particular project. In another representative embodiment of the present invention, the system may be further configured to comprise a popup watermark to replay internal control surveys with a cycle/process popup. Additionally, a back button 4115 may be suitably configured to discard changes a user may have implemented and/or return the user to the Predefined Account Setup page. A save button 4120 allows a relationship to be created between a selected predefined account and one or more checked processes. In a representative embodiment of the present invention, in order to perform the risk rating, typically all cycles and processes must be linked to a financial account and assigned a materiality in the Trial Balance Setup and the Assessment Control Survey should be complete.

Referring now to FIG. 42, in a representative embodiment of the present invention, a Trial Balance Setup page 4200 may comprise an Entity column 4205 where a business 4210 and its components (such as divisions, subsidiaries, and/or the like 4215) and/or any of the sub-components such as a branch and/or subdivision 4220 may be listed. Additional columns may include: Fiscal Year 4225, Added By 4230, Date Added 4235, and Action 4240. Furthermore, buttons (such as a back button 4250, which may be configured to direct a user to a previous screen such as the Trial Balance Summary screen, and/or an import button 4245) may be present. The import button 4245 may be suitably configured to link to a popup that permits a user to upload a consolidated and/or sub-level trial balance. The Import popup may be further configured to comprise radio buttons that allow the user to indicate whether the imported information should update or replace trial balance information.

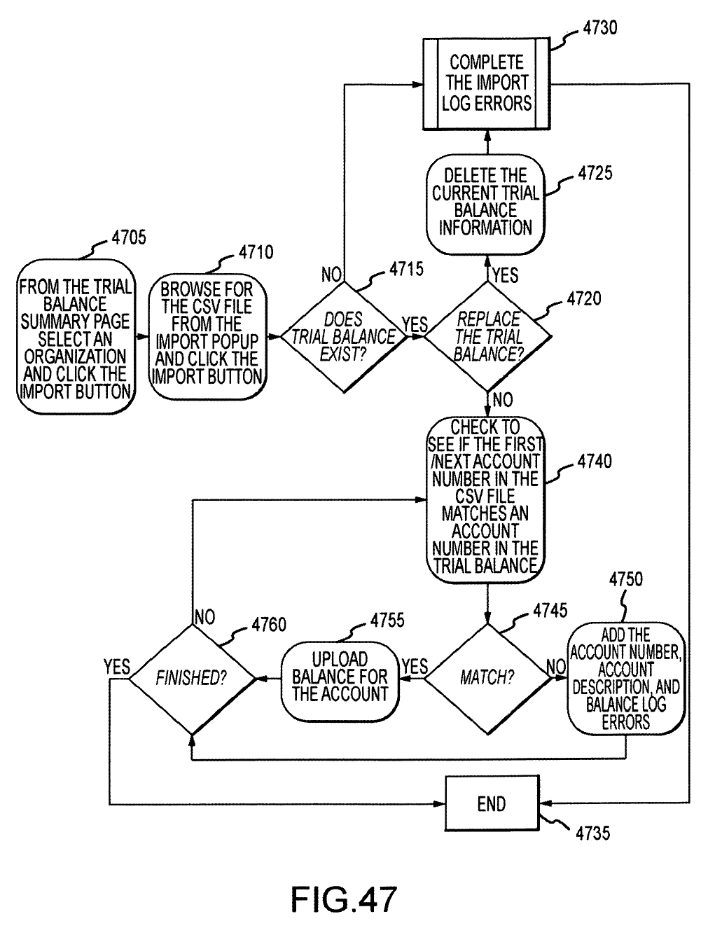

Referring now to FIG. 47, a user may access the import popup from the Import button 4245 located on the Trail Balance Summary Page 4705. Once the import popup is visible, a user may browse for a file and click “import” 4710. If the answer to whether the Trial Balance Exists 4715 is ‘No’, then the system will complete the import log errors 4730 and end 4735. If the answer to whether the Trial Balance Exists 4715 is ‘Yes’ and the user chooses to replace the Trial Balance 4720, then the system will delete the current trial balance information 4725, complete the import log errors 4730 and end 4735. If the answer to whether the Trial Balance Exists 4715 is ‘Yes’ and the user chooses not to replace the Trial Balance 4720, then the system will check to see if the first and/or next account number in a file matches an account number in the Trial Balance 4740. If the answer to whether there is a match 4745 is ‘No’, then the system will add the account number, account description and/or balance log errors 4750. If the user and/or system determine that the import is finished 4760, then the import ends 4735. If the user does not determine the import to be finished 4760 for uploading the balance for the account 4755, then the system will again determine if the first and/or next account number in a file matches an account number in the Trial Balance 4740. If the answer to whether there is a match 4745 is ‘Yes’, then the user and/or system will upload balance for the account 4755, and if the user and/or system determines that the import is finished 4760, then the import ends 4735. If the user does not determine the import to be finished 4760 after uploading of the balance for the account 4755, then the system will again determine if the first and/or next account number in a file matches an account number in the Trial Balance 4740.

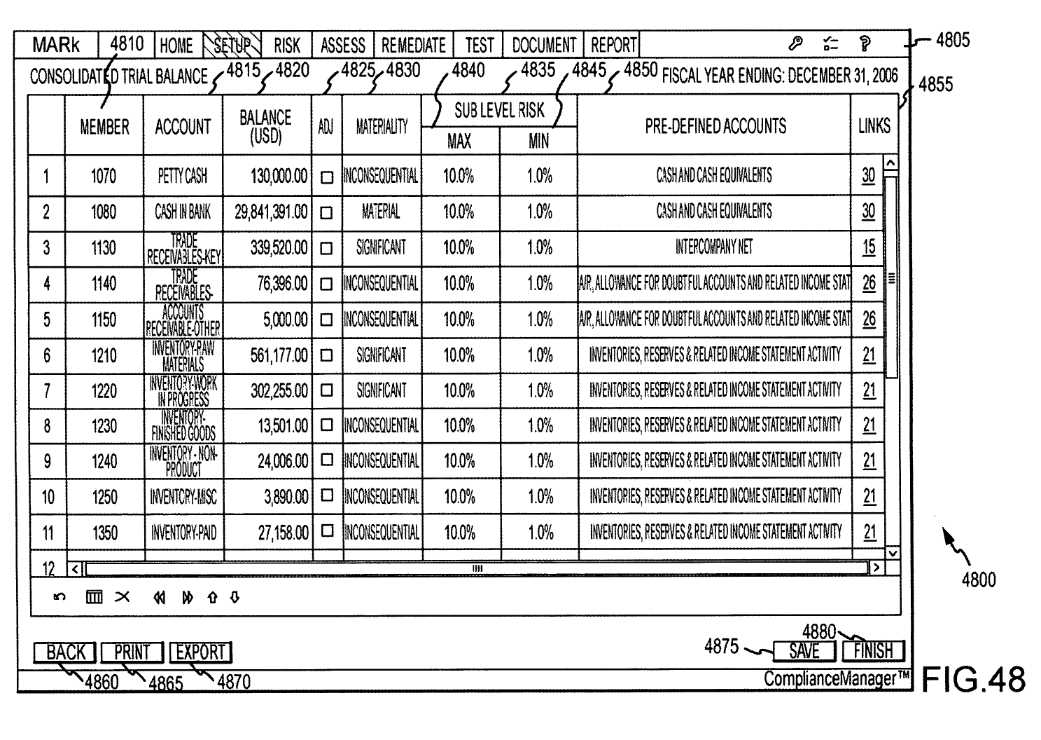

The system may be configured to allow a user, from the Trial Balance Setup screen 4200, to select an entity and view a consolidated trial balance for a fiscal period. Referring now to FIG. 48, in a representative embodiment of the present invention, a Consolidated Trial Balance screen 4800 may provide a consolidated trial balance for a particular Fiscal period such as a Fiscal Year 4805. The Consolidated Trial Balance screen 4800 may also include the following columns: Number 4810; Account 4815—comprising the account type, such as Petty Cash, Cash in bank, Inventory, and/or the like; Balance 4820—comprising a monetary amount related to an Account 4810; Adj 4825—comprising a checkbox column indicating whether an adjustment has taken place for an account; Materiality 4830—providing the materiality level of associated risk with an account, comprising at least one of: inconsequential, material, and significant; Sub-Level Risk 4835 providing Maximum 4840 and Minimum 4845 sub-columns—comprising the maximum and minimum risk levels for a sub-level account; Pre-Defined Accounts 4850—comprising the name of a predefined account selected for the associated account; and Links 4855—comprising a link to the Process/Control selection popup 4100. The Consolidated Trial Balance page 4800 may further comprise a Back button 4860—configured to return a user to the Trial Balance Summary page 4200; a Print button 4865—configured to generate a printable version of the page; Export button 4870—configured to generate and export a page to a spreadsheet program such as Microsoft Excel; a Save button 4875—configured to save any changes made to a page; a Finish button 4880—configured to allow a user to complete a currently selected trial balance.

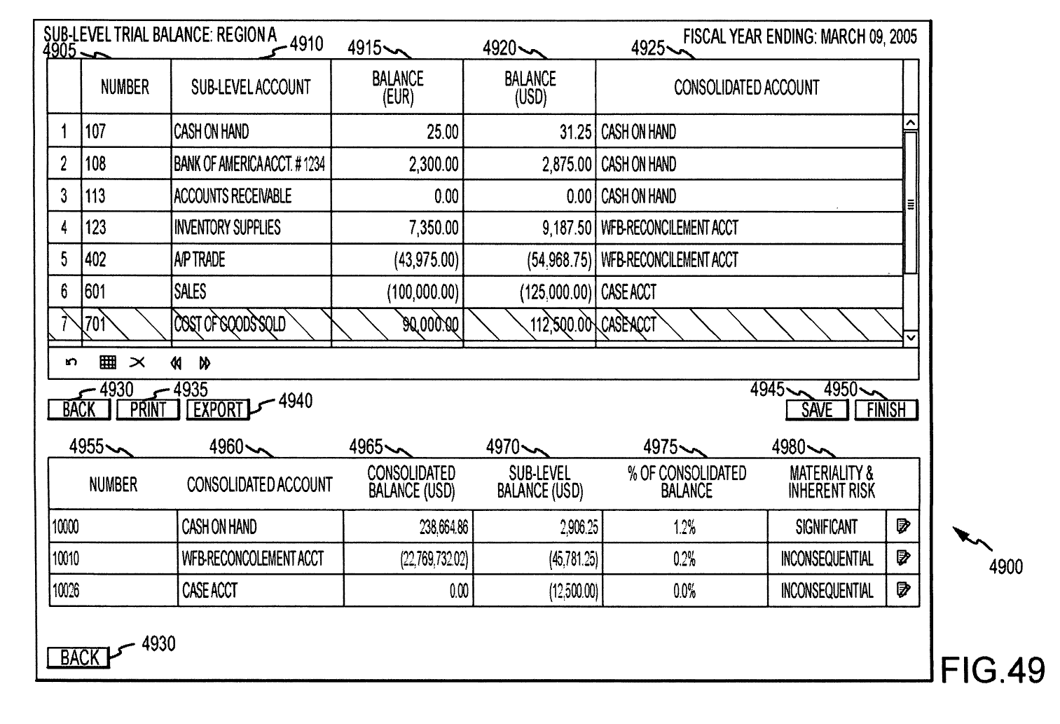

The Trial Balance Summary Page may comprise a link to a sub-level trial balance. Referring now to FIG. 49, in a representative embodiment of the present invention, a Sub-level Trial Balance page 4900 may comprise a table with the following columns: Number 4905—comprising a sub-level account number; Sub-level Account 4910—comprising a sub-level account description; Balance (Sub-Entity Currency) 4915—comprising a sub-entity currency balance; Balance (Base Currency) 4920—comprising a balance in a base currency; and Consolidated Account 4925—comprising the name of a consolidated account selected for an account. The Sub-level Trial Balance page 4900 may further comprise a Back button 4930—configured to return a user to the Trial Balance Summary page 4200; a Print button 4940—configured to generate a printable version of a page; Export button 4940—configured to generate and export a page to a spreadsheet program such as Microsoft Excel; a Save button 4945—configured to save changes made to a page; and a Finish button 4950—configured to allow a user to complete a currently selected trial balance.

The Sub-level Trial Balance page 4900 may further comprise a sub-level consolidated table having a consolidation of the sub-level trial balance accounts. The Sub-level Trial Balance page 4900 may include the following representative columns: Number 4955—comprising the sub-level account number; Sub-Level Account 4960—comprising the sub-level account description; Consolidated Balance (Base Currency) 4960—comprising the total balance in the selected currency; Consolidated Balance (Sub Level Currency) 4965—comprising the total balance in a selected currency; Sub-Level Balance 4970—comprising the total balance in the selected currency; % of Consolidated Balance 4970—comprising the percentage of the consolidated balance; and Materiality and Inherent Risk 4980—comprising the materiality based on consolidated accounts materiality, maximum and minimum risk parameters, and the % of Consolidated Balance.

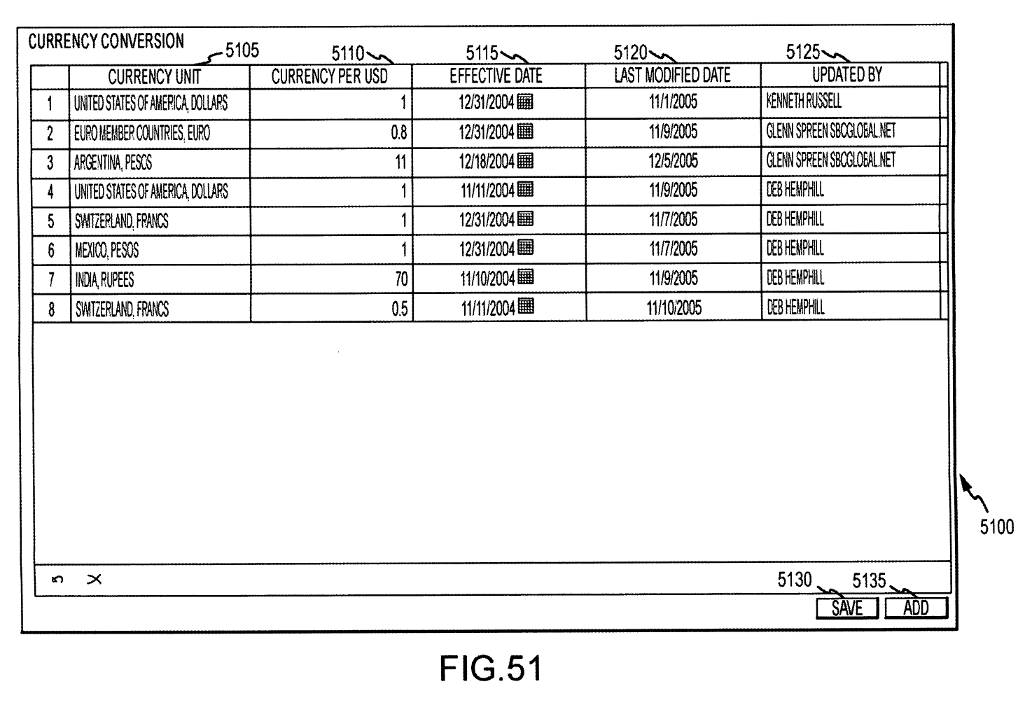

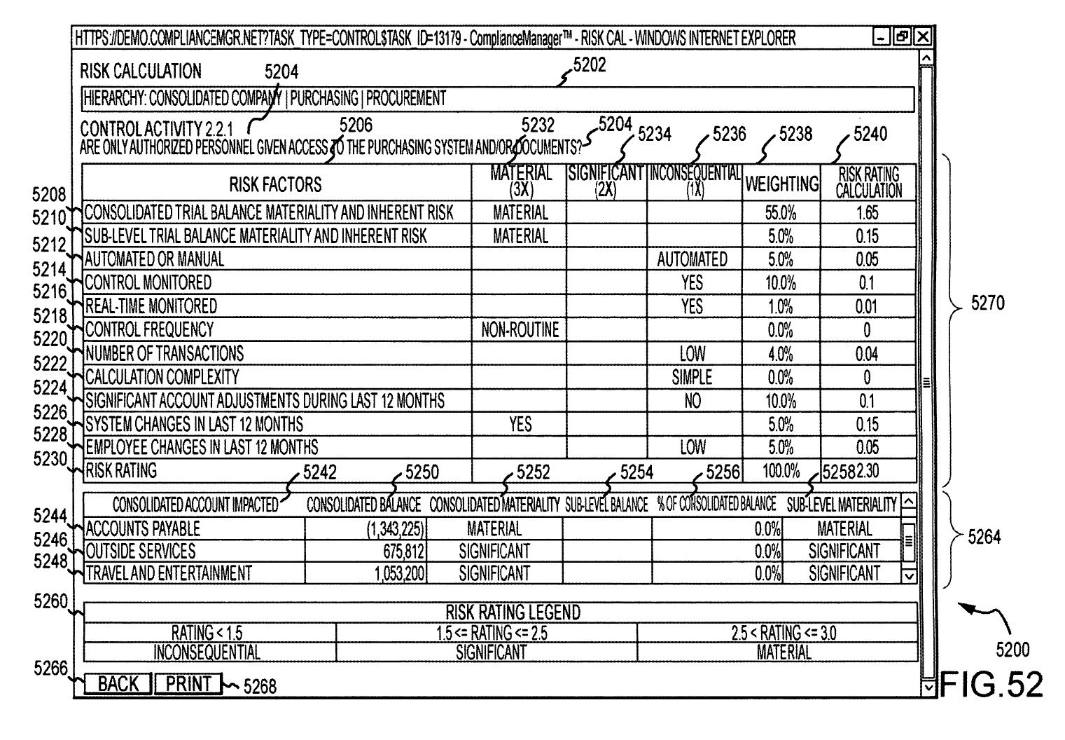

The system may be further configured to accept financial data in more than one currency. For example, the system may comprise a currency conversion subsystem and/or currency conversion setup. Referring now to FIG. 51, in a representative embodiment of the present invention, a Currency Conversion setup page may comprise a table with the following representative columns: Currency Unit 5105—comprising the currency that applies to the conversion rate; Currency per “Base Currency” 5110—comprising the conversion from the selected currency to the base currency; Effective date 5115—comprising the effective date of the conversion rate; Last Modified date 5120—comprising the last date that the conversion rate was modified; and Update By 5125—comprising the name of the last user to update the conversion rate. Additionally, the Currency Conversion setup page 5100 may comprise a Save button 5130 that saves any changes made to the currency conversion table and an Add button 5135 that may be configured to show the add currency form to allows a user to add a new conversion.

Sample sizes for testing may comprise pre-populated and/or custom sample sizes. Pre-populated sample sizes may comprise system generated sample size calculations based on a confidence level, such as 90%, 95%, and/or the like. In a representative embodiment of the present invention, a confidence level may comprise a low margin of error (e.g., a deviation rate of no more than 5%). In another representative embodiment of the invention, a default sample size may correspond to 95% for all entities.

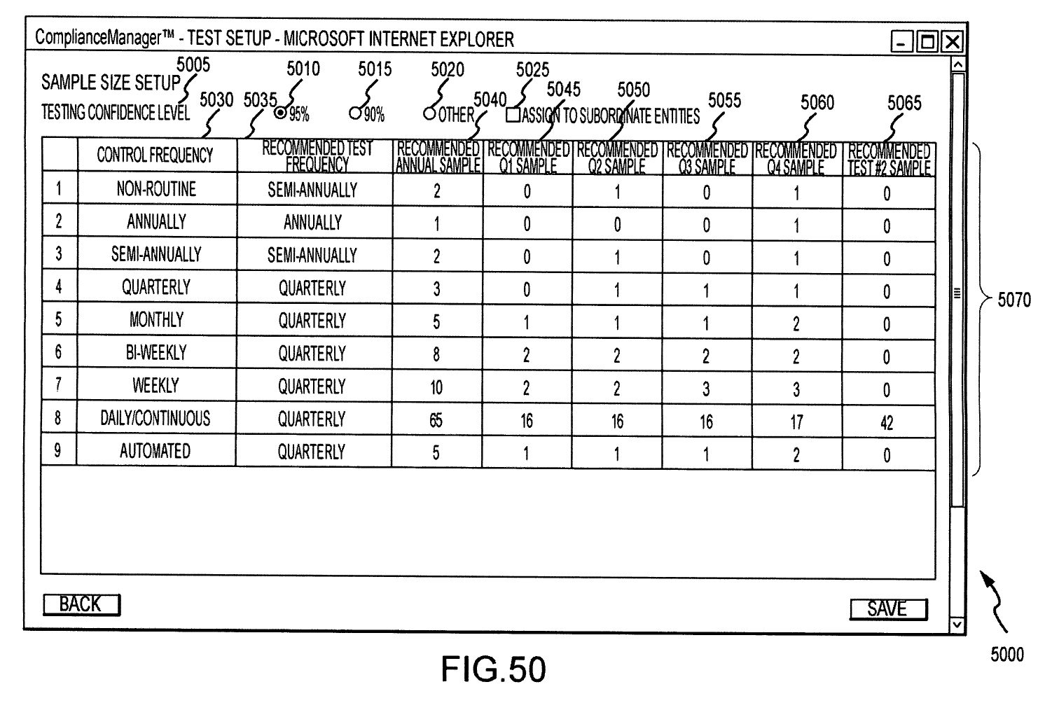

Referring now to FIG. 50, in a representative embodiment of the present invention, a sample size may be characterized through a Sample Size Setup page 5000. The Sample Size Setup page may comprise a Testing Confidence Level field 5005 and a control frequency table 5070. The Testing Confidence Level field 5005 may comprise radio buttons to allow the user to select a confidence level of 95% 5010, 90% 5015, or Other 5020. Additionally, a user may be able to assign the selected testing confidence level to subordinate entities through a checkbox 5025. The table may comprise the following representative columns: Control Frequency 5030—indicating how often the test for a control is performed; Recommended Frequency 5035—providing a recommended test frequency for a control; Recommended Annual Sample 5040—indicating how many samples are to be tested annually based on the control frequency; Recommended Q1 Sample 5045—indicating how many samples are to be tested in the first quarter based on the control frequency; Recommended Q2 Sample 5050—indicating how many samples are to be tested in the second quarter based on the control frequency; Recommended Q3 Sample 5055—indicating how many samples are to be tested in the third quarter based on the control frequency; Recommended Q4 Sample 5060—indicating how many samples are to be tested in the fourth quarter based on the control frequency; and Recommended Test #2 Sample 5065—indicating how many samples are to be tested in the second test (if applicable) based on the control frequency.

The system may comprise one or more mechanisms for connecting one or more documents to any number of tasks in a workflow (e.g. via a document clothesline). A document clothesline may comprise a document workflow function allowing documentation tasks to be assigned and/or attached at any level in the summary navigation trees (i.e., upon the assignment step regardless of whether user has existing profile or status in the system). In a representative embodiment of the present invention, a documentation task may comprise a letter and/or form certifying a set of controls as completed and may contain the actual results of those controls. The documentation task may be automatically written by the system based on a template. The user responsible for producing the documentation task generally will append a signature at the bottom either agreeing and/or disagreeing with any statements. The form may be designed such that the user simply selects the bubble corresponding to the desired response.

In a representative embodiment of the present invention, response choices may correspond to: “Yes, I agree with the representations made above” and “No, I do not agree with the representations”. In another representative embodiment of the present invention, if the user chooses to disagree with the representations made in the letter, they may be required to type comments in the comment box before the system will let the user submit the documentation task. In yet a further representative embodiment of the present invention, a user may type their name and position into the appropriate fields in order to complete the documentation task. The documentation tasks may be created and attached at any time interval, including (but not limited to) quarterly and/or annual intervals, allowing the user to assign, complete and approve documentation tasks in intervals throughout the year. These intervals may be determined by the administrator or project coordinator and also may be altered in any suitable manner, such as allowing the user complete a documentation task at any desired time.

It should be appreciated that in accordance with various aspects of the present invention, a template may be used to create the content of the documentation tasks with the system populating the template with appropriate data. For example, the template may require the system to populate fields with certain controls and/or other project data. The template may be modified by the administrator and/or users. The documentation tasks may include a track changes features which allows changes in the data to be saved and/or searched. The base and task values may be saved separately and a user may view and/or audit changes made between the quarterly documentation tasks. The template and documentation task setup may be implemented in any suitable manner in order to record and/or certify that controls or other activities are being completed, such as allowing users to create their own documentation tasks not based on a template, only partially based on a template, or to upload a document for use as a template.

The system may be further implemented to include a document library. The document library may comprise a central point where attachments may be added throughout the workflow process and may further be searched, viewed, added, updated, deleted, and/or the like. In a representative embodiment of the present invention, a document library may permit documents from a single project to be searched, but may otherwise allow documents added in the system to be searched. Documents may be attached and/or viewed throughout various stages in the workflow process and at various hierarchy levels. The document library may also permit a user to find a specific task, stage and/or node where the original document was attached, as well as download the attachment from the library without returning to the task, stage or node where the document was originally attached.

In another representative embodiment of the present invention, the document library page may also allow the user to add new documents. When a user adds a document to the document library, they will generally select an appropriate document tag. The document tag may comprise fields that associate an attachment to a specific control within a project. The document tag may comprise, for example: business unit, document type, cycle, process, control activity number, description, document name, and whether the document should be set to a privacy view for internal review to prevent access to the document to users with read-only or guest access. The system may also be configured to add searchable document tags (e.g. ‘added by’, ‘project name’, etc.) automatically, based on the user's Login ID and the project where the attachment is added. Documents may also be added to the document library after attachment at various stages, hierarchy levels, as well as within specific tasks in the workflow process.

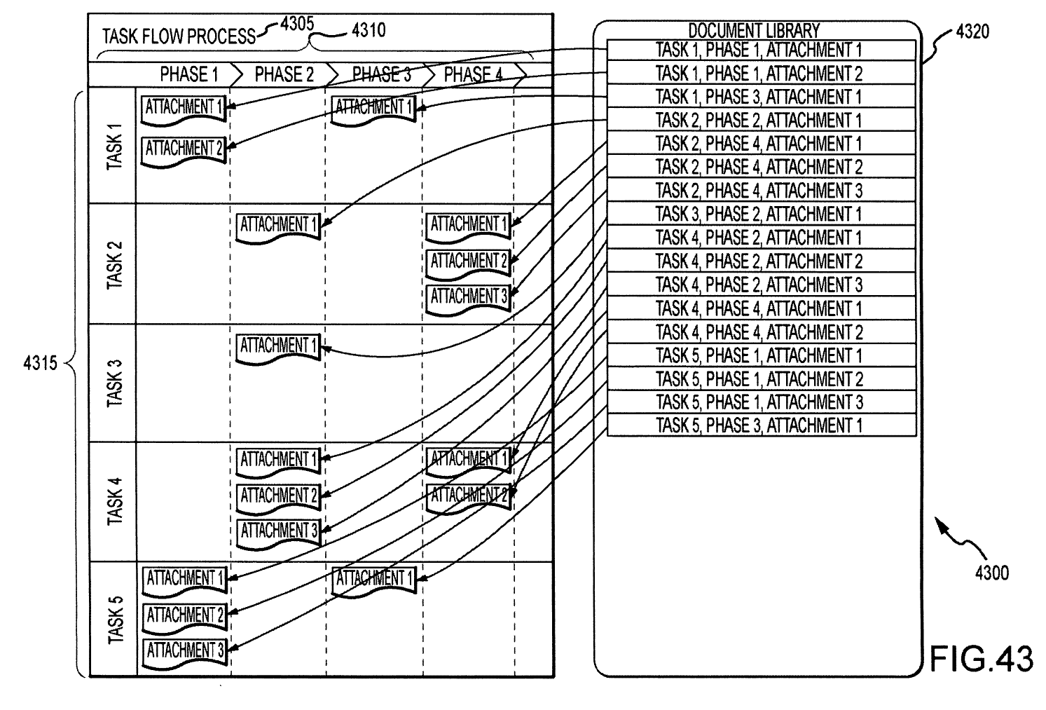

Referring now to FIG. 43, in a representative embodiment of the present invention, the document library 4320 may be implemented in accordance with a task flow process 4305, where a document may be tagged in association with a phase 4310 and a task 4315. In such an embodiment, a document library 4320 may be organized by task number, phase number, and attachment number within a task flow process.

In another representative embodiment of the present invention, as with documents added at the document library page, the system may also automatically apply document tags to the attachment. The user does not need to enter this information, although the system may be configured such that a user may enter the information manually. Additionally, the document tags will generally comprise searchable parameters within the document library.

To perform a search of the document library, the user may construct a search request using drop-down filters at the top of the page. In exemplary embodiments of the present invention, representative filters may include: Added By, Business Unit, Control Activity Number, Cycle, Description, Document Date, Document Name, Document Type, Process and/or Project. Additionally, the user may construct a search by selecting any number of filters, such that only documents that meet all of the restrictions are displayed. To add filters, the user may create a filter and then press the “add” button at the top of the document library. After the user has selected all of the desired filters, they may then select the search button and only the documents satisfying all of the requirements for the corresponding search criteria will be displayed in the document library. Documents may be added in any suitable manner and at any location and/or workflow in the system. Additionally, the system may be configured to accept any type of computer file as a document to be uploaded, such as, for example: .doc, .pdf, .mp3, .jpeg, .tif, .xls, and/or the like.

In a representative embodiment of the present invention, the user may select an ‘attach document’ hyperlink located in the control detail summary to attach a document. The hyperlink may be configured to open an Add Attachment popup, and after the user selects the document to upload, types a description and selects whether it is for internal review only before pressing the import button. In another representative embodiment of the invention, document tags may then be applied automatically to the attachment, as previously described, and listed both in the Add Attachment popup as well as in the document library.

The system may provide one or more reports. Reports may be configured to display information about one or more processes, cycles and/or controls. Reports may be implemented in any suitable manner to allow the user to filter and evaluate the data based on a set of parameters, whether now known or otherwise hereafter described in the art.

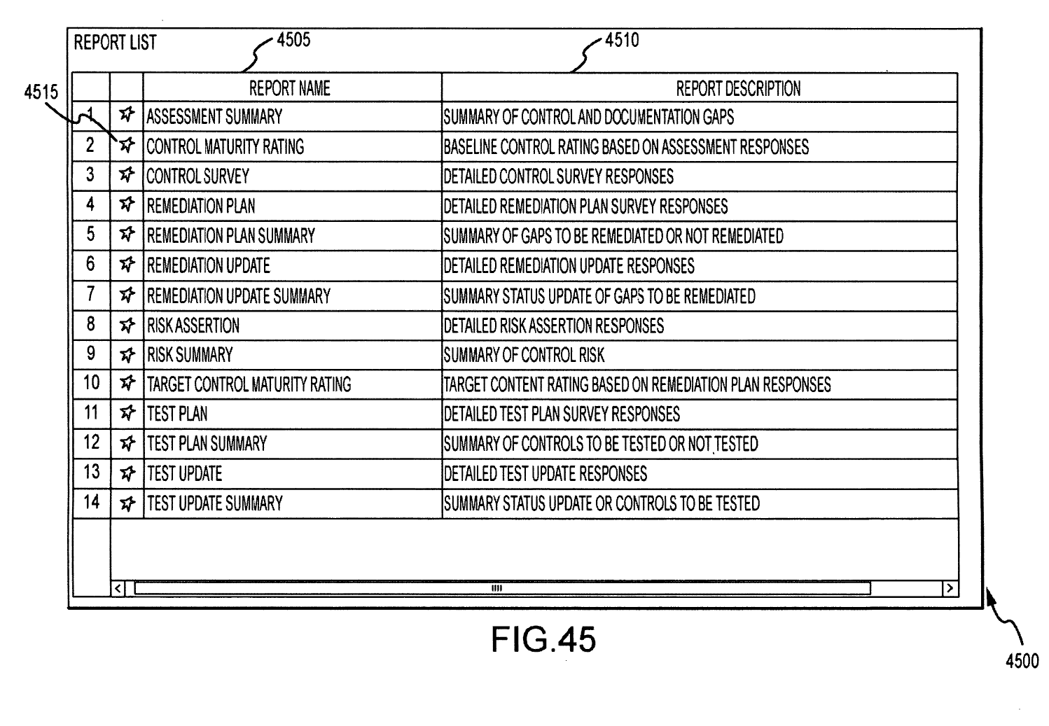

In a representative embodiment of the present invention, reports may be implemented in the system through a reports page. Referring now to FIG. 45, the Reports page 4500 may be adapted to display a table with a list of reports pre-defined by the system and/or previously saved in two columns: Report Name 4505 and Report Description 4510. Reports Names and Descriptions may include, for example: Assessment summary—providing a Summary of Control and Documentation Gaps; Control Maturity Rating—providing a Baseline Control Rating based on Assessment responses; Control Survey—providing Detailed Control Survey responses; Remediation Plan—providing Detailed Remediation Plan Survey responses; Remediation Plan Summary—providing a Summary of gaps to be remediated or not remediated; Remediation Update—providing Detailed Remediation Update responses; Remediation Update Summary—providing a Summary Status Update of gaps to be remediated; Risk Assertion—providing Detailed Test Plan Survey responses; Test Plan Summary—providing a Summary of controls to be tested or not tested; Test Update—providing Detailed Test Update responses; and Test Update Summary—providing a Summary Status Update of controls to be tested.

The Reports page 4500 may be further configured to include a Run Icon 4515, which may be suitably adapted to run a saved report and/or add a new report to the list and then run a report. For each report that a user requests to Run, the Report may requires that the user select Report Parameters.

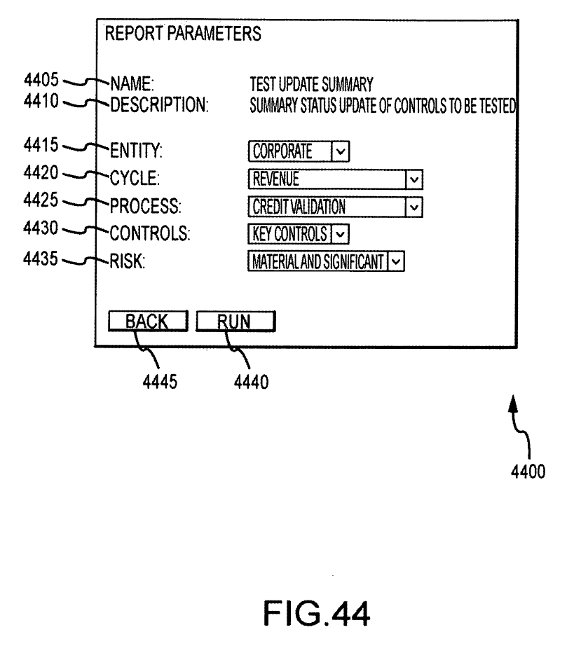

Referring now to FIG. 44, in a representative embodiment of the present invention, a Report Parameters popup 4400 may display details of a report. The Report Parameters popup 4400 may include, for example: the report name 4405 and description 4410, as well as provide drop-down boxes such that the user may select the entity (or other hierarchal data node) 4415; the cycle 4420; the process 4425; and the type of controls to display 5530, such as all controls or only key controls. Optionally, the Report Parameters page may include: Assess—where the user may select document gaps, control gaps or all; risk 4435—where the user may select material risks, inconsequential, significant or material, and significant; and remediate—where the user may select gaps that have been remediated and/or gaps that have not been remediated. Additionally, the Reports Parameter popup 4400 may comprise a Back button 4445 that may direct the user back to the Reports page 4500.

After selecting the parameters, the user selects the Run button 4440 from the Report Parameters popup 4400 and the report is generated and displayed as a popup. Request data is captured from the system and populated into the report structure and the report is able to be exported and/or printed.

A report structure may comprise a table, similar to a summary table, and may include a column for the company hierarchy, as well as columns for the different task status in one or more levels of the company's organization. In a representative embodiment of the present invention, a drill-down report may be available for selected data. The drill-down report may be configured to display additional information about the summary data provided in the original report. For example, the process of a particular business and its rejected tasks may be selected to show a display of each control and the tasks that have been rejected and what values have been entered.

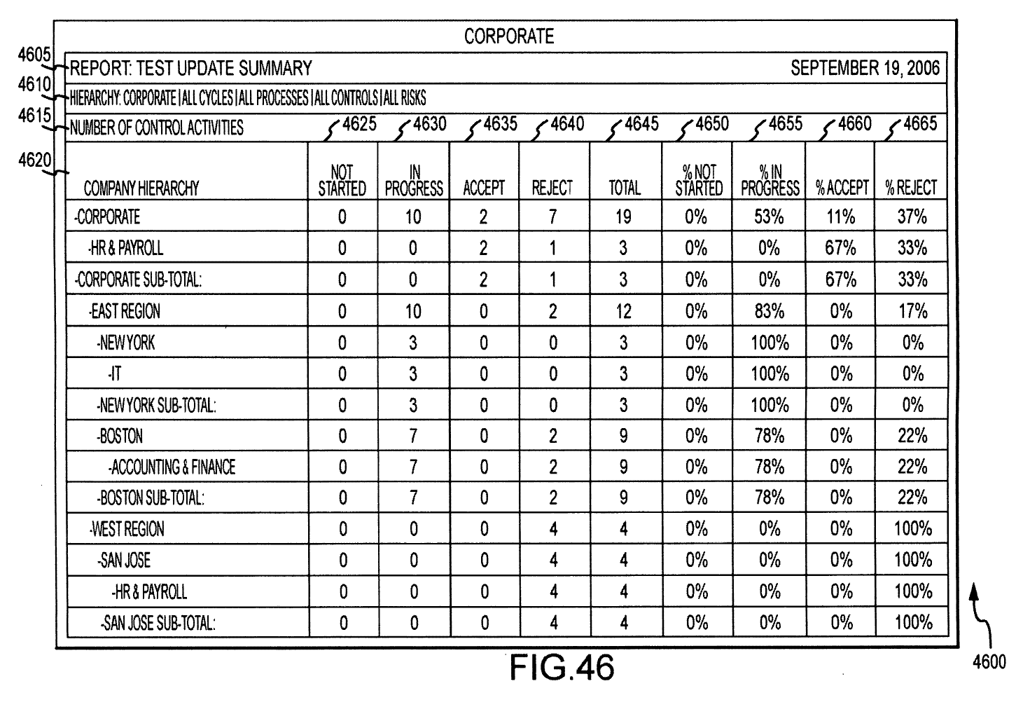

Referring now to FIG. 46, in a representative embodiment of the present invention, a report 4600 may comprise: a report name caption 4605; a hierarchy caption 4610; number of controls caption 4615; and a table comprising the following columns:

Company Hierarchy 4620; Not Started 4625; In Progress 4630; Accept 4635; Reject 4640; Total 4645; % Not Started 4650; % In Progress 4655; % Accept 4660; and % Reject 4665.

The system may be configured to permit users to create custom reports based on one or more criteria. Custom reports may display a summary of the tasks status and stages by selecting data elements through filtering global and/or project data within a specific project. In a representative embodiment of the present invention, custom reports may be configured to allow a user to quickly and efficiently summarize a current status of a project, outcomes of previous projects, and/or the like. In another representative embodiment of the present invention, a user may create a custom report on various aspects of a business' compliance with one or more standards. In yet a further representative embodiment of the present invention, a user may create a custom report to demonstrate test results in a particular period and/or test results over one or more periods.

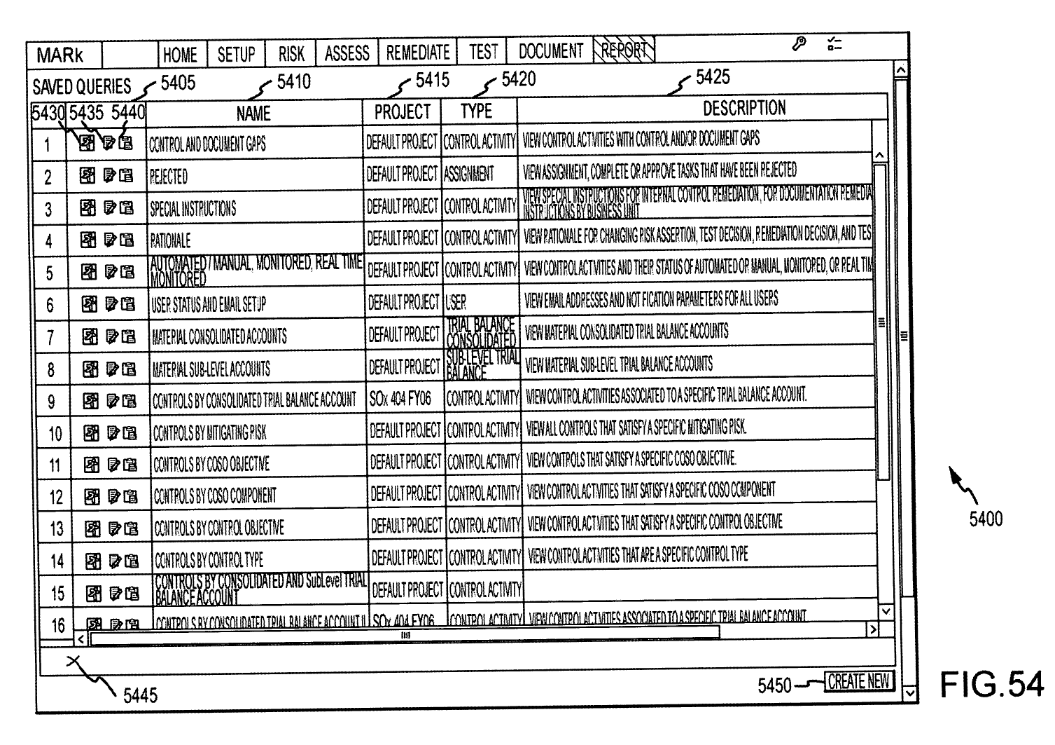

A user may create a custom report through a query page via accessing a Query page through the homepage under the Navigation Bar Button Risk. The user may choose to execute a new query and/or run a previously saved query. Referring now to FIG. 54, in a representative embodiment of the invention, a Query page may comprise a table of previously saved queries, and a Create New button 5450 to allow a user to create a new query. The table of save queries may comprise the following representative columns: an icon column 5405 comprising a Run icon 5430, an Edit icon 5435, and a Copy icon 5445; a Name column 5410 comprising the names of saved queries; a Project Column 5415 comprising the name of the project that the query is set to run against; a Type column 5420 identifying the type of filed associated with the query; and a Description 5425 column comprising a description of the saved query. Additionally, a user may delete one or more saved queries by selecting the query to be deleted and clicking the Delete icon 5445.

In a representative embodiment of the present invention, the icons available in the Icon column 5405 for selection may depend on the query and the user. For example, the Edit icon 5435 may not be available for a user viewing a public query. In another representative embodiment of the present invention, the Query page 5400 may be configured to display a list of previously saved queries. There may be at least two types of queries: public and private. In yet another representative embodiment of the present invention, a public query may be seen by all users; however, only administrators will generally be able to edit the results. A user may copy a public query as a private query and modify it as a private query for his or her own use.

In a further representative embodiment of the present invention, a private query may comprise a query that has been created by the user ab initio or by copying another existing query. In general, these queries may only be seen by the user that creates them. After a user has executed a query, the results may be presented as a grid. Thereafter, the user may export these results as a Microsoft Excel spreadsheet, Adobe Acrobat PDF, and/or any other desired format.

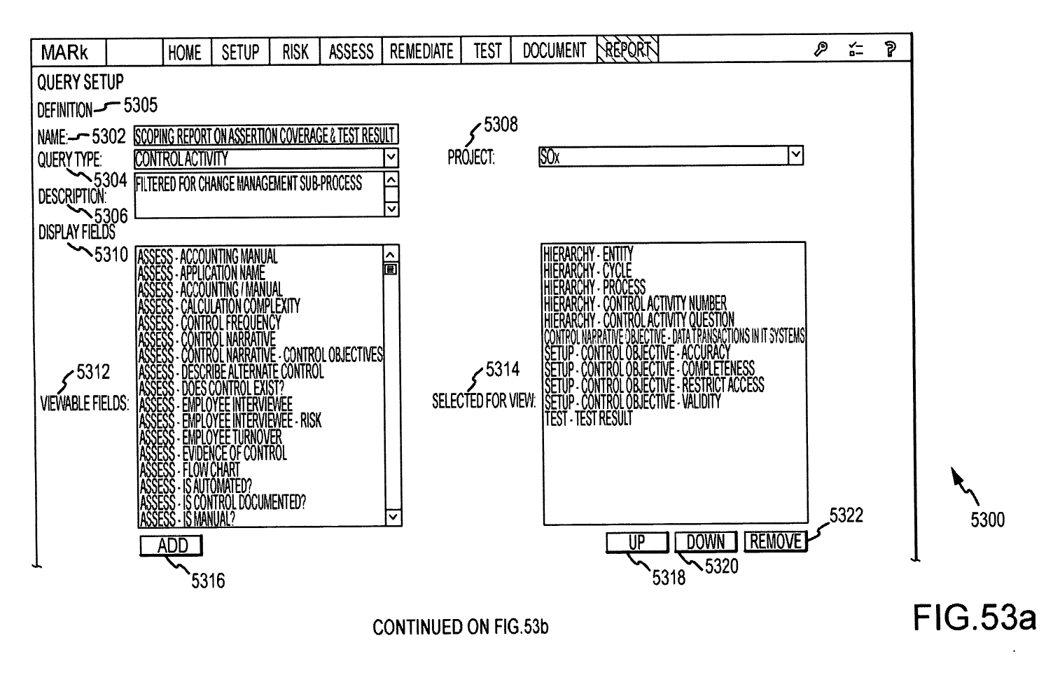

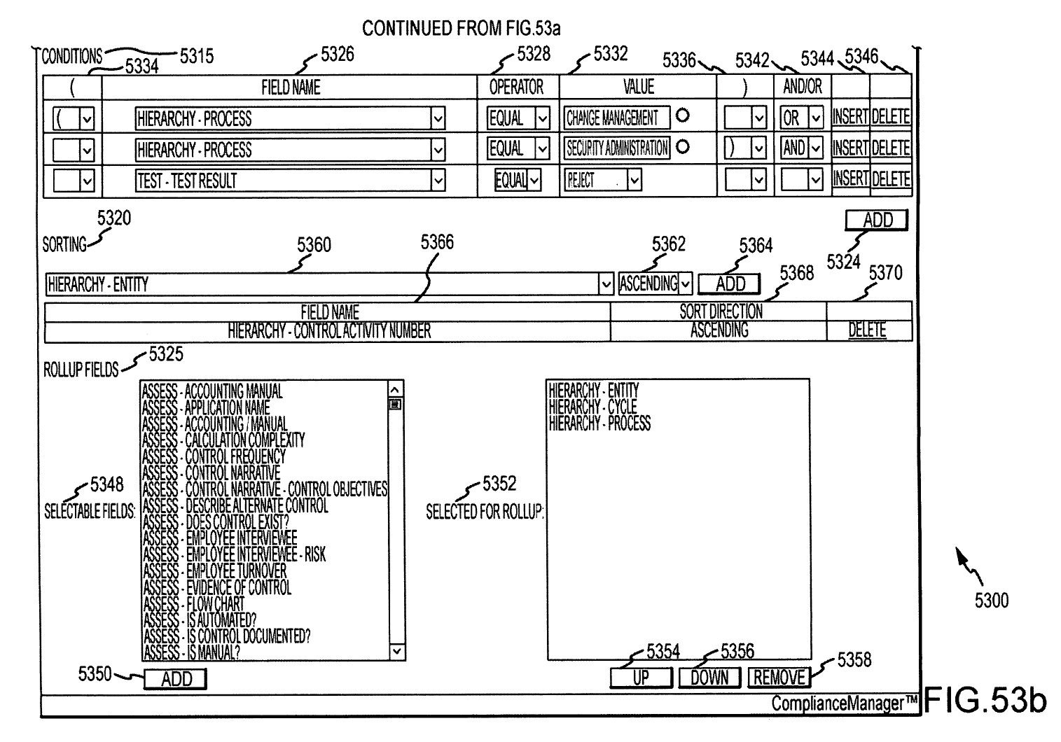

In a representative embodiment of the present invention, a user may select a Create New button 5450 on the Query page 5400 to create a new query. Referring now to FIG. 53, in a representative embodiment of the present invention, the Query Setup Page 5300 may comprise various sections, including, for example: Definition 5305, Display Fields 5310, Conditions 5315, Sorting 5320, and Rollup Fields 5325. The Definition 5305 section may comprise the following fields: Name 5302—providing a field for description of query; Query Type 5304—comprising a textbox where the user may describe the query; and Project 5308—comprising a drop-down menu for selecting a project to ensure that only data related to that specific project will be returned to the user. The user may select from a variety of query types, where the type instructs the system where to retrieve data and determines the sets of fields included in the query. An non-inclusive list of representative query types may include: Assignment—providing a data field based on user assignment and status; Control Activity—providing a data field based on the control activity base and element values along with some task status information; User-providing a data field based on user information; Trial Balance Consolidated—providing a data field based on the consolidated trial balance entries; and Sub-Level Trial Balance—providing a data field based on the sub-level trial balance entries. The query definition may be set up in any suitable manner, such as permitting multiple projects to be selected.

The second section generally comprises the Display Fields 5310. The Display Fields 5310 may include a column corresponding to Viewable Fields 5312—where the user may select the fields displayed on the query result from a set of viewable fields. These viewable fields may be determined from the user selection under query type. When the user selects a certain field as viewable, that field may be displayed in another column under Selected for View 5314. The user may then select as few or as many fields for viewing and may remove selected fields by simply pressing the Remove button 5322. Additionally, the user may determine the order in which the fields are displayed on the query results page by selecting a field and pressing the Up 5318 or Down 5320 buttons at the bottom of the ‘Selected for View’ column. The user may also add view fields using the Add button 5316.

Viewable fields 5310 in accordance with various aspects of the present invention may comprise a type of query using at least one of the following fields listed in the table below:

| Query Type | Viewable Field |
|---|---|
| Assignment | Actual End Date |
| Assignment | Actual Start Date |
| User | Address 1 |
| User | Address 2 |
| Consolidated | Adjustments |
| Trial Balance | |
| Control Activity | Application Name |
| Control Activity | Assertions |
| Control Activity | Assertions - Completeness |
| Control Activity | Assertions - Disclosure |
| Control Activity | Assertions - Existence |
| Control Activity | Assertions - Measurement |
| Control Activity | Assertions - Occurrence |
| Control Activity | Assertions - Presentations |
| Control Activity | Assertions - Rights and Obligations |
| Control Activity | Assertions - Valuation |
| Control Activity | Assessment Automated/Manual |
| Control Activity | Assessment Employee Interviewee |
| Control Activity | Assessment Monitored |
| Control Activity | Assessment Preparer″s Name |
| Control Activity | Assessment Real Time Monitored |
| Assignment | Assignmentment Type |
| Sub Level | Associated Consolidated Account |
| Trial Balance | |
| Sub Level | Balance in Consolidated Currency |
| Trial Balance | |
| Sub Level | Balance in Sub-Level Currency |
| Trial Balance | |
| Control Activity | Business Unit |
| Assignment | Business Unit |
| Control Activity | Calculation Complexity |
| User | City |
| Control Activity | COBIT Domain |
| Control Activity | COBIT Domain - Acquire & Implement |
| Control Activity | COBIT Domain - Deliver & Support |
| Control Activity | COBIT Domain - Evaluate |
| Control Activity | COBIT Domain - Monitor |
| Control Activity | COBIT Domain - Plan & Organize |
| Control Activity | COBIT Information Credibility |
| Control Activity | COBIT Information Criteria - Availability |
| Control Activity | COBIT Information Criteria - Compliance |
| Control Activity | COBIT Information Criteria - Confidentiality |
| Control Activity | COBIT Information Criteria - Effectiveness |
| Control Activity | COBIT Information Criteria - Efficiency |
| Control Activity | COBIT Information Criteria - Integrity |
| Control Activity | COBIT Information Criteria - Reliability |
| Control Activity | COBIT Resources |
| Control Activity | COBIT Resources - Application |
| Control Activity | COBIT Resources - Data |
| Control Activity | COBIT Resources - Facilities |
| Control Activity | COBIT Resources - People |
| Control Activity | COBIT Resources - Technology |
| Assignment | Complete Date |
| Consolidated | Consolidated Account Description |
| Trial Balance | |
| Control Activity | Consolidated Account Description |
| Consolidated | Consolidated Account Number |
| Trial Balance | |
| Consolidated | Consolidated Balance |
| Trial Balance | |
| Consolidated | Consolidated Materiality |
| Trial Balance | |
| Control Activity | Control Activity Comment |
| Assignment | Control Activity Number |
| Control Activity | Control Activity Question |
| Control Activity | Control Activity Statement |
| Control Activity | Control Frequency |
| Control Activity | Control ID |
| Control Activity | Control Objective |
| Control Activity | Control Objective - Accuracy |
| Control Activity | Control Objective - Completeness |
| Control Activity | Control Objective - Restrict Access |
| Control Activity | Control Objective - Validity |
| Control Activity | Control Remedial Action |
| Control Activity | Control Remediation Due Date |
| Control Activity | Control Remediation Owner |
| Control Activity | Control Remediation Update Status |
| Control Activity | Control Type |
| Control Activity | Control Type - Authorization |
| Control Activity | Control Type - Control Type Reconciliation |
| Control Activity | Control Type - Documentation |
| Control Activity | Control Type - Internal Control Documentation |
| Control Activity | Control Type - Safeguarding of Assets |
| Control Activity | Control Type - Segregation of Duties |
| Control Activity | Control Type - Validation |
| Control Activity | COSO Component |
| Control Activity | COSO Component - Control Activities |
| Control Activity | COSO Component - Event Identification |
| Control Activity | COSO Component - Information and Communication |
| Control Activity | COSO Component - Internal Enviroment |
| Control Activity | COSO Component - Monitoring |
| Control Activity | COSO Component - Risk Assessment |
| Control Activity | COSO Component - Risk Response |
| Control Activity | COSO Component - Objective Setting |
| Control Activity | COSO Objective |
| Control Activity | COSO Objective - Compliance |
| Control Activity | COSO Objective - Operations |
| Control Activity | COSO Objective - Reporting |
| Control Activity | COSO Objective - Strategic |
| User | Country |
| Assignment | Current Assignmentment |
| Control Activity | Current Period Test Due Date |
| Control Activity | Cycle |
| Assignment | Cycle |
| Control Activity | Describe Mitigating Control |
| Control Activity | Documentation Remedial Action |
| Control Activity | Documentation Remediation Due Date |
| Control Activity | Documentation Remediation Owner |
| Control Activity | Documentation Remediation Update Status |
| Control Activity | Documentation Special Instructions |
| Control Activity | Does Control Exist? |
| Assignment | Due Date |
| Control Activity | Employee Turnover |
| Control Activity | Entity |
| Control Activity | Evidence of Control |
| User | Expiration Date |
| Control Activity | Financial Statement Line Items |
| User | First Name |
| Sub Level | Fiscal Year End Date |
| Trial Balance | |
| Control Activity | Internal Control Special Instructions |
| Control Activity | Is Control Documented? |
| Control Activity | Is Key Control? |
| User | Last Name |
| User | Location |
| Control Activity | Mitigated Risk Description |
| Control Activity | Narrative Text |
| Control Activity | Number of Transactions |
| User | Position |
| Control Activity | Preventative/Detective |
| Control Activity | Process |
| Assignment | Process |
| User | Receive Assignments by Email |
| User | Receive Alerts by Email |
| Control Activity | Recommended Annual Sample |
| Control Activity | Recommended Test Frequency |
| Assignment | Rejected |
| Control Activity | Remedial Action Approver |
| Control Activity | Remediated Automated/Manual |
| Control Activity | Remediated Monitored |
| Control Activity | Remediated Real Time Monitored |
| Control Activity | Remediation Decision Rationale |
| Control Activity | Remediation Plan Employee Interviewee |
| Control Activity | Remediation Plan Preparer″s Name |
| Control Activity | Remediation Update Employee Interviewee |
| Control Activity | Remediation Update Preparer″s Name |
| Control Activity | Responsible Tester |
| Control Activity | Risk Assertion |
| Control Activity | Risk Assertion Employee Interviewee |
| Control Activity | Risk Assertion Preparer″s Name |
| Control Activity | Risk Assertion Rationale |
| Control Activity | Risk Rating |
| Assignment | Sequence |
| Control Activity | Stage |
| Assignment | Stage |
| User | State |
| Control Activity | Status |
| User | Status |
| Control Activity | Sub Level Account Description |
| Sub Level | Sub-Level Account Description |
| Trial Balance | |
| Sub Level | Sub-Level Account Number |
| Trial Balance | |
| Sub Level | Sub-Level Currency |
| Trial Balance | |
| Sub Level | Sub-Level Entity |
| Trial Balance | |
| Consolidated | Sub-Level Risk Max |
| Trial Balance | |
| Consolidated | Sub-Level Risk Min |
| Trial Balance | |
| Control Activity | System Changes |
| Assignment | Target End Date |
| Assignment | Target Start Date |
| Assignment | Task Name |
| Assignment | Task Owner |
| Assignment | Task Owner - email |
| Assignment | Task Status |
| Assignment | Task Type |
| User | Telephone |
| Control Activity | Test Approver |
| Control Activity | Test Control |
| Control Activity | Test Coordinator |
| Control Activity | Test Decision Rationale |
| Control Activity | Test Plan Employee Interviewee |
| Control Activity | Test Plan Preparer″s Name |
| Control Activity | Test Procedure |
| Control Activity | Test Result |
| Control Activity | Test Result Rationale |
| Control Activity | Test Special Instructions |
| Control Activity | Test Status |
| Control Activity | Test Update - Actual Sample Size |
| Control Activity | Test Update - Comment Text |
| Control Activity | Test Update - Description of Exceptions |
| Control Activity | Test Update - Number of Exceptions |
| Control Activity | Test Update - Period Name |
| Control Activity | Test Update - Recommended Sample Size |
| Control Activity | Test Update - Reference Documents |
| Control Activity | Test Update - Test End Date |
| Control Activity | Test Update - Tester |
| Control Activity | Test Update Employee Interviewee |
| Control Activity | Test Update Preparer's Name |
| User | User Id |
| User | User Role |
| User | Zip |

A third section corresponds to Conditions 5315, where the user is able to filter the data returned by the query. In a representative embodiment of the present invention, the user may select as many conditions as desired by selecting the Add button 5324 at the bottom of the conditions table. Alternatively, the user may choose not to put any conditions or restraints on the query.

The Query Setup page 5300 may further comprise a query type field that may be configured to define a query process to retrieve data and determine a set of fields that may be included in a query. In an exemplary embodiment of the present invention, representative query types may include:

| Query Type | Field Name |
|---|---|
| Assignment | Actual End Date |
| Assignment | Actual Start Date |
| Control Activity | Application Name |
| Control Activity | Assertions - Completeness |
| Control Activity | Assertions - Disclosure |
| Control Activity | Assertions - Existence |
| Control Activity | Assertions - Measurement |
| Control Activity | Assertions - Occurrence |
| Control Activity | Assertions - Presentations |
| Control Activity | Assertions - Rights and Obligations |
| Control Activity | Assertions - Valuation |
| Control Activity | Assessment Automated/Manual |
| Control Activity | Assessment Employee Interviewee |
| Control Activity | Assessment Monitored |
| Control Activity | Assessment Prepared By: |
| Control Activity | Assessment Preparer″s Name |
| Control Activity | Assessment Real Time Monitored |
| Assignment | Assignment Type |
| Sub Level | Associated Consolidated Account |
| Trial Balance | |
| Sub Level | Balance in Consolidated Currency |
| Trial Balance | |
| Sub Level | Balance in Sub-Level Currency |
| Trial Balance | |
| Control Activity | Business Unit |
| Assignment | Business Unit |
| Control Activity | Calculation Complexity |
| Control Activity | COBIT Domain - Acquire & Implement |
| Control Activity | COBIT Domain - Deliver & Support |
| Control Activity | COBIT Domain - Evaluate |
| Control Activity | COBIT Domain - Monitor |
| Control Activity | COBIT Domain - Plan & Organize |
| Control Activity | COBIT Information Criteria - Availability |
| Control Activity | COBIT Information Criteria - Compliance |
| Control Activity | COBIT Information Criteria - Confidentiality |
| Control Activity | COBIT Information Criteria - Effectiveness |
| Control Activity | COBIT Information Criteria - Efficiency |
| Control Activity | COBIT Information Criteria - Integrity |
| Control Activity | COBIT Information Criteria - Reliability |
| Control Activity | COBIT Resources - Application |
| Control Activity | COBIT Resources - Data |
| Control Activity | COBIT Resources - Facilities |
| Control Activity | COBIT Resources - People |
| Control Activity | COBIT Resources - Technology |
| Assignment | Complete Date |
| Consolidated | Consolidated Account Description |
| Trial Balance | |
| Control Activity | Consolidated Account Description |
| Consolidated | Consolidated Account Number |
| Trial Balance | |
| Consolidated | Consolidated Balance |
| Trial Balance | |
| Consolidated | Consolidated Materiality |
| Trial Balance | |
| Control Activity | Control Activity Number |
| Assignment | Control Activity Number |
| Control Activity | Control Frequency |
| Control Activity | Control ID |
| Control Activity | Control Objective - Accuracy |
| Control Activity | Control Objective - Completeness |
| Control Activity | Control Objective - Restrict Access |
| Control Activity | Control Objective - Validity |
| Control Activity | Control Remediation Due Date |
| Control Activity | Control Remediation Owner |
| Control Activity | Control Remediation Update Status |
| Control Activity | Control Type - Authorization |
| Control Activity | Control Type - Control Type Reconciliation |
| Control Activity | Control Type - Documentation |
| Control Activity | Control Type - Internal Control Documentation |
| Control Activity | Control Type - Safeguarding of Assets |
| Control Activity | Control Type - Segregation of Duties |
| Control Activity | Control Type - Validation |
| Control Activity | COSO Component - Control Activities |
| Control Activity | COSO Component - Event Identification |
| Control Activity | COSO Component - Information and Communication |
| Control Activity | COSO Component - Internal Enviroment |
| Control Activity | COSO Component - Monitoring |
| Control Activity | COSO Component - Risk Assessment |
| Control Activity | COSO Component - Risk Response |
| Control Activity | COSO Component - Objective Setting |
| Control Activity | COSO Objective - Compliance |
| Control Activity | COSO Objective - Operations |
| Control Activity | COSO Objective - Reporting |
| Control Activity | COSO Objective - Strategic |
| Assignment | Current Assignment |
| Control Activity | Current Period Test Due Date |
| Control Activity | Cycle |
| Assignment | Cycle |
| Control Activity | Documentation Remediation Due Date |
| Control Activity | Documentation Remediation Owner |
| Control Activity | Documentation Remediation Update Status |
| Control Activity | Does Control Exist? |
| Assignment | Due Date |
| Control Activity | Employee Turnover |
| Control Activity | Entity |
| USER | Expiration Date |
| Control Activity | Financial Statement Line Item |
| USER | First Name |
| Consolidated | Fiscal Year End Date |
| Trial Balance | |
| Sub Level | Fiscal Year End Date |
| Trial Balance | |
| Control Activity | Is Control Documented? |
| Control Activity | Is Key Control? |
| USER | Last Name |
| USER | Location |
| Control Activity | Narrative Text |
| Control Activity | Number of Transactions |
| Control Activity | Preventative/Detective |
| Control Activity | Process |
| Assignment | Process |
| Control Activity | Recommended Annual Sample |
| Control Activity | Recommended Test Frequency |
| Assignment | Rejected |
| Control Activity | Remedial Action Approver |
| Control Activity | Remediate Control and/or Documentation |
| Control Activity | Remediated Automated/Manual |
| Control Activity | Remediated Monitored |
| Control Activity | Remediated Real Time Monitored |
| Control Activity | Remediation Plan Employee Interviewee |
| Control Activity | Remediation Plan Prepared By: |
| Control Activity | Remediation Plan Preparer″s Name |
| Control Activity | Remediation Update Employee Interviewee |
| Control Activity | Remediation Update Prepared By: |
| Control Activity | Remediation Update Preparer″s Name |
| Control Activity | Responsible Tester |
| Control Activity | Risk Assertion |
| Control Activity | Risk Assertion Employee Interviewee |
| Control Activity | Risk Assertion Prepared By: |
| Control Activity | Risk Assertion Preparer″s Name |
| Control Activity | Risk Rating |
| Control Activity | Stage |
| Assignment | Stage |
| Control Activity | Status |
| USER | Status |
| Control Activity | Sub Level Account Description |
| Sub Level | Sub-Level Account Description |
| Trial Balance | |
| Sub Level | Sub-Level Account Number |
| Trial Balance | |
| Sub Level | Sub-Level Entity |
| Trial Balance | |
| Control Activity | System Changes |
| Assignment | Target End Date |
| Assignment | Target Start Date |
| Assignment | Task Name |
| Assignment | Task Owner |
| Assignment | Task Owner - email |
| Assignment | Task Status |
| Assignment | Task Type |
| Control Activity | Test Approver |
| Control Activity | Test Control |
| Control Activity | Test Coordinator |
| Control Activity | Test Plan Employee Interviewee |
| Control Activity | Test Plan Prepared By: |
| Control Activity | Test Plan Preparer″s Name |
| Control Activity | Test Result |
| Control Activity | Test Status |
| Control Activity | Test Update Employee Interviewee |
| Control Activity | Test Update Prepared By: |
| Control Activity | Test Update Preparer″s Name |
| USER | User Id |
| USER | User Role |

The Conditions table may be designed to use any type of search parameters. In a representative embodiment of the present invention, the Conditions table may be configured to use Boolean and parenthetical operators. For example, the user may select the Field name 5326 available for the selected query type, then the Boolean operator 5328. The Boolean operators 5328 may change depending on the selected field, but may representatively comprise equal, less than, greater than, greater than or equal, less than or equal, includes, not equal, not like, is not null, is null, and/or any other combination. After selecting the Operator 5328, the user may then select the Value 5332 corresponding to the value to be operated on. The user may choose to place parenthesis 5334, 5336 around a statement and/or a grouping of multiple statements. The user may also use an And/Or button 5342 to make logical comparisons and group parenthetical conditions together. Additionally, the user may use the Insert 5344 and Delete 5346 buttons to insert and/or delete selected conditions.

A fourth section corresponds to Sorting 5320, where a drop-down field box 5360 may be provide for a user to select a field to query, as well as whether the sorting parameter should be ascending or descending in a order drop-down box 5362. An Add button 5364 to add the field to the query search may also be provided. In a representative embodiment of the present invention, a user may wish to order the rows, for example, in ascending order of Field 1 within a descending order of Field 2; however, the user may only sort by the fields selected for view in the Display Fields 5310 section.

In another representative embodiment of the present invention, the Query Setup page 5300 may also comprise a Rollup Fields 5325 section. Rollup fields 5325, in accordance with various aspects of the present invention, may enable a user to group and sum data in the query results. In a representative embodiment of the present invention, when a field is selected from the Selectable Fields 5348 and added for Rollup 5352 using the Add button 5350, the fields may be summed and rolled up to the level specified. In another representative embodiment of the present invention, a field selected for Rollup may be moved up and/or down the list of fields selected for rollup using the Up 5354 and/or Down 5356 buttons. Additionally, a user may remove a field selected for rollup by selecting the field and clicking the Remove button 5358.

The system may be configured to display information through one or more charts. Charts may be implemented in any suitable manner, such as a table format that additionally includes a drill-down table listing additional information about the data. A pie chart format may not include the drill-down pie chart option or there may be any number of charts displayed for each status.

In a representative embodiment of the present invention, the system displays charts to illustrate the status of tasks throughout the system. Representative status levels illustrated on the charts correspond to: Not Started, In Progress, Complete, Past Due, and Pending. The user may select the format in which the charts are displayed. Representative formats include, for example, pie chart and/or table displays. The table display format may include a column for the control name, the total and the percentage. The pie chart format may be configured to display each status name and its rounded percentage, unless the pie slice is too thin to display the name and percentage in which case both are omitted. In a representative embodiment of the present invention, when a user moves the mouse cursor over each slice on the pie chart, a popup may be displayed corresponding to additional information concerning the selected status. For example, in another representative embodiment of the invention, a slice of the pie chart may be too small for the system to display the text or other designation of the status it is reflecting. Accordingly, when the user moves their cursor over the slice, the status and its value may be displayed with the detailed popup also displaying the actual value and name of every slice if the user wants to view actual percentage values as opposed to numerically rounded percentage. Additionally, the user may display another popup by selecting the displayed link on the pie chart that displays a drill-down pie chart. The drill-down pie chart may be used to display additional information about the data, such as how the data for that slice may be broken down and the percentages of each type of data that may be taken into account for the original slice percentage calculation.

The system may be further implemented to automatically generate a workflow chart to illustrate various controls, as well as how they interconnect to solve a task. A workflow chart, in accordance with various aspects of the present invention, may be substantially identical to the narrative text. In a representative embodiment of the present invention, a workflow chart may be implemented with any selection of colors, lines, shapes, or font in order to illustrate to the user when there is a gap in the control and/or document tasks.

In another representative embodiment of the present invention, in order to reach a Control Activity Workflow page, a user may select a Document link from the navigation bar followed by selection of a Workflow link. The Control Activity Workflow page may include a diagram that links control activities that have been pushed out of Assessment process in order. In another representative embodiment of the present invention, a diagram may be configured to highlight a document and/or control gap by outlining the text of the control activity with a red dashed outline. If there is no gap, then the activity may be outlined in green. A gap in either a document or control may occur when the data entered in the system with respect to the document or control task does not match correctly with the standard or has not been entered at all. In addition to the flow chart illustration, the Control Activity Workflow page may be configured to illustrate a component narrative section. Additionally, the user may attach comments and/or documents to the cycle workflows.

The system may be further implemented to comprise a Reconciliation Summary Table to display controls, processes, and cycles in a hierarchal order with expansion and minimization options on the process and cycle names. Expansion and minimization functions may allow a user to choose how many lower levels are displayed for each process and cycle. The columns included in the Reconciliation Summary table may be active or inactive depending on the workflow stage the user is viewing. If the column is inactive, it may be displayed in a different color than the active columns.

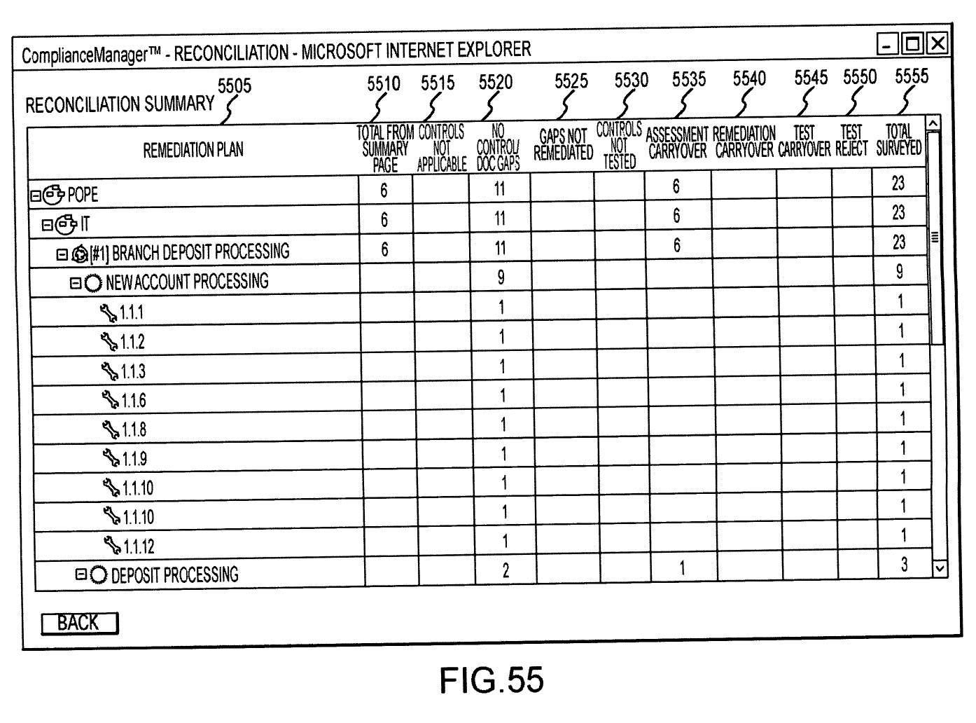

Referring now to FIG. 55, in a representative embodiment of the present invention, a Reconciliation Summary page 5500 may comprise a table with the following representative columns: Risk Assertion 5505—comprising levels of one or more cycles, processes and/or controls; Total for summary page 5510—providing details for tasks under each row; Controls Not Applicable 5515—displaying the controls from the summary table that do not apply to the particular workflow stage being viewed; No Control/Doc Gaps 5520—displaying the number of controls where there are no gaps present; Gaps Not Remediated 5525—providing the number of controls not set to be remediated; Controls Not Tested 5530—providing the number of controls not selected to be tested; Assessment Carryover 5535—providing the number of controls that are still pending in the assessment; Remediation Carryover 5540—providing the number of controls still pending in remediation; Test Carryover 5545—indicating the total controls still pending in test; Test Reject 5550—indicating the total controls that have tests that have been rejected; and Total Surveyed 5555—displaying all of the controls that are still active in the project. It will be appreciated that the reconciliation summary table may be implemented in any suitable manner so as to display the project data in a format easily readable by the user.

The system may optionally comprise an administrative tool that may be implemented in any suitable manner and may include any functions substantially accessible to administrators and/or installation experts. In a representative embodiment of the present invention, an administrative tool may comprise a mechanism for increasing efficiency and/or accuracy of data entry by limiting access to administrators and/or installation experts. In another representative embodiment of the present invention, an administrative tool may be accessible only by the administrator and may be designed to facilitate administrator functions within the system. The Admin Tool may comprise a graphical user interface having two primary functions corresponding to Data Upload and Data Manipulation. The Data Upload may be used during setup and importing of global and project hierarchy data into the system. After the Data Upload tool has been used, the administrator may view the data to ensure accuracy before it is loaded into the system. The Data Manipulation may be used to help the administrator modify existing data within the system, such as mistakes made in data entry.

In another representative embodiment of the present invention, the administrative tool may comprise a windows form-based application. One of the functions under Data Upload may comprise the Survey Data Loader, where the user or administrator may load surveys into the system from a unitary spreadsheet. After the survey data has been loaded, the user or administrator reviews the data and then selects the project where the data will be stored.

In accordance with various representative embodiments of the present invention, various other risk assessment procedures may be alternatively, conjunctively or sequentially employed. For example, a substantially user-customized risk assessment survey may be used to at least partially characterize unique risks that may be specific to a particular organization or user. The user-customized risk assessment survey may be suitably configured or otherwise adapted to produce customized controls for tracking, aggregation, quantification, evaluation, mitigation, and/or the like for a designated risk (e.g., competitive risks, strategic risks, environmental risks, etc.). It will be appreciated that various risk assessment protocols, whether now known or hereafter described in the art, may be used in accordance with representative embodiments of the present invention to achieve a substantially similar result.

It will be appreciated, that various other applications of the present invention may be formulated and that a network may be provided that may include any system for exchanging data, such as, for example, the Internet, an intranet, an extranet, WAN, LAN, satellite communications, and/or the like. It may be noted that the network may be implemented as other types of networks, such as an interactive television (ITV) network. The users may interact with the system via any input device such as a keyboard, mouse, kiosk, personal digital assistant, handheld computer (i.e., Palm Pilot®), cellular phone and/or the like. Similarly, the invention may be used in conjunction with any type of personal computer, network computer, workstation, minicomputer, mainframe, or the like running any operating system such as any version of Windows, Windows Vista, Windows XP, Windows Longhorn, Windows Whistler, Windows ME, Windows Mobile, Windows NT, Windows 2000, Windows Server, Windows 98, Windows 95, MacOS, OS/2, BeOS, Linux, UNIX, or any other operating system, whether now known or hereafter described by those skilled in the art. Moreover, the invention may be readily implemented with TCP/IP communications protocols, IPX, AppleTalk, IP-6, NetBIOS, OSI or any number of existing or future protocols. Moreover, the system contemplates the use, sale and/or distribution of all goods, services and/or information having similar functionality described herein.

The computing units may be connected with each other via a data communication network. The network may be a public network and assumed to be insecure and open to eavesdroppers. In one exemplary implementation, the network may be embodied as the Internet. In this context, computers may or may not be connected to the Internet at all times. Specific information related to data traffic protocols, standards, and application software utilized in connection with the Internet may be obtained from any suitable source and/or sources.

A variety of conventional communications media and protocols may be used for data links, such as, for example, a connection to an Internet Service Provider (ISP) over the local loop as is typically used in connection with standard modem communication, cable modem, Dish networks, ISDN, Digital Subscriber Line (DSL), or various wireless communication methods. Polymorph code systems might also reside within a local area network (LAN) which interfaces to a network via a leased line (T1, T3, etc.). Such communication methods are well known in the art, and are covered in a variety of standard texts.

The present invention may be embodied as a method, a system, a device, and/or a computer program product. Accordingly, the present invention may take the form of an entirely software embodiment, an entirely hardware embodiment, or an embodiment combining aspects of both software and hardware. Furthermore, the present invention may take the form of a computer program product on a computer-readable storage medium having computer-readable program code means embodied in the storage medium. Any suitable computer-readable storage medium may be utilized, including hard disks, CD-ROM, optical storage devices, magnetic storage devices, USB memory keys, and/or the like.

Data communication may be accomplished through any suitable communication means, such as, for example, a telephone network, intranet, Internet, point of interaction device (point of sale device, personal digital assistant, cellular phone, kiosk, etc.), online communications, off-line communications, wireless communications, and/or the like. It will be further appreciated that, for security reasons, any databases, systems, and/or components of the present invention may consist of any combination of databases or components at a single location or at multiple locations, wherein each database or system includes any of various suitable security features, such as firewalls, access codes, encryption, de-encryption, compression, decompression, and/or the like.

The present invention is described herein with reference to screen shots, block diagrams and flowchart illustrations of methods, apparatus (e.g., systems), and computer program products according to various aspects of the invention. It will be understood that each functional block of the block diagrams and the flowchart illustrations, and combinations of functional blocks in the block diagrams and flowchart illustrations, respectively, may be implemented by computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

These computer program instructions may also be stored in a computer-readable memory that may direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

In the foregoing specification, the invention has been described with reference to specific exemplary embodiments; however, it will be appreciated that various modifications and changes may be made without departing from the scope of the present invention as set forth herein. The specification is to be regarded in an illustrative manner, rather than a restrictive one and all such modifications are intended to be included within the scope of the present invention, Accordingly, the scope of the invention should be determined by the claims and their legal equivalents rather than by merely the examples described above.

For example, the steps recited in any method or process embodiment may be executed in any order and are not limited to the specific order presented in the claims. Additionally, the components and/or elements recited in any apparatus or composition embodiment may be assembled or otherwise operationally configured in a variety of permutations to produce substantially the same result as the present invention and are accordingly not limited to the specific configuration recited in claims.

Benefits, other advantages and solutions to problems have been described above with regard to particular embodiments; however, any benefit, advantage, solution to problem or any element that may cause any particular benefit, advantage or solution to occur or to become more pronounced are not to be construed as critical, required or essential features or components of the invention.

As used herein, the terms “comprising”, “having”, “including” or any variation thereof, are intended to reference a non-exclusive inclusion, such that a process, method, article, composition or apparatus that comprises a list of elements does not include only those elements recited, but may also include other elements not expressly listed or inherent to such process, method, article, composition or apparatus. Other combinations and/or modifications of the above-described structures, arrangements, applications, proportions, elements, materials or components used in the practice of the present invention, in addition to those not specifically recited, may be varied or otherwise particularly adapted to specific environments, manufacturing specifications, design parameters or other operating requirements without departing from the general principles of the same.

We claim:

1. A system for complying with at least one standard, said system comprising:
a computing device having a central processing unit and at least one input suitably configured to be responsive to data via a graphical user interface and to communicate with said processing unit; and
data that may be suitably organized into a plurality of levels of organization comprising at least global data and project data, wherein global data comprises at least one global parameter and project data comprises at least one project parameter, and wherein said project data optionally comprises at least one stage;
wherein said system is configured to:
permit at least partial system access based on a role, wherein said role comprises at least one of:
an administrator and a user;
provide a protocol for at least one of identifying, characterizing and meeting a standard using at least one control and testing of said control through performance of at least one task;
verify that the standard is met;
prescribe a remediation protocol suitably adapted to meet the standard if the standard has not been met;
at least one of characterize and analyze at least one risk associated with the standard; and
provide a method for certifying that the standard has been met.

2. The system of claim 1, wherein said graphical user interface is further suitably configured to at least partially limit access to said data.

3. The system of claim 1, wherein said user comprises at least one of: a read-only user, a guest, and a project coordinator.

4. The system of claim 1, wherein said user has a status comprising at least one of: active, inactive and modified.

5. The system of claim 1, wherein said graphical user interface is further configured to display a homepage.

6. The system of claim 5, wherein said homepage at least one of: comprises an at least partially individualized homepage for a user, is at least partially configured based on the level of access of a user, and comprises a to-do list.

7. The system of claim 6, wherein said to-do list is substantially configured to be individualized for a user.

8. The system of claim 6, wherein said to-do list further comprises at least one of: a stage column, a pending assigned task column, a pending approval column, a rejection column, a due date column, and a past due column.

9. The system of claim 5, wherein at least one status chart at least partially illustrates status of at least one of said task, said project, and said stage, wherein said chart comprises at least one of a pie chart, a table and a graph.

10. The system of claim 1, wherein said administrator is permitted to at least one of: add, modify, and deactivate said user.

11. The system of claim 1, wherein said administrator is permitted to query at least one user by at least one of: a user name, name, location, entity, position, status, assignment, and role.

12. The system of claim 1, wherein said administrator is further configured to filter a list of users to display at least one of: active users, inactive users, and modified users.

13. The system of claim 1, further comprising at least one security feature to limit at least one of access and use of the system.

14. The system of claim 13, wherein said security feature further comprises a graphical user interface to at least one of: substantially prevent unauthorized access, at least partially randomly generate new login passwords, and encrypt stored passwords.

15. The system of claim 14, wherein said user password is further configured to comprise one-way encryption.

16. The system of claim 1, wherein said global data is at least substantially accessible to a plurality of users and administrators.

17. The system of claim 1, further comprising at least one domain, wherein said domain comprises at least one of a global parameter and a project parameter that is suitably configured to at least one of: group, add, edit, delete and reorder at least one of said global parameter and said project parameter.

18. The system of claim 17, wherein said parameter may be suitably configured to be identified by at least one of a code value and a data value.

19. The system of claim 1, wherein at least one global parameter is only accessible by said administrator.

20. The system of claim 1, wherein said graphical user interface is further configured to comprise at least one administrator tool, wherein said administrator tool is substantially accessible only by said administrator.

21. The system of claim 20, wherein said administrator tool comprises at least one form-based screen that is suitably configured to at least partially facilitate bulk loading of data into at least one of said project data and said global data.

22. The system of claim 1, wherein project data is substantially accessible to at least one of a user and administrator after assignment to said project.

23. The system of claim 1, further configured to allow at least one of said user and said administrator to search said data.

24. The system of claim 1, wherein said graphical user interface comprises a survey suitably configured to facilitate said input of data based on at least one of said global parameter and said project parameter.

25. The system of claim 24, wherein said survey comprises a template based on at least one of said global parameter and said project parameter.

26. The system of claim 25, wherein said template is suitably configured to be at least one of customized and saved.

27. The system of claim 1, further configured such that a change in at least one of said project data and said global data may be propagated throughout substantially each project.

28. The system of claim 1, wherein said project comprises at least one stage and wherein said stage comprises at least one task.

29. The system of claim 28, wherein said task uses at least part of said project data.

30. The system of claim 1, wherein said task is suitably configured to be assigned to a plurality of users.

31. The system of claim 1, wherein said task is assigned to one user.

32. The system of claim 1, wherein said task comprises at least one status comprising at least one of: assign, complete, approve, not started, in progress, past due, reject, re-assign, and re-open.

33. The system of claim 32, wherein said task status comprises ‘assign’ and wherein said status places an initial assignment of said task to at least one user.

34. The system of claim 32, wherein said task status comprises ‘complete’ and wherein said status signals at least one user to complete said task.

35. The system of claim 32, wherein said task status comprises ‘approve’ and wherein said status signals to a user that said task should be approved.

36. The system of claim 34, further comprising a task status engine that is suitably configured to communicate at least one of: a new task assignment, a task assignment rejection, a password reset, and a new user added to the system.

37. The system of claim 36, wherein said task status engine is further configured to transmit at least one alert via email.

38. The system of claim 36, wherein said task status engine is further configured to send a stage reminder to indicate at least one of: a new task assignment, task assignment rejection, password reset, and a new user added to the system.

39. The system of claim 36, wherein said task status engine is further configured to at least partially automatically determine at least one due date for a task assignment when said task assignment is generated.

40. The system of claim 39, wherein at least one due date is calculated using at least one milestone date.

41. The system of claim 40, wherein said due dates for a completed task are set by said user and are before an assignment due date and past the day a task assignment is made.

42. The system of claim 39, wherein said due dates for approval of tasks are configured using at least one of said project parameters.

43. The system of claim 40, wherein said computing device is further configured to create at least one documentation task, wherein said documentation task may be assigned to at least one of said global data and said project data.

44. The system of claim 43, wherein said documentation task is suitably configured to be assigned at least one of: annually, biannually, quarterly, biweekly, weekly, and daily.

45. The system of claim 44, wherein said documentation task is suitably configured to record at least one change to said task.

46. The system of claim 1, further comprising a project maintenance page, wherein said maintenance page allows for at least one of viewing, editing, archiving and copying said project.

47. The system of claim 1, further comprising an audit trail, wherein said audit trail is configured to record at least one task.

48. The system of claim 47, wherein said audit trail comprises at least one of the following descriptions: stage initiated, pending assign task, assigned task, rejected task, re-assigned task, completed task, pending completed task, pending approval, approved, rejected approval, and send to next stage.

49. The system of claim 1, further comprising a document library suitably configured to comprise a central point where at least one attachment is added to at least one of said project and said global data, and wherein said attachment may be at least one of: searched, viewed, added, updated, and deleted.

50. The system of claim 1, further comprising a query page configured to run at least one query search.

51. The system of claim 50, wherein the query search displays at least one result based on at least one term selected by at least one user, and wherein said result comprises at least part of at least one of said project data and said global data.

52. The system of claim 51, wherein said query search results are suitably configured to be displayed to said user in a grid format.

53. The system of claim 50, wherein said query further comprises at least one of: a definition, a display field, a condition, and sorting.

54. The system of claim 1, wherein said graphical user interface is further configured to allow said user to at least one of: at least partially write at least one custom report, upload at least one custom report to said project, and at least partially run at least one custom report.

55. The system of claim 53, wherein results of said custom reports are suitably configured to be at least one of: view, printed, and exported.

56. The system of claim 1, wherein said standard comprises at least one of: a law, a rule, a cannon, a regulation, a requirement, a goal, and a procedure.

57. The system of claim 1, wherein said device is suitably configured for at least one of: remote access, real-time updates, and archiving.

58. The system of claim 1, wherein said global organization comprises a business and wherein said project comprises at least one of: a department, a subsidiary, a division, and a branch.

59. The system of claim 1, further comprising a root node and at least one child node.

60. The system of claim 61, wherein said root node links global data and wherein at least one child node links project data.

61. The system of claim 62, wherein said root node and child node comprise a navigation tree.

62. The system of claim 62, wherein a global level comprises a root node and at least one child node, and wherein said child node comprises a root node for a project level.

63. The system of claim 61, wherein said child node links to a root node.

64. The system of claim 1, wherein said graphical user interface allows said user to provide said global data and project data via a data input; and displays said data output to said user.

65. The system of claim 1, further comprising a flag that is set when at least one of: new project data and new global data is added; wherein said flag saves values corresponding to author, date, and time of change as modification data.

66. A method for complying with at least one standard with a data management system, said method comprising the steps of:
providing a computing device having a central processing unit and at least one input suitably configured to be responsive to data via a graphical user interface and to communicate with said processing unit;
assigning a role, wherein said role corresponds to at least one of an administrator and a user,
where said role at least partially determines a level of access granted to said system;
organizing data into a plurality of levels of organization corresponding to at least one of global and project data, where global data comprises at least one global parameter and where project data comprises at least one project parameter, and wherein said project optionally comprises at least one stage;
providing a protocol for at least one of identifying, characterizing and meeting the standard using at least one control and testing said control through performance of at least one task; and
optionally prescribing a remediation protocol substantially configured to meet the standard.

67. The method of claim 66, further comprising the step of at least partially analyzing at least one risk associated with the standard.

68. The method of claim 66, further comprising the step of certifying that the standard has been met.

69. The method of claim 66, wherein said graphical user interface is suitably configured to at least partially limit access to said data.

70. The method of claim 66, wherein said user comprises at least one of: a user, a read-only user, a guest, and a project coordinator.

71. The method of claim 66, wherein said user has a status comprising at least one of: active, inactive and modified.

72. The method of claim 66, wherein said graphical user interface is further configured to display a homepage.

73. The method of claim 72, wherein said homepage at least one of: comprises an at least partially individualized homepage for a user, is at least partially configured based on the level of access of a user, and comprises a to-do list.

74. The method of claim 73, wherein said to-do list is substantially configured to be customized for a user.

75. The method of claim 73, wherein said to-do list further comprises at least one of: a stage column, a pending assigned task column, a pending approval column, a rejection column, a due date column, and a past due column.

76. The method of claim 73, wherein said homepage further comprises at least one of: a user preference link, an inbox, and a logout option.

77. The method of claim 73, further comprising the step of providing a status of at least one of a project, a stage and a task through said homepage.

78. The method of claim 77, further comprising the step of providing at least one status chart that at least partially illustrates status of at least one of said task, said project, and said stage, wherein said chart comprises at least one of a pie chart, a table and a graph.

79. The method of claim 66, wherein said administrator is suitably configured to at least one of: add, modify, and inactivate a user.

80. The method of claim 66, wherein said administrator may filter a list of users to display at least one of: active users, inactive users, and modified users.

81. The method of claim 66, further comprising the step of providing at least one security feature to limit at least one of access and use of the system.

82. The method of claim 81, wherein said security feature further comprises a graphical user interface to at least one of: substantially prevent unauthorized access, at least partially randomly generate new login passwords, and encrypt stored passwords.

83. The method of claim 82, wherein said user password is further configured to comprise one-way encryption.

84. The method of claim 66, wherein said global data is at least substantially accessible to all users and administrators.

85. The method of claim 66, further comprising at least one domain, wherein said domain comprises at least one of a global parameter and a project parameter that is suitably configured to at least one of: group, add, edit, delete and reorder at least one of said global parameter and said project parameter.

86. The method of claim 85, further providing the step of identifying at least one project parameter by at least one of a code value and a data value.

87. The method of claim 66, further comprising the step of providing an administrator with access to at least one global parameter.

88. The method of claim 66, wherein said graphical user interface is further configured to comprise at least one administrator tool that is substantially accessible by said administrator.

89. The method of claim 88, wherein said administrator tool comprises at least one form-based screen that is suitably configured to at least partially facilitate bulk loading of data into at least one of said project data and said global data.

90. The method of claim 66, wherein said project data is substantially accessible to at least one of said user and said administrator after assignment of said project.

91. The method of claim 66, further comprising the step of allowing at least one of said user and said administrator to search said data.

92. The method of claim 66, further comprising the step of providing a survey suitably configured to facilitate said input of data based on at least one of said global parameter and said project parameter.

93. The method of claim 92, wherein said survey comprises a template based on at least one of said global parameter and said project parameter.

94. The method of claim 93, wherein said template is suitably configured to be at least one of customized and saved.

95. The method of claim 66, further comprising the step of at least partially propagating a change in at least one of said project data and said global data throughout substantially each project.

96. The method of claim 66, wherein said project comprises at least one stage and said stage comprises at least one task.

97. The method of claim 96, wherein said task uses at least part of said project data.

98. The method of claim 66, further comprising the step of assigning said task to more than one user.

99. The method of claim 66, wherein said task comprises a status comprising at least one of:
assign, complete, approve, not started, in progress, past due, reject, re-assign, and re-open.

100. The method of claim 99, wherein said task status comprises ‘assign’ and wherein said status places an initial assignment of said task to at least one user.

101. The method of claim 99, wherein said task status comprises ‘complete’ and wherein said status signals at least one user to complete said task.

102. The method of claim 99, wherein said task status comprises ‘approve’ and wherein said status signals to a user that said task should be approved.

103. The method of claim 101, further comprising the step of providing a task status engine, wherein said task status engine is suitably configured to communicate at least one of: a new task assignment, a task assignment rejection, a password reset, and a new user added to the system.

104. The method of claim 103, wherein said task status engine is further configured to transmit at least one alert via email.

105. The method of claim 104, wherein said task status engine is further configured to send a stage reminder to indicate at least one of: a new task assignment, a task assignment rejection, a password reset, and a new user added to the system.

106. The method of claim 103, wherein said task status engine is further configured to at least partially automatically determine at least one due date for a task assignment when said task is generated.

107. The method of claim 106, wherein at least one due date is calculated using at least one milestone date.

108. The method of claim 107, wherein said due date for a completion of a task is set by said user and occurs before an assignment due date and after the day a task assignment is made.

109. The method of claim 107, wherein said due date for task approval is configured using at least one project parameter.

110. The method of claim 107, wherein said computing device is further configured to create at least one documentation task, wherein said documentation task may be assigned to at least one of said global data and said project data.

111. The method of claim 110, further comprising the step of assigning said documentation task at least one of: annually, biannually, quarterly, biweekly, weekly, and daily.

112. The method of claim 111, wherein said documentation task is suitably configured to record at least one change to said task.

113. The method of claim 66, further comprising the step of providing a project maintenance page, wherein said maintenance page allows for at least one of: viewing, editing, archiving, and copying said project.

114. The method of claim 66, further comprising the step of providing an audit trail, wherein said audit trail comprises at least one of the following descriptions: stage initiated, pending assign task, assigned task, rejected task, completed task, pending competed task, pending approval, rejected approval, and send to next stage.

115. The method of claim 66, further comprising the step of providing a document library, wherein said document library is suitably configured to comprise a central point where at least one attachment is added to at least one of said project and said global data, and wherein said attachment may be at least one of: searched, viewed, added, updated, and deleted.

116. The method of claim 66, further comprising a query page, wherein said query page is suitably configured to run at least one query search.

117. The method of claim 116, wherein said query search displays at least one result, wherein said result is based on at least one term selected by at least one user, and wherein said result comprises at least part of at least one of said project data and said global data.

118. The method of claim 117, wherein said query further comprises at least one element corresponding to at least one of: definition, display field, condition, and sorting.

119. The method of claim 66, wherein said graphical user interface is further configured to allow said user to at least one of: at least partially write at least one custom report, upload at least one custom report to said project, and at least partially run at least one custom report.

120. The method of claim 119, wherein results of said custom reports are suitably configured to be at least one of: viewed, printed, and exported.

121. The method of claim 66, wherein said graphical user interface allows said user to provide said global data and project data via a data input, and displays said data output to said user.

122. The method of claim 66, further comprising the step of setting a flag when at least one of new project data and new global data is added, wherein said flag saves values, user making modification, date and time of change as modification data.

123. The method of claim 66, wherein said standard comprises at least one of: a law, a rule, a cannon, a regulation, a requirement, a goal, and a procedure.

124. The method of claim 66, wherein said computing device is suitably configured for at least one of: remote access, real-time updates, and archiving.

125. The method of claim 66, wherein said global organization comprises a business and wherein said project comprises at least one of: a department, a subsidiary, a division, and a branch.

126. The method of claim 66, further comprising the step of providing a root node and at least one child node.

127. The method of claim 126, wherein said root node links global data and wherein said child node links project data.

128. The method of claim 126, wherein said root node and child node comprise a navigation tree.

129. The method of claim 126, wherein a global level comprises a root node and at least one child node, and wherein said child node comprises a root node for a project level.

130. The method of claim 126, wherein said child node links to a root node.

131. A computing device suitably configured to provide a system for complying with at least one standard relating to Sarbanes-Oxley requirements, said computing device comprising:
a central processing unit;
at least one input substantially configured to be responsive to data via a graphical user interface and to communicate with said processing unit;
wherein said graphical user interface comprises at least one security feature; and
wherein said computing device is substantially configured to:
organize data into a plurality of levels of organization comprising at least one of global, project and optionally stage, wherein global data comprises at least one global parameter and project data comprises at least one project parameter, and further comprising at least one domain suitably configured to at least one of: group, add, edit, delete, and reorder at least one of said global parameter and said project parameter, and
wherein said computing device is substantially configured to at least one of:
permit access to the system at least partially based on a role, wherein said role comprises at least one of: an administrator and a user, and wherein a user comprises at least one of a user,
a read-only user, a guest, and a project coordinator;
provide a protocol for at least one of identifying, characterizing and meeting the standard using at least one control and testing said control through performance of at least one task;
organize at least one document verifying at least one of completion and approval of at least one task;
provide a query search of substantially all of at least one of global data and project data;
verify that the standard is met;
prescribe a remediation protocol suitably configured to meet the standard;
at least one of characterize and analyze at least one risk associated with the standard; and
provide a method for certifying that the standard has been met.
